(19) United States
(12) Patent Application Publication
(10) Pub. No.: US 2004/0054549 A1
(43) Pub. Date: Mar. 18, 2004

(54) Method, computer system and computer system network

(76) Inventors: Andrew I Chittenden, London (GB); Petros Andreas Demetriades, London (GB); Richard Fussey, Harlington Middlesex (GB); Todd Howard Morgan, London (GB); Simon Patterson, London (GB)

Correspondence Address: Baker & McKenzie, 130 E Randolph Drive, Chicago, IL, 60601, US

(21) Appl. No.: 10/332,397

(22) PCT Filed: Jul. 6, 2001
(86) PCT No.: PCT/GB01/03056

(30) Foreign Application Priority Data
Jul. 7, 2000 (GB) 0016822.9
Sep. 2, 2000 (GB) 0023073.0

(51) Int. Cl. G06F 17/60

(52) U.S. Cl. 705/1; 701/201

(57) ABSTRACT

A computer system for providing an integrated representation of transport service levels for routes in a transport system comprising a multiplicity of connectable stations is disclosed. The computer system comprises a processing unit, an interface unit for communication with said processing unit and a memory unit. The system is configured to store in the memory unit a short term schedule of individual instances of transport provider route legs, each route leg corresponding to a directly connectable station pair. The system is configures to further store in the memory unit service level data representative of one or more transport service levels ascribed to one or more route leg instances. The service level data comprised for the or each transport service level a service level identifier identifying the transport service level and at least one service attribute representing a characteristic of the transport service level. A route segment table comprising one or more route segments, each route segment corresponding to a route leg instance or a combination of route leg instances is derived.

This is a National Stage application of International PCT Application No. PCT/GBOl/03056.

### BACKGROUND AND SUMMARY OF THE INVENTION

The present invention relates to a method, computer system and computer system network configured for automatically generating routing options for a transport system. In particular, but not exclusively, the present invention relates to automatically generating routing options in an air cargo transport system.

While passenger transport systems, such as rail and air transport, utilize technology such as computer-based booking systems to handle and manage passenger movement and capacity, freight transport management systems are significantly less technologically advanced. For example, through Central Reservation Systems (CRSs), airlines offer passenger tickets for sale and travel agents book such tickets. As a result of the lack of technological tools, the air freight industry, for example, labors under significant inefficiencies.

The freight transport industry is typically highly fragmented. For example, in the air freight transport industry carriers (airlines) and forwarders (air freight/cargo capacity brokers) comprise many different and unrelated undertakings. There exists no centralized communications system or booking system for the forwarders to book cargo capacity with the carriers, and this results in a significant latency in the forwarders adjusting to changes to capacity available from the airlines, and to the airlines adjusting to the level of desired capacity by the forwarders. In order to take account of this latency, forwarders tend to block book cargo capacity up to 6 months in advance, such booking often being an overbooking which may result in a significant number of “no-shows” for the carrier. In order to compensate for such overbooking and to mitigate against “no-shows” carriers overbook flights thereby reducing the number of situations where capacity remains unsold. As a result, if more than the anticipated number of forwarders show-up, the carrier has to offload some forwarders. This means that the perceived service offered by the carrier to the forwarders is reduced. Also, as a result of this, forwarders attempt to micro-manage carriers by insisting on guaranteed flight-specific bookings to avoid such situations where their cargo is off-loaded and their customers (shippers) dissatisfied. This results in loss of revenue for the carriers who are also carrying the burden of high fixed costs and asset risks of running aircraft and routes, by way of possible customer dissatisfaction and unused capacity. Conversely, ad hoc bookings may be made to make up for any shortfall in a forwarder's cargo capacity needs. However, ad hoc bookings are also inefficient since it is necessary for a forwarder, or forwarder's agent, to contact many carriers individually, by telephone, fax or e-mail, for example, in order to obtain information on capacity availability and price. Very often, further information such as the type of cargo a carrier is able to carry over a certain route will be required, together with the type of packaging required.

Although existing Electronic Data Interchange (EDI) systems operated by carriers and forwarders typically operate under established EDI conventions and protocols, different versions, data and data structures are utilized. Thus inter-working and high levels of integration are inhibited. EDI is a generic term for one-to-one communication between systems, which relate to just one carrier. Due to the inherent sequential and asynchronous nature of messaging via EDI, there is no single and current database of flight, capacity availability and rating information that can be addressed electronically via a single query. This inhibits the utilization of such EDI systems within individual carriers and forwarders. Furthermore, the conventions are often rigid International standards and so are difficult to change.

In one-to one EDI systems, a request for information has to be sent to each individual carrier's EDI system. A specific query or request for information has to be made, conforming to a format used by a respective EDI system. This results in EDI users having to send a request for the same information many times, once to each carrier's EDI system, in order to obtain information regarding the total service available. Secondly, the request must be in the appropriate format for each EDI system which may require re-formatting of a request for submission to different systems. This takes significant time and effort on behalf of a user. Additionally, different EDI systems support different information, so that not all EDI systems can answer the same query, or provide the required information. A further drawback is that tariff rate changes can only be distributed slowly, even when distributed via fax or e-mail, since they are not available via a central system.

Another drawback is that results from different carrier EDIs cannot be viewed at the same time. The response from different EDI systems is asynchronous, since they are independent of each other. Thus a user is inhibited from assessing the information as a whole, which makes optimum selection of available services difficult. This is because existing EDI systems are based around messages sent to and from single carriers. Thus, it is extremely difficult to assemble routing options, for example, across carriers using EDI systems. Currently, it is necessary to send sets of messages to carriers regarding the various segments of a desired journey, and to try to assemble a set of flight segments formed from the individual flight segments to form the journey.

Although EDI systems were originally intended for the electronic exchange of data and to avoid manual input of data, they have degraded into mere messaging systems, and do not provide for the efficient interchange of information. The failure of existing EDI systems to fully integrate, version and update data regarding all the different attributes of plural airline transport systems such as schedule, available capacity and price information for review by forwarders, to provide a system to support bookings by forwarders for example, results in the air freight industry laboring under significant inefficiencies. Furthermore, the lack of automated integrated information management systems, provides a barrier to the optimization of routing options and route management, by for example, taking into account aircraft type with regard to capacity and cargo type for a particular route.

Historically, carriers have typically offered a single service of simply moving freight from an origin station to a destination station. Typically, the carrier specifies the services that are likely to be used, such as the mode of transport e.g. aircraft, ships, trucks, rail etc., and specify an estimated time of departure at an origin station and an estimated time of arrival at a destination station. A forwarder has to allow a period before the estimate time of departure in order to drop off cargo, and wait a time after the estimated time of arrival in order to pick up cargo. The time a forwarder has to allow before the departure time and after the arrival time depends upon the efficiency of the cargo handling provided by the carrier at each origin and destination station. A typical service offering has a lack of clarity regarding commitments and obligations between carriers and forwarders. Often there are no guarantees with regard to the service typically provided by carriers. Cargo can consequently be delayed without financial penalty, for example due to late or cancelled flights, delayed handling, or even having been off loaded due to overbooking of the cargo capacity of the vehicle for which it was destined. Likewise, forwarders generally have no financial obligation to actually turn up with their cargo.

In order to augment and improve their market share, carriers are seeking to differentiate the market by introducing different levels of services. The carriers are not merely seeking to differentiate between services offered by themselves, but to distinguish their services from services of their competitors. These different levels of service are commonly termed “products”, and the term “product” or “products” will be used interchangeably with transport service level, service, services, level of service or level of services as appropriate.

By introducing more clearly defined products, carriers are seeking to differentiate themselves from the provision of simple service as conventionally provided.

However, the implementation of products within the cargo freight industry presents carriers with a number of technical obstacles. Carriers typically need to manage a combination of the following; namely changing the operational procedures in order to fulfill the various products offered in their service, change their business processes in order to take and manage bookings of and to invoice for different product services, and to develop a data system for presenting products for selection by forwarders. This in itself is a significant technical challenge. Furthermore, there are no systems that allow a forwarder to search across multiple carriers to see what products are offered on a single route, together with the availability and price of each product on a route.

Typically, those carriers who have sought to implement a differentiation in the level of services that they offer have amended their existing systems in order to support the requirements of the specific products they have chosen to market. The level of sophistication of these systems varies in proportion to the amount of manual involvement necessary to implement the differentiated product offerings. However, in some instances, hardly any change in the existing level of service is offered. Particular draw backs of existing systems which do market different products is that they do not offer the following features:

the ability for the carrier to add new product offerings by editing parameter data only;

the ability to support all known products in the market place;

dynamic generation and optimization of different performance options from an underlying schedule according to characterized performance and marketing rules;

a graphical indication of the complex properties of the products;

many different products being displayed for many different carriers in response to a single search request by a forwarder, in an order prioritized by the forwarder;

a “level playing field” for comparison of many different products in a single display;

the ability to view, instead of make, bookings for many products in a single display; and

the ability to monitor actual performance against the performance stated by a carrier for that product.

Accordingly, the present invention seeks to provide a computer system, a method for configuring a computer system and a network incorporating such a computer system, that addresses, and preferably mitigates, at least one of the foregoing. Further problems and drawbacks associated with known systems will become apparent from the following description and drawings, together with further aspects of the present invention.

Particular and preferred aspects of the invention are set out in the accompanying independent and dependent claims. Combinations of features from the dependent claims may be combined with features of the independent claims as appropriate and not merely as explicitly set out in the claims.

In accordance with a first aspect of the invention there is provided a method of configuring a computer system including a processing unit, an interface unit for communication with said processing unit and a memory unit, for providing an integrated representation of transport service levels for routes in a transport system comprising a multiplicity of connectable stations, the method comprising:

storing in said memory unit a short term schedule of individual instances of transport provider route legs, each route leg corresponding to a directly connectable station pair;

further storing in said memory unit service level data representative of one or more transport service levels ascribed to one or more route leg instances, said service level data comprising for the or each transport service level a service level identifier identifying the transport service level and at least one service attribute representing a characteristic of the transport service level;

deriving a route segment table comprising one or more route segments, each route segment corresponding to a route leg instance or a combination of route leg instances; and

storing said route segment table in said memory unit.

In accordance with a second aspect of the invention there is provided a computer system comprising a processing unit, an interface unit for communication with said processing unit and a memory unit, for providing an integrated representation of transport service levels for routes in a transport system comprising a multiplicity of connectable stations, configured to:

store in said memory unit a short term schedule of individual instances of transport provider route legs, each route leg corresponding to a directly connectable station pair;

further store in said memory unit service level data representative of one or more transport service levels ascribed to one or more route leg instances, said service level data comprising for the or each transport service level a service level identifier identifying the transport service level and at least one service attribute representing a characteristic of the transport service level;

derive a route segment table comprising one or more route segments, each route segment corresponding to a route leg instance or a combination of route leg instances; and

store said route segment table in said memory unit.

Optionally or additionally, the service level data comprises performance category data representative of one or more performance categories. The performance category data comprises a performance category identifier and a plurality of performance category attributes, a performance category identifier being a service attribute of a plurality of transport service levels. The performance category attributes represent service attributes of the plurality of transport service levels and one or more performance categories are ascribed to one or more route leg instances. Advantageously, the number of entries in the route segment table is reduced, increasing efficiency. Further, the implementation of performance categories enables transport providers to update data common to several transport service levels without having to update the data for each transport service level separately.

Preferably a service attribute and/or a performance category identifier associating each route segment with said one or more ascribed transport service levels is included in the route segment table.

The transport system data is divided up into route segments, each route segment corresponding to an origin station and destination station pair which are preferably connected by the use of a single vehicle. That is to say, in a journey between the origin and destination stations of a route segment the same vehicle is used, and there is no transfer of cargo from one vehicle to another vehicle within the journey. The route segments are derived from individual, or a combination of individual, route legs. Each route leg corresponds to an origin and destination pair which are directly connectable or consecutive origin/destination station pairs. That is to say, a route leg has no intermediate stations between the origin and destination stations. A route segment comprising a combination of route legs has an origin station corresponding to a first route leg in the combination, and a destination station corresponding to the last route leg in the combination.

Additionally, an operator of a transport system, or a part thereof, such as an airline, railway company or shipping line, may modify available route legs by creating new ones or deleting old ones which can then immediately be used in the creation of routing options, without having to modify all possible routing options utilizing such new or old route legs station pairs in accordance with the changes. Thus old or unprofitable routes can easily be deleted, and new routes added.

An advantage of an embodiment in accordance with the first or second aspect of the invention is that different levels of service for a route leg in a transport system may be defined. Thus, it is possible to offer different transport service levels, or “product” across a route leg thereby providing premium services, mid-range value services and low end services for example, with appropriate price differentiation. Thus, carriers will be able to generate new revenue streams, and build brand differentiation to promote customer loyalty. The availability of different levels of service or products provides an opportunity for the carriers to appeal to different customers willing to pay for higher value services or products.

Suitably a service attribute may correspond to an operational service attribute. Preferably, the operational service attribute comprises one or more of the following group of operational service attributes:

import handling time; export handling time; minimum transfer time; maximum transfer time; permitted cargo type; permitted service package add on; vehicle type; cargo conveyance capacity; departure time; arrival time; cargo compatibility, size and weight controls and set of office hours.

Optionally or additionally, the service attribute corresponds to a non-operational service attribute, such as one or more of the following group of non-operational service attributes:

service guarantee; time specific search flag; itinerary specific search flag; minimum journey time; maximum journey time; terms and conditions of carriage; icon; service level category; display options; route segment; price in respect of a conveyance capacity; set of permitted drop-off times; set of permitted pick-up times; rules to determine access to capacity and permitted interline options.

Price for conveyance capacity is particularly advantageous, since it allows for the differentiation of the service levels in accordance with price. Thereby, new and differentiated revenue streams may be created. In particular, high value, high service level products may be created for those forwarders/customers willing to pay a premium price.

Optionally or additionally, said service attribute corresponds to a route service attribute for said transport system, such route service attribute comprising one or more of the following group of route service attributes:

minimum journey time; maximum journey time; permitted transfer stations; service level category; and permitted service package add on.

In a preferred embodiment said one or more transport service level is alterable by a transport provider, although they may be alterable by the computer system operator also. Typically, at least one of said service attribute, operational service attribute, non-operational service attribute and route service attribute are alterable by a transport provider.

Preferably, said one or more transport service level is associated with a multiplicity of stations in said transport system. Thus, there is a high level of granularity in the service levels that can be created. Furthermore, by providing the service level at the station level it is possible to generate many different routes for a given service level or product without having to define them explicitly. Thus, products or service levels for routes may be dynamically generated from the physical data relating to the transport system, together with an overlying layer of marketing data.

In accordance with a particular embodiment of the invention, a drop-off time for a route may be calculated in accordance with the following relationship;

drop-off time equals the latest of a set of permitted drop-off times for an origin station prior to a latest feasible drop-off time, wherein the latest feasible drop-off time equals the departure time minus export handling time for said route, and a pick-up time calculated for a route in accordance with the following relationship:

pick-up time equals earliest of a permitted set of pick-up times for a destination station after an earliest feasible pick-up time, wherein the earliest feasible pick-up time equals the arrival time plus import handling time for said route.

Data representative of a conveyance capacity associated with each segment, transport service level and/or performance category and data representative of attributes may be included in the route segment table. Advantageously, since the information is held centrally in the route segment table, a user can search the table and establish the availability of routes and preferably associated attributes quickly and efficiently without the transport provider being consulted first. That is to say, a computer system in accordance with the invention provides a service quite different to a simple broker system where a user request would be sent to each of the transport providers, each returning a response with the responses then being communicated to the user. Further, deriving the route segment table means user searches can be handled quickly and efficiently in real time. Without the route segment table, laborious searches would have to be made through a multiplicity of data tables.

The route segment table includes an origin and destination pair for each route segment. For segments comprising an individual route leg, the origin and destination pair correspond to the origin and destination stations for that individual route leg. However, for route segments comprising more than one route leg, the origin and destination pair for each route segment comprises the origin station of the first route leg of the route segment and the destination station of the last route leg of the route segment.

Transport providers may provide long term schedules specifying the route legs for a whole season, such as in a train time table for instance. Alternatively, transport providers may provide short term schedules specifying the actual instances (operational schedule) of route legs. Advantageously, in accordance with an embodiment of the invention the system is configured to handle schedule data in either form. Scheduling may be for flight routes, truck routes or routes relating to other vehicles used in the transport system.

In a preferred embodiment, the system is configured to receive and update data from the transport providers. The system may be further configured to initiate and send an update request message to the transport provider as a data update poll. Advantageously, the entries in tables in the memory unit of the system are kept up-to-date.

In accordance with a third aspect of the invention there is provided a method for operating a computer system configured substantially as described in the foregoing paragraphs:

said method comprising:

generating one or more route options responsive to a route search request specifying a journey having an origin and destination station pair, each route option comprising a route segment having an origin and destination station pair specified in said route search request and selected from said route segment table, said route segment comprising one or more route leg instances ascribed to the same one or more transport service levels and/or performance categories throughout said route segment; and

storing said one or more route options in a segment set list in said memory unit.

In accordance with a fourth aspect of the invention, there is provided a computer system substantially as described above, further configured to:

generate one or more route options responsive to a route search request specifying a journey having an origin and destination station pair, each route option comprising a route segment having an origin and destination station pair specified in said route search request and selected from said route segment table, said route segment comprising one or more route leg instances ascribed to the same one or more transport service levels and/or performance categories throughout said route segment; and

store said one or more route options in a segment set list in said memory unit.

The journeys may be specified by way of stations corresponding to specific transport depots, for example in an air transport system stations may correspond to airports. Optionally or additionally, journeys may be specified by way of a region such as a city associated with one or more stations.

Aspects of the present invention provide for the integration, handling and management of information relating to different service attributes of a transport system in a centralized process and apparatus. Information relating to different aspects of a transport system may be automatically combined to create different transport service levels for one or more route options meeting the journey origin and destination stations and other route search request criteria originating from a potential user of the transport system, e.g. a forwarder.

In a preferred embodiment, an origin and destination station pair for a requested journey are compared with a route table comprising permissible origin/destination station pairs, in order to determine a permissible routing option. Checking the list of routing options against a list of permissible routes provides a carrier, e.g. an airline, with the ability to set up permissible routes which they wish to market and against which requested journey origin and destination station pairs may be automatically checked. When deriving the one or more route options from said route segment table, only route segments for carriers marketing a route corresponding to the requested journey origin destination station pair are utilized. This reduces processing and an originator of the route search request (forwarder) has only those route options which a carrier wishes to market, returned to them.

In one embodiment the route table is used when deriving the route segment table, so that route segments are only created for routes which are permissible. Advantageously, this reduces the size of the route segment table and required storage space, consequently increasing search speeds.

The permissible route options may then be referred back to the originator of the route search request e.g. a forwarder, to allow them to view the list and decide which routing option most meets their requirements.

Typically, one or more consecutive route legs define a route segment. Such a route segment comprises route legs which have some form of association with each other. For example, the same vehicle may be used throughout the segment or in an air cargo system, the route legs making up the route segment may be part of the same flight. In one embodiment of the invention route legs are only combined to form route segments in the route segment table if the route legs have the same route identifier, for example the same flight number. By constructing route segments in this way, the system can handle data from different transport providers. In an air cargo system, some transport providers assign a single flight number to a flight comprising several legs whereas others assign a single flight number to each leg.

Preferably, two or more route segments of the route segment table may be concatenated to form a route option having an origin and destination station pair which correspond to the route search request. In an embodiment which has an attribute associated with each route segment, only route segments which each satisfy the route search request are concatenated. For example, if a search request specifies particular cargo dimensions or a particular container for holding loose cargo (a unitized loading device), only segments which have an associated compatibility entry specifying that the dimensions or unitized loading device are compatible with the leg will be returned.

Yet more preferably, the memory unit stores a transfer set table comprising a plurality of transfer set records, each associated with an origin and destination station pair. Each transfer set record includes one or more entries representative of one or more permissible transfer point stations between route segments for a route between an associated origin and destination station pair. Thus, it is possible for a carrier to set up a table for restricting the number of transfers between vehicles that can occur over any created route. Also the carrier can prevent certain journeys from being returned by not specifying transfer points that make up the journey. In particular, the transfer set table may be linked to the route table such that the transfer set records are each associated with a permissible route. Thus, a carrier may limit the transfers and the transfer stations in accordance with the facilities that the carrier has at that transfer station for the transfer of cargo between vehicles. This is of significant importance where the cargo comprises some form of fragility, such as perishable cargo (e.g. fruit and vegetables). A carrier having a transfer station without suitable refrigeration units may wish to restrict the transfer of such perishable cargo at stations which do not have such refrigeration facilities. The transfer set table may be used together with the route table when deriving the route segment table, again reducing the size of the route segment table and increasing search speeds.

Suitably, the route search request includes a parameter representative of a maximum number of transfer points in a route between the origin/destination pair to derive routing options which comprise no more transfer points than the maximum number. Thus, a user of the transport system may specify in advance the maximum number of transfer points they wish to have in any of the routing options created for them. This gives the forwarder the opportunity to request a search for routing options which can take account of the nature of the forwarder's intended cargo. That is to say, if a forwarder is wishing to purchase conveyance capacity for a fragile cargo, they may wish to avoid transfer points, or keep them to a minimum number, in order to reduce the likelihood of damage to the cargo and loss through theft by reducing the number of transfers between vehicles.

Structuring the information in this way provides a high degree of flexibility for creating route leg and segment combinations to meet search request criteria.

Advantageously, data representative of respective attributes of said route legs are received from said transport providers, said data being included in said route segment table. Thus, a route search request can include a parameter representative of an attribute such that one or more routing options may be derived wherein the origin and destination pair are associated with the attribute. Thus, the forwarder may request origin and destination station pairs for which the routes will have certain attributes, for example departure time and arrival time for a journey between the origin and destination station pair and conveyance capacity, for example. Separate tables are set up comprising one or more attributes of the transport system and which are used when deriving the segment set list. An operator of a transport system, for example a carrier, may then modify respective attribute tables to reflect the services they wish to offer, without having to modify a large table such as the segment set table. This reduces the complexity and processing necessary for updating the data tables.

In accordance with a fifth aspect of the present invention, there is provided a client computer system configured for remote communication with a computer system as described in the foregoing paragraphs. The client computer system comprises:

a processing unit;

an interface unit for communication with said processing unit;

a memory unit; and

a display means for displaying information to a user of said client computer system;

said processing unit comprising a user interface mechanism configured to receive said search request input via said interface unit from said user, and to communicate said search request to said computer system for processing thereby.

In a preferred embodiment, the client computer system comprises a user interface mechanism configured to provide a graphical representation of the route segment set list, the user interface mechanism being operable to display on a display means a plurality of route options including origin and destination station, departure date, arrival date, available conveyance capacity and price for conveyance arranged in a logical grouping, the user interface mechanism being responsive to a user input to select a displayed route option and to record a user booking of at least a portion of a conveyance capacity of the selected route option.

A sixth aspect of the invention provides a computer system network comprising a plurality of client computer systems and a computer system as described in the foregoing paragraphs.

In accordance with an embodiment of the invention, a short term schedule may comprise an extended-key and/or a standard-key schedule having different logical data keys.

In accordance with a seventh aspect, there is provided a method of configuring a computer system including a processing unit, an interface unit for communication with said processing unit and a memory unit, for providing an integrated representation of routes in a transport system comprising a multiplicity of connectable stations, the method comprising:

storing in said memory unit a short term extended-key schedule of individual instances of route legs each route leg corresponding to a connectable station pair, and

deriving from said short term extended-key schedule a route segment table comprising one or more extended-key route segments, each route segment corresponding to an individual instance of said route legs, or a combination of individual instances of said route legs.

In accordance with an eighth aspect of the invention there is provided a computer system comprising a processing unit, an interface unit for communication with said processing unit and a memory unit, for providing an integrated representation of routes in a transport system comprising a multiplicity of connectable stations, the system configured to

store in said memory unit a short term extended-key schedule of individual instances of route legs each route leg corresponding to a connectable station pair, and

derive from said short term extended-key schedule a route segment table comprising one or more extended-key route segments, each route segment corresponding to an individual instance of said route legs, or a combination of individual instances of said route legs.

Advantageously, implementing such a configuration enables extended-key segments and standard key segments to be processed in the same route segment table, allowing extended-key and standard-key segments to be combined to form route options. Such a configuration can be used to implement handling of virtual flight schedules in an air cargo system.

### BRIEF DESCRIPTION OF THE DRAWINGS

Specific embodiments, in accordance with the present invention, will now be described, by way of example only, with reference to the accompanying drawings, in which:

FIG. 1 schematically illustrates the geographic distribution of airports in an air transport system;

FIG. 2 schematically illustrates an example of a forwarder's cargo booking architecture;

FIG. 3 schematically illustrates the logical location of a data management system in accordance with an embodiment of the present invention;

FIG. 4 schematically illustrates functional aspects and relationships of a data management system in accordance with an embodiment of the present invention;

FIG. 5 schematically illustrates details of a database structure for a data management system in accordance with an embodiment of the present invention;

FIG. 6 illustrates a data model in accordance with an embodiment of the present invention;

FIG. 7 is a relationship diagram for establishing a flight segment table;

FIG. 8 schematically illustrates a maximum connection timetable;

FIG. 9 schematically illustrates a minimum connection timetable;

FIG. 10 is a relationship diagram for a carrier marketed route options table and a transfer points table;

FIG. 11 is a flow diagram for the creation of a flight segment table;

FIG. 12 schematically illustrates a network coupled data management system in accordance with an embodiment of the present invention;

FIG. 13 schematically illustrates the logical architecture of a data management system in accordance with an embodiment of the present invention;

FIG. 14 schematically illustrates the physical architecture of a data management system in accordance with an embodiment of the present invention;

FIG. 15 schematically illustrates a computer system workstation;

FIG. 16 schematically illustrates an example of a search for capacity user interface screen;

FIG. 17 is a flow diagram for a dmPerformSearch stored procedure in accordance with an embodiment of the invention;

FIG. 18 is a flow diagram for a dmFltLegSet stored procedure in accordance with an embodiment of the invention;

FIG. 19 is a schematic illustration of the search process for combinations of route segments for building routes in accordance with an embodiment of the invention;

FIG. 20 is an illustration of a results screen in accordance with an embodiment of the invention;

FIG. 21 is a flow diagram for a Carrier Search function in accordance with an embodiment of the invention;

FIG. 22 is a flow diagram for a Unitized Search function in accordance with an embodiment of the invention;

FIG. 23 schematically illustrates the architecture of a particularly suitable data management system in accordance with an embodiment of the present invention;

FIG. 24 schematically illustrates the relationship between data entities in accordance with an embodiment of the present invention;

FIG. 25 is a relationship diagram for a carrier product table, a cargo type table and a product cargo table;

FIG. 26 is a relationship diagram for a performance category table and a carrier product table;

FIG. 27 illustrates a schedule table;

FIG. 28 is a relationship diagram for a schedule type table, a schedule performance category table, a performance category table and schedule tables;

FIG. 29 is a relationship diagram for a schedule type table, a schedule performance category table and a performance category exclusions table;

FIG. 30 illustrates a connection times table and a handling times table for establishing a flight segment table;

FIG. 31 illustrates a flight connection times table and a flight handling times table;

FIG. 32 illustrates a rate card table;

FIG. 33 outlines a differentiation between different products;

FIG. 34 illustrates a drawback of existing systems;

FIG. 35 illustrates an advantage of an implementation in accordance with an embodiment of the present invention;

FIG. 36 illustrates a product layer and a physical layer;

FIG. 37 illustrates the dynamic generation of results in accordance with an embodiment of the present invention; and

FIG. 38 outlines performance monitoring.

### DETAILED DESCRIPTION OF THE INVENTION

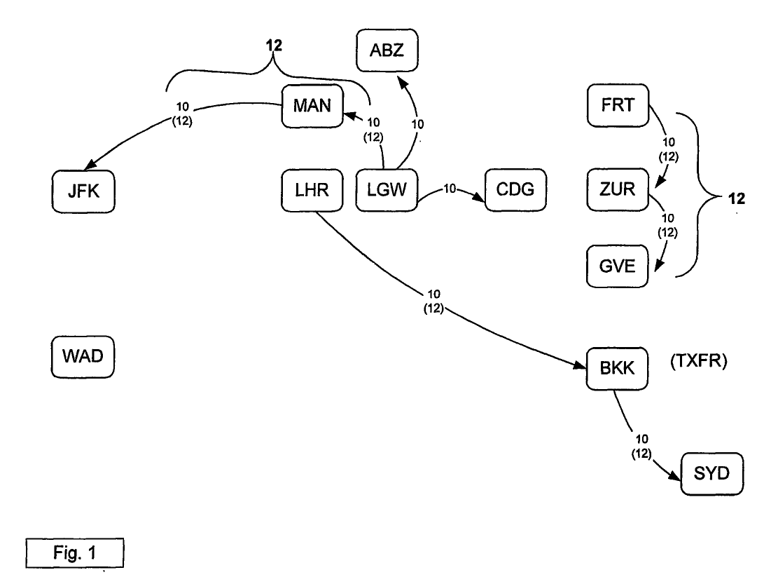

Referring now to FIG. 1, there is illustrated an example of a transport system having a plurality of connectable stations. In the particular example of FIG. 1, the transport system is an air transport system in which the connectable stations are airports. The airports are geographically distributed substantially as shown in FIG. 1 and are referred to using the International Air Transport Association (IATA) codes. In an air transport system a number of carriers, airlines, provide flights between airports thereby connecting stations within the transport system. A direct connection between two consecutive airports, is termed a flight leg, referenced 10 in FIG. 1. Flight legs represent the lowest level of connection within an air transport system and may be considered to comprise a “wheels up-wheels down” sequence. A single flight leg or combination of flight legs forming part of the same flight, e.g. having the same flight number, are termed flight segments, referenced 12 in FIG. 1. For individual single flight legs within a flight segment, reference 12 is placed in brackets indicating that the single flight leg forms a part of a flight segment. Generally, a flight segment is bounded by transfer points but may include any number of stopovers and even different aircraft.

A route between London Gatwick (LGW) and John F. Kennedy (JFK) airports shown in FIG. 1 includes a stopover, for re-fuelling and/or on-load or off-load of cargo, at Manchester (MAN) airport. Additionally, there are connections between LGW and MAN, and MAN and JFK. Each connection, LGW/MAN and MAN/JFK is a flight segment.

The route between LGW and JFK is also a flight segment and comprises flight legs LGW/MAN and MAN/JFK. Freight on flight segment LGW/MAN may connect with the flight segment LGW/JFK at MAN, thereby using flight leg MAN/JFK of flight segment LGW/JFK to complete a route between LGW and JFK.

For the journey shown from London Heathrow (LHR) to Sydney (SYD) via Bangkok (BKK), two flight segments 10 are shown. These are not flight legs for the journey LHR to SYD, because a transfer (TXFR) between flights occurs at BKK, and thus the journey LHR to SYD is not a single flight segment. Additionally, airports may be connected by road or rail. For example, a truck may be booked to transport cargo from Zurich (ZUR) to Geneva (GVE) for transferring onto a flight to another airport, if no suitable flight is available into Geneva airport.

Airlines often operate primarily within geographic areas and do not offer service between all airports. Restrictions are generally due to the service locations of the aircraft for a particular airline, as well as market and business plans of the airline. In particular, many airlines are state-owned, controlled or strongly linked with the state, which often restricts the operation of the airline.

In air cargo transport systems there are a number of players. There are the carriers who provide cargo capacity on flights; the forwarders who book cargo capacity from carriers; and integrators who combine the function of both carrier and forwarder into a vertically integrated service.

Carriers provide air cargo capacity within aircraft. In general, they do not interface directly with shippers wishing to have cargo transported (or the receivers of air cargo), but distribute cargo capacity via freight forwarders who function as their agents or brokers.

Carriers may be divided up into three main types. The first type includes carriers who provide both passenger and cargo service. Typically, the air cargo service comprises the excess belly-hold space on passenger aircraft, although there are a number of passenger airlines that operate dedicated freighter aircraft. Some of these passenger airlines also operate so-called “combis” that have some of the main-deck seats of the passenger cabin removed in order to give additional cargo capacity.

A second type of carrier is the cargo only carrier. These are carriers dedicated to the transportation of cargo through the operation of an all-freighter fleet and comprise freight operator companies such as CargoLux and Polar. In most cases, the carriers operate regular or semi-regular services and distribute their cargo capacity through freight forwarders. In some cases, the freighter operators will offer specially arranged or charter flights on an as-needed basis.

A third type of carrier is the so-called “private label” carrier. Such carriers, for example Atlas, promote the outsourcing of freighters by operating aircraft on behalf of other carriers who contract for the full freighter including the pilot. Optionally, the private label carriers will sub-divide an aircraft on behalf of two or more conventional carriers.

Freight forwarders, more commonly referred to as “forwarders”, are brokers of air cargo capacity in the sense that they principally buy capacity on behalf of shippers, and manage the logistics and customer documentation on behalf of the shippers. Generally, forwarders do not own their own aircraft, and where they do they may be considered to be integrators, as described later.

The forwarder industry is highly fragmented with in excess of 10,000 such undertakings throughout the world. Indeed, there are estimated to be around 1000 forwarders in the UK alone. Although forwarders are generally multi-modal in that they ship via sea, road and rail in addition to air cargo, a very significant proportion of their activities and resources are directed to the air cargo market.

There is a third type of player in the air cargo transport environment which has only recently become significant. This player is known as an Integrator. Integrators own their own aircraft and interface with customers through an extensive retail/ground network to provide the forwarder function. The four main players are currently Fedex, UPS, DHL and TNT, who represent a vertical integration of the airline and forwarder functions.

Within the air transport system, certain locations are known as “hubs”. Hubs are the main entrances or portals to the air transport system and are distributed throughout the main territories of the air transport system. Typically, cargo is transshipped between aircraft at hubs. A hub is usually a carrier base, where the carrier's operational equipment is stored, maintained and serviced. Forwarders generally have their infrastructure based around one or more hubs.

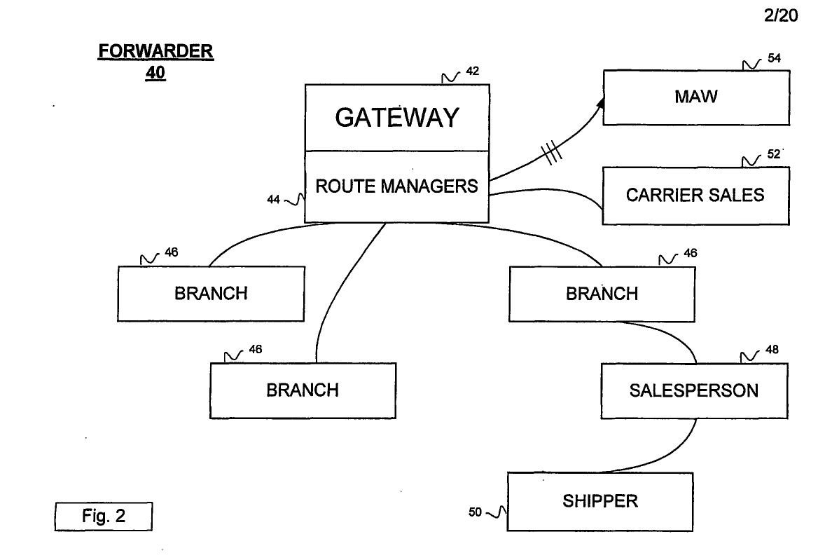

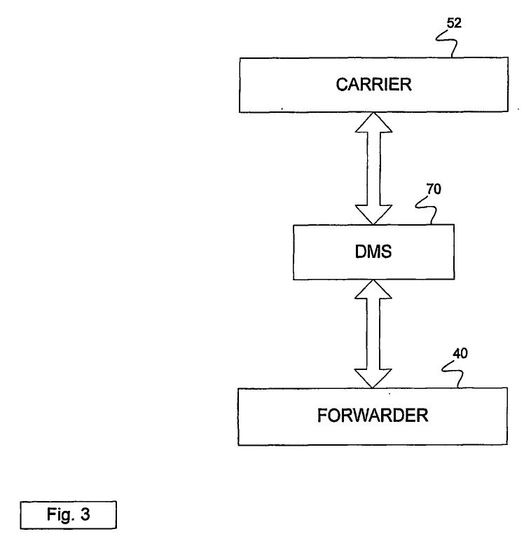

The existing forwarder infrastructure for making cargo bookings will now be described with reference to FIG. 2.

The gateway 42 is controlled and managed by a combination of a carrier route manager 44 and a forwarder gateway manager. The carrier route manager receives cargo capacity requests from a forwarder gateway manager who in turn receives cargo capacity requests from respective forwarder branches 46, who have been contacted by a sales person 48 to provide cargo capacity on behalf of a shipper 50, or direct from a shipper. Currently, requests for cargo capacity made to the carrier route manager from the forwarder gateway manager are made via telephone, fax or e-mail.

Typically, an individual sales person 48, or a branch 46, is provided with cargo capacity targets for sale to shippers. As cargo is received from shippers 50 and forwarded to the forwarder gateway manager, the forwarder gateway manager seeks to balance the cargo capacity requirements with the capacity he has pre-booked or can negotiate with the carriers. Separate cargo packages from shippers are consolidated at gateway 42 for onward carriage. Optionally, the branch or salesperson consolidates shipments before passing them onto the forwarder gateway manager. The forwarder gateway manager is responsible for negotiating and managing consolidated bookings and regular bookings on a given route or set of routes. They negotiate with the carrier route manager to ensure that adequate cargo capacity has been booked to meet the forwarder organizations consolidation, general cargo or ad hoc requirements. The forwarder gateway manager negotiates by fax, telephone or e-mail with a carrier sales person 52 or the carrier route manager in order to manage the cargo capacity requirements on a daily, weekly, basis, etc, as appropriate. Optionally, the carrier may operate a telephone call center. This can be a substantial challenge, since there can be differences in the daily (including hourly), weekly and seasonal demand for air cargo capacity. Such differences are driven by consumer and industrial buying patterns, shipper manufacturing configurations, scheduling and shipping approaches, such as back consolidation or just in time shipping. For example, even a relatively minor breakdown at a manufacturing facility of a shipper with substantial volume on a given route can create a backlog of goods and throw the market into imbalance for weeks. The demand variances are also complicated by global micro-economic trends such as GDP growth, foreign exchange rates and labor rates which can have a significant impact on the directional focus of any given route and by micro-economic conditions such as labor strikes.

The forwarder gateway manager makes two types of bookings, permanent and ad hoc bookings. Permanent bookings are long-standing bookings of six months or more allocation of cargo capacity on a given flight. Ad hoc bookings, as their name suggests, are made at the time they are required. They exist outside of the permanent bookings arrangement. The permanent bookings may have different rates in accordance with various factors such as day, month, nature of cargo, route, capacity, etc.

The forwarder gateway manager utilizes the forwarder computer legacy system to analyze the record of all permanent bookings made with the various carriers. The gateway manager then seeks to balance all the difference cargo capacity requirements originating from the branches to best utilize the available permanent booking. Any excess requirement on any particular route would then be achieved by ad hoc bookings. The permanent bookings are made by negotiation with the carrier sales 52, although are generally based upon long-standing expectations and commitments. What is more complex, are the ad hoc bookings in which a forwarder gateway manager has to contact a number of carrier sales 52 in order to determine what cargo capacity over what routes and at what price are available to fulfill the ad hoc requirement. Currently, this is achieved by virtue of telephone calls, fax transmissions and, sometimes, electronic mail. Thus, the forwarder gateway manager has to contact an individual carrier sales person 52 to determine available cargo capacity to meet the ad hoc requirement for that carrier. The forwarder gateway manager has to contact each carrier sales person 52, for each carrier operating at the hub in order to determine what cargo capacity is available. The forwarder gateway manager then has to analyze all the information to determine with which carrier to book the ad hoc capacity. However, it is often the case that the forwarder gateway manager is unable to get an immediate answer from the carrier sales as to available cargo capacity since the carrier sales would have to conduct their own investigations within the carrier to determine what is currently available. This may occur with many of the carriers with sales persons with whom the route manager has requested ad hoc capacity. This introduces a significant latency in the information available to the forwarder gateway manager, and makes the booking of appropriate cargo capacity extremely difficult.

The forwarder gateway manager consolidates the shipments in terms of permanent bookings and ad hoc bookings from the branches at the gateway 42 and transfers the individual house airway bills (HAWB) for each shipment onto a master airway bill (MAWB) pre-allocated by the carrier. The forwarder gateway route manager also organizes and manages shipments into Unit Load Devices (ULD) for transfer to the carrier or may merely provide loose or bulk shipments which will be packaged and unitized by the carrier themselves. ULDs are containers for holding loose cargo. They are of three main types: containers which are enclosures with or without lids; pallets; or igloos which sit on top of a pallet and restrict or constrain the volume of cargo supported by the pallet.

Forwarders may not have contractual penalties applicable for the permanent bookings that they maintain with carriers. As such, there may be no incentive or penalty if the forwarder is a ‘no-show’, or ships less than was booked. The forwarder gateway manager may also alert the carriers sales 52 when a permanent booking or allocation made on behalf of the forwarder is unlikely to be used. When negotiating with the carrier sales 52, the forwarder gateway manager will often haggle over the rates for a particular shipment.

In general, the existing forwarder/carrier interface is very difficult to manage since a plurality of negotiations are necessary and there is a significant latency within those negotiations. Furthermore, there is a low visibility of the availability of cargo capacity and currently there is no electronic or automated integration between the forwarder systems and the carrier legacy systems.

Furthermore, in order to complete a booking, the forwarder gateway manager has to await confirmation of the booking by typically a fax back communication which provides proof to the shipper that a booking for their shipment has been made. The airway bill is then utilized on the basis of this booking and fixed to the shipment. As mentioned above, individual airway bills are appended to a master airway bill 54 for the combined booking made by the forwarder with the carrier.

The carrier sales 52 or route manager 44 labor under significant limitations as to data availability on air cargo capacity within their carrier. The carrier sales 52 and route manager 44 wish to optimize the revenue obtained from their cargo business which would typically require a high level of flexibility in rates and type of cargo in order to fully utilize the capacity. However, at the moment, the carrier sales 52 and route manager 44 just know the weight available on a particular route at any particular moment. This substantially limits the service that they can provide to the carrier.

In accordance with an embodiment of the present invention, data management system (DMS) 70 is provided between the carriers sales 52 or route manager 44 and the forwarder (typically the forwarder gateway manager), as illustrated in FIG. 3. The DMS 70 in accordance with the invention provides an interface between the carrier sales 52 and the forwarder 40 in order to enhance the nature of the transactions conducted between them. Suitably, the DMS 70 provides up-to-date, on-line scheduling, including cargo capacity. Additionally, a quote market is available in which buyers of capacity can view data about the price at which a carrier will make capacity available to them to meet their requirements, for example by route, shipment type, weight and cargo type. Furthermore, such a DMS system is capable of performing complex searches in order to enable forwarders to input a desired origin/destination airport pair and a range of search criteria, such as preferred vehicle types, cargo type and shipment type, and then search and display a list of carrier options to meet these criteria. A further enhancement is that the display order may be determined by the customer's prioritization of search criteria (e.g. by placing a priority on preferred carrier relationships, lowest rate, earliest departure or latest arrival). Such prioritization may be by way of a parameter pre-set by a forwarder, or input at the time of searching. Additionally, a reverse market or auction may be conducted by virtue of the DMS 70, in which prospective buyers of capacity can place a request for a quote to a selected set of carriers. Optionally, an auction market may be provided where prospective sellers of capacity, typically carriers, initiate an auction for excess capacity over a particular route with unsold capacity.

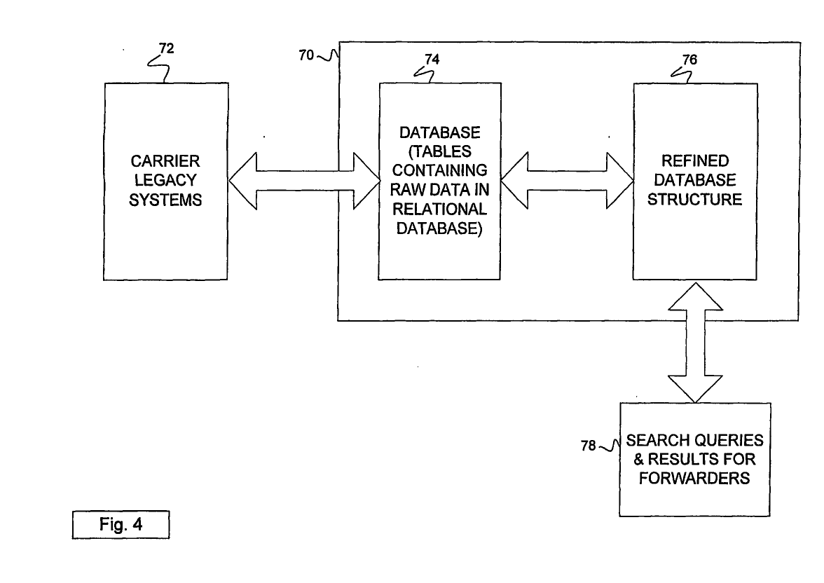

The functional aspects of the DMS 70 and their relationship to the carrier and forwarder will now be described with reference to FIG. 4.

DMS 70 contains a relational database including tables comprising raw data received from carrier legacy systems 72. The DMS system derives a refined database structure 76 from the raw data contained in database 74. The refined database structure 76 is configured for efficient searching in response to search queries from forwarders 78. A forwarder submits a search query to the DMS 70 and has returned to it a results table which includes carrier routes conforming to the search query criteria. The tables contained in database 74 are set up such that the data may be easily maintained and updated over a link from the carrier legacy system 72, preferably an automatic update link. Any changes in database 76 caused by updating of database 74 are then effected such that the revised database structure 76 is kept up-to-date, in order to service search queries and provide suitable results to the forwarder's systems 78.

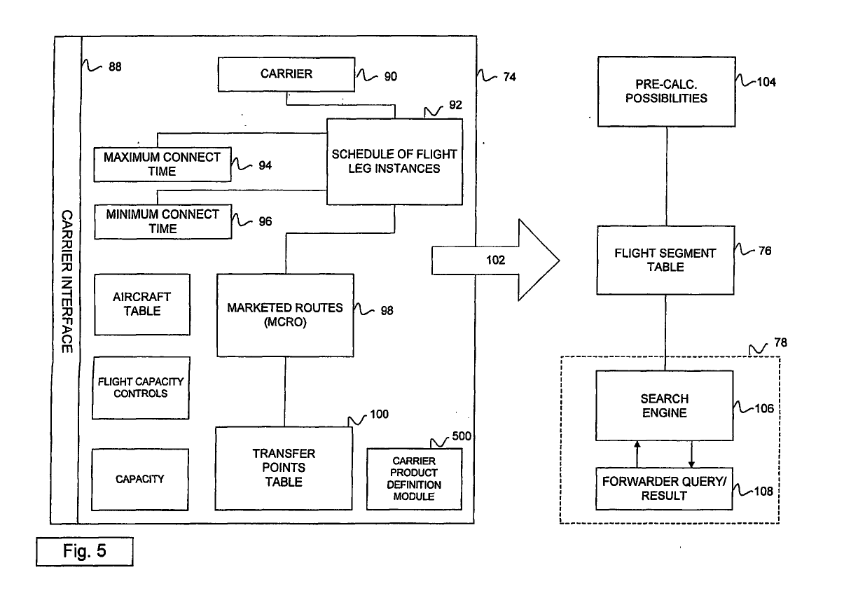

Relational database 74, containing the raw data received from the carriers, will now be described in further detail with reference to FIG. 5. Relational database 74 contains a plurality of data tables. The data is input to the database from the carriers over a carrier interface 88. Optionally, where there is no electronic interface with the carriers, the data may be input by way of keyboard entry by the operator of the DMS system. Database 74 contains a carrier table 90 comprising a list of carriers taking part in the DMS 70 in accordance with the invention. For each carrier entered into the carrier table 90, a series of related tables are stored in the database. At the top level, there is stored an operational schedule table 92 for each carrier. Not all carriers provide an operational schedule, which is for a limited period, for example 2 weeks or 1 month, but instead provide a seasonal schedule which is typically a 3 month or 6 month advance schedule of flights. Schedule table 92 comprises the operational schedule (a short term schedule) provided to the DMS, or as derived from the seasonal schedule (a long term schedule), as appropriate to the particular carrier. The operational schedule table 92 provides a schedule of each flight leg instance for the carrier 90. That is to say, each flight between stations, the origin & destination stations, the time and date of arrival and departure, equipment type and ability to on-load or off-load cargo at each station for the flight are recorded in the operational schedule.

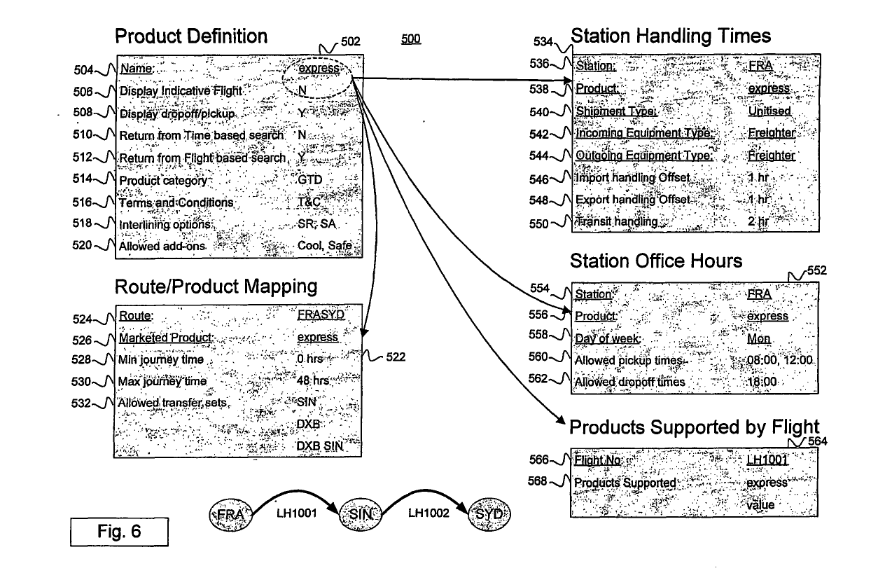

In accordance with an embodiment of the invention, database 74 also includes product definition module 500, for defining products sold by the carrier within their service offering. FIG. 6 illustrates an embodiment of a product definition data model for product definition module 500 in accordance with an embodiment of the invention. In accordance with a preferred embodiment of the invention, product definition module 500 is split into 5 sub-modules comprising a product definition sub-module 502, a route/product mapping sub-module 522, a station handling times sub-module 534, a station office sub-module 552 and products by flight to sub-module 564.

Product definition sub-module 502 defines each service level or product in terms of non-operational service attributes and rules for that product. In a preferred embodiment, the product definition sub-module comprises the name 504 of the product, which in the illustrated example is an “express” product. Other non-operational service attributes are whether or not the DMS will display an indication of the flight, 506, which were used by the product, and whether or not it will display the drop-off/pick-up times, 508, for dropping off and picking up the cargo at respective origin and destination stations. Additionally, product definition sub-module 502 also contains service attributes which may be set to determine whether or not the product will be returned for a particular type of search, such as a time base search, 510, or a flight base search, 512. The product definition sub-module 502 will also contain a definition of a product category, 514. The terms and conditions relating to that product, 516, whether or not any interlining options are available, 518, and what add-ons, 520, may be allowed. In the present example, the add-ons allowed for the illustrated product definition are that the carriage of the cargo will be at a temperature defined as ‘cool’, and within a safe environment. For example, a carrier may guarantee that the temperature of the cargo will not exceed a certain temperature, or lie within a certain temperature range as defined by ‘cool’. Additionally, the carrier offers safe carriage of the cargo, which may comprise a certain type of secure labeling device or secure holding, transfer, import and export areas.

By defining a product definition centrally as illustrated by sub-module 502, a carrier may define a generic type of product for the whole of their service offering. Furthermore, a carrier can modify the service attributes of their products centrally, which allows for a high level of flexibility such as may be necessary to respond to varying market conditions for example. Furthermore, a centralized, generic definition of products reduces the possibility of error in products definitions such as may occur if products were non-centrally defined.

Product definition module 500 also includes route/product mapping sub-module 522. Within the illustrated data model, route/product mapping sub-module 522 is related to the product definition sub-module 502 by way of the marketed product, 526, which in this case is an “express” product. The route/product mapping sub-module 522 includes a route, 524, in this instance Frankfurt to Sydney (FRASYD), together with the product, 526, offered for that route. In the illustrative example, each route/product defines a minimum journey time, 528, a maximum journey time, 530, and the allowed transfer stations defined in transfer set 532. A particular route, for example FRASYD, may be marketed under more than one product. For example, a route for FRASYD for a “value” product may have a maximum journey time, 530, of 72 hours, rather than the 48 hours defined for the “express” product. Also, more transfer stations may be defined in transfer set 532 for a “value” route.

Product definition module 500 also includes a station handling times sub-module 534. Sub-module 534 includes a number of tables each relating to a particular station in the transport system, which in the illustrated embodiment is Frankfurt, FRA, 536. Each station is related to product definition module 502 by the product name, 538, which in the illustrated example is an “express” product. For each station and product, operational service attributes may be defined. Typically, the operational service attributes are the import handling time, 546, the export handling time, 548, and the transit handling time 550 for the carrier offering the product at that station. Import and export handling times are self-explanatory, and the transfer time is the connection time for cargo traveling through that station. Typically, the import, export and transit handling times are dependent upon the cargo shipment type, 540, that is to say whether a loose or unitized cargo, the incoming, 542, and outgoing, 544, equipment type, such as whether the equipment is a freighter or other vehicle such as a truck. In the illustrated example, it can be seen that for an express product at Frankfurt, a unitized cargo arriving and/or departing on a freighter can expect an import and/or export handling time of no more than one hour, or a transit handling time of no more than two hours.

A further sub-module, 552, relates to station office hours operated by a carrier. Such a sub-module is set up for each station, 554, which in the illustrated example is FRA. The service attributes defined in the station office hours sub-module, 552, are a mixture of both non-operational service attributes and operational service attributes. In the illustrated example, for an express product, 556, the allowed pick-up, 560, and drop-off, 562, times for a Monday, 558, are defined. In part, the pick-up and drop-off times are defined by operational service attributes, in that for a Sunday when a station office may be closed, the entries 560, and 562, will be left blank. However, they may also be defined by non-operational service attributes such as the level of service that an express product provides at this particular station in terms of when cargo may be dropped off or picked up.

A further sub-module, 564, defines which flights support particular products. In this instance, a particular flight number, 566, is defined as supporting one or more products, 568, which in the illustrated example are express and value products.

All of the sub-modules within the product definition module 500 may be centrally located in database 74, and modified or altered centrally by a carrier.

Optionally, station handling times sub-module, 534, and station office hours sub-module, 552, may be included in flight segment table, 76, and associated with the respective stations in the flight segment table. Products by flight sub-module, 564, may be part of a flight table, whilst the route/product mapping sub-module, 522, may be a part of the marketed routes MCRO table, 98.

Other data modules for the product definition may be utilized, and respective definition sub-modules may be physically or logically disposed in any suitable fashion within the DMS.

In a preferred embodiment of the invention, a minimum connect time table 96 is provided which is related to the operational schedule table 92. The minimum connect time table 96 is a table of the stations included in schedule table 92 together with the minimum transfer times between carrier aircraft at that station. Preferably, a maximum connect time table 94 is also provided and comprises a table of the stations referred to in the schedule table 92 together with the maximum connection time for transfers between carrier aircraft at that station. The minimum and maximum connect tables may be utilized to calculate the transit handling time at a particular station, and used to determine whether or not a particular route segment or leg fulfils a product requirement.

A further table related to the schedule table 92 is the Marketed Carrier Routes Options (MCRO) table 98 (a route table). This table contains the routes marketed by the carrier, together with other relevant information for that route. Related to the carrier's MCRO table 98 is a transfer points table 100. The transfer points table contains a list of the marketed routes, together with the number of transfer point stations allowable for a journey over that route.

At least a part of the data contained in database 74 may be transferred, 102, to a pre-calculation routine 104 which derives the flight segment table 76 from the data in database 74.

Pre-calculation routine 104 creates an instance of every valid combination of flight legs derived from respective operational schedule tables 92. Valid combinations of flight legs are formed in accordance with the examples disclosed in the description of FIG. 1. Namely, that a flight segment is bounded by transfer stations. Any number of flight legs may be combined to form a flight segment.

Referring now to FIG. 1, pre-calculation routine 104 instantiates flight segments LGW-MAN, MAN-JFK and LGW-JFK, showing all possible flight leg combinations. However, only flight segments LHR-BKK and BKK-SYD are instantiated in flight segment table 76, without an instance of LHR-SYD, since BKK is a transfer station. That is to say, cargo is transferred from one aircraft to another at BKK for onward carriage to SYD.

The DMS system also includes a search engine 106 which is coupled to the flight segment table 76 and responds to a search query 108 to search for suitable flights in the flight segment table. The search engine also interrogates other data tables in the DMS system which relate to parameters in the search request and the flight segments. The search engine also returns search results 108 to the forwarder submitting the query.

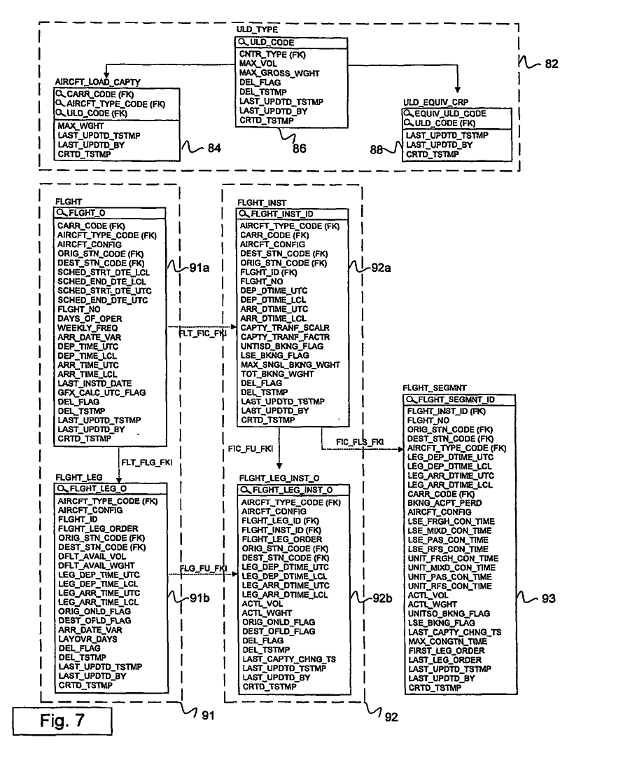

An example of the data provided by a carrier in a seasonal schedule table entry 91 is illustrated in FIG. 7. The entry is represented as a column. Many entries make up the seasonal schedule.

The seasonal schedule entry 91 is divided into two parts, 91a representing a flight and 91b representing a flight leg of the flight represented by 91a. For each flight 91a, there may be one or more flight leg entries 91b respectively corresponding to each flight leg of flight 91a. The flight leg entry/ies 91b are child/ren of flight entry 91a.

Flight entry 91a comprises information characterizing a flight, for example: carrier code (CARR_CODE); aircraft type and configuration codes (AIRCFT_TYPE_CODE) and (AIRCFT_CONFIG) respectively; origin and destination stations for the flight (ORIG_STN_CODE) and (DEST_STN_CODE); the seasonal schedule start and end dates (SCHED_STRT_DTE) and (SCHED_END_DTE) in both local and universal time (i.e. GMT) shown by the extension LCL and UTC respectively; the flight number (FLIGHT_NO), days of operation (DAYS_OF_OPER) and the weekly flight frequency (WEEKLY_FREQ) are also included in the entry; and the arrival and departure times (ARR_TIME) and (DEP_TIME) are given in both local (LCL) and universal time (UTC).

Flight leg entry 91b includes the identity of the flight of which it is a leg, (FLIGHT_ID), and the order of the leg within the flight, (FLIGHT_LEG_ORDER). The leg departure and arrival times (LEG_DEP_TIME) and (LEG_ARR_TIME) are included for both local (LCL) and universal (UTC) time. Also included in flight leg entry 91b is information on the usual cargo capacity for the aircraft type and configuration in terms of weight (DFLT_AVAIL_VOL) and volume (DFLT_AVAIL_WGHT). The flight leg 91b is also identified as allowing cargo to be on-loaded at the origin and off-loaded at the destination by setting flags (ORIG_ONLD_FLAG) and (DEST_OFLD_FLAG) respectively.

The operational schedule 92 is either derived from the seasonal schedule 91 or is supplied directly by the carrier, and an entry for flight instances and flight leg instances are shown labeled 92a and 92b respectively in FIG. 7. As mentioned above referring to FIG. 6, in one embodiment service attributes comprising product definition, station handling times and station office hours sub-modules may be stored in the flight segment table 76, which for the data structure illustrated in FIG. 7 would mean that they may be located in the flight instance and flight leg tables for respective origin and destination stations.

Flight instance entry 92a is a child of flight entry 91a. Flight instance entry 92a contains more detailed information regarding individual flights, i.e. a flight instance. The departure and arrival times are provided by date and time (DEP_DTIME) and (ARR_DTIME) in both local and universal time.

The types of allowable cargo and limits of cargo are included in the fields (UNITSD_BKNG_FLAG) and (LSE_BKNG_FLAG) for indicating whether unitized or loose cargo bookings are allowed, and (MAX_SNGL_BKNG_WGHT) and (TOT_BKNG_WGHT) for the maximum single booking by cargo weight, and the total weight of cargo bookings by a forwarder organization that may be taken. The contents of these fields may be set to default values dependent on the aircraft type and configuration, or by the carrier. The maximum single booking weight limit and total booking weight limit may be set by the operator of the DMS as a system parameter, automatically or manually derived from the default values, for example.

Flight leg instance entry 92b is a child of both flight instance entry 92a and flight leg entry 91b. The flight leg instance entry 92b includes specific details of that flight leg. For example, the leg order (FLGHT_LEG_ORDER), flight instance and flight leg identities (FLGHT_INST_ID) and (FLGHT_LEG_ID), and the actual cargo capacity available by volume (ACTL_VOL) and weight (ACTL_WEHT). Other fields corresponding to fields of flight leg entry 91b and flight instance entry 92 are also included as shown in FIG. 7. The actual cargo capacity available by volume and weight is preferably provided separately to the schedules. For example available capacity data for each route leg instance may be provided by each carrier. Alternatively, carriers may set default values for sets of legs. In a preferred embodiment carriers provide capacity data in a table for each route leg instance and may provide capacity updates.

A flight segment entry 93, corresponding to an entry in a flight segment table, is derived from the flight instance entry 92a and flight leg instance entry 92b. The fields for flight segment entry 93 include the flight number, flight instance identity, origin and destination stations, the carrier code, arrival and departure times and the aircraft configuration. Also included is a field for setting a period prior to flight departure during which no further cargo bookings for the flight segment may be taken (BKNG_ACPT_PERD); this defines a booking acceptance time. This field may be set by the DMS operator or be a default period, for example. The available volume and weight of cargo capacity is included in the flight segment entry 93, together with the connection times for different types of cargo for different types of aircraft. The connection time categories are loose (LSE) or unitized (UNIT) freighter (FRGH_CON_TIME), mixed passenger and freighter, (MXD_CON_TIME), passenger (PAS_CON_TIME) or truck (RFS_CON_TIME). In a preferred embodiment the type of equipment from which the cargo is off-loaded and on to which cargo is to be loaded, determines the connection time. In a preferred embodiment, flight segment entry 93 also includes a maximum connection time (MAX_CONCTN_TIME) which is a system wide parameter and field for (LAST_LEG_ORDER) and (FIRT_LEG_ORDER), respectively identifying the last and first flight leg in the segment. The flight segment entry 93 will also include the service attributes for the station handling times and station office hours sub-modules if they are included in the flight instance and flight leg tables.

Also illustrated in FIG. 7 are Unitized Loading Device (ULD) tables 82. Aircraft load capacity table 84 is provided for each aircraft type, identified by AIRCFT_TYPE_CODE(FK), and is maintained by respective carriers having carrier codes CARR_CODE(FK). Each table 84 includes a field ULD_CODE(FK) indicating the ULD type which the identified aircraft can carry.

Table 86, ULD_TYPE, comprises a full list of the ULD types, drawn from what are used in the cargo freight industry.

Table 88, ULD_EQUIV_GRP, maps ULD type codes onto equivalent ULD codes (EQUIV_ULD_CODE), in order to harmonise different ULD types used in the industry to standard types used in the DMS system. For example, different ULD codes may be used in the industry to refer to the same ULD type or different ULD codes may be compatible.

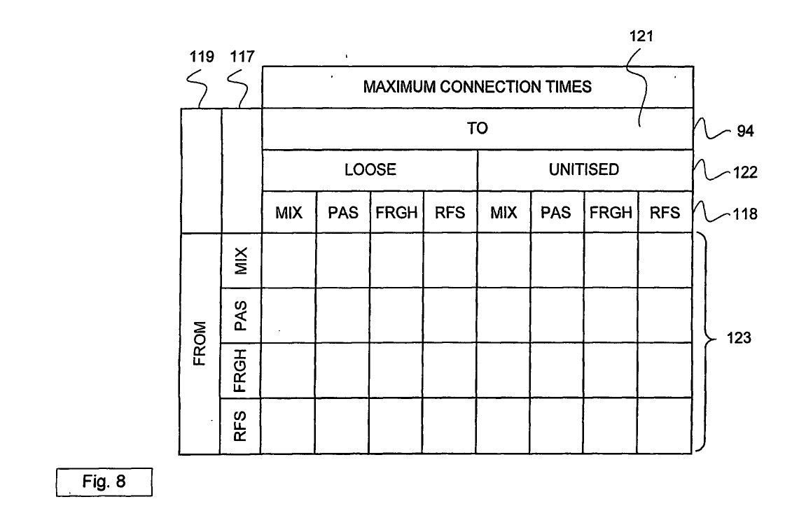

FIG. 8 is an example of a maximum connection time table 94 in accordance with an optional embodiment of the invention and from which the maximum connection time fields for the flight segment table 93 can be populated. The table is in the form of a grid, each type of carrier equipment (117, 118) is represented as being an originating equipment from (119) which cargo is unloaded, and to (121) which cargo is transferred. The grid is split into two repeating parts for loose and unitized cargo 112 respectively. The grid cells 123 each hold a value which represents the maximum connection time for transfers of cargo between the equipment and for the shipment type to which the cell relates.

A maximum connection time table 94 is set up for each station in the carrier's network at which on-load and off-load of cargo can take place. The maximum connection time table 94 illustrated in FIG. 8 is merely an example, in grid format, of such a table. It is readily recognizable that other logical structures and criteria may be utilized, and embodiments of the invention are not limited to specific examples. For example, it may be the case that the maximum connection time is dependent upon the type of cargo that is being transferred, and therefore the time may vary according to cargo type. An example of a cargo type where maximum connection time may be critical is that of perishable goods, such as food and vegetables. The maximum transfer time for such cargo may be significantly shorter than the maximum transfer time for non-perishable goods such as electronic equipment.

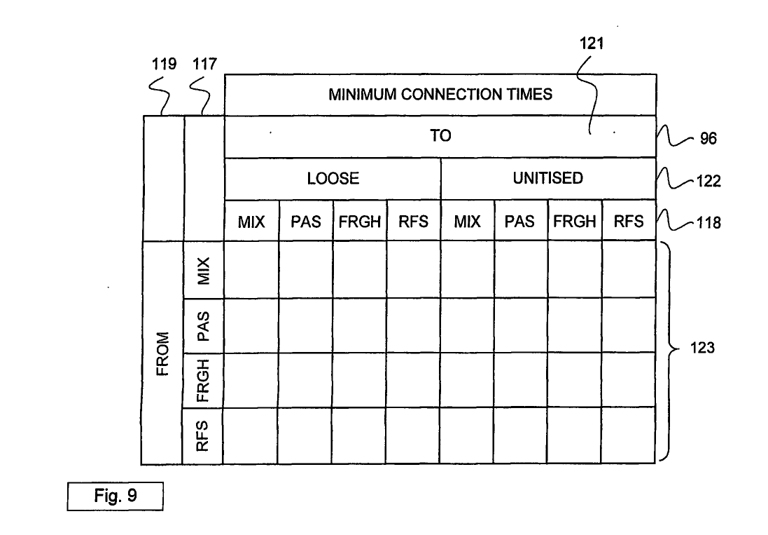

FIG. 9 is an example of a minimum connection time table 96. The minimum connection time table 96 is shown having a similar logical structure to the maximum connection described with reference to FIG. 8, and so no further description will be provided.

As described above with reference to FIG. 6, the maximum and minimum connection time tables 94, 96 may be utilized to determine if a station can fulfill the transit handling time for a particular product at that station.

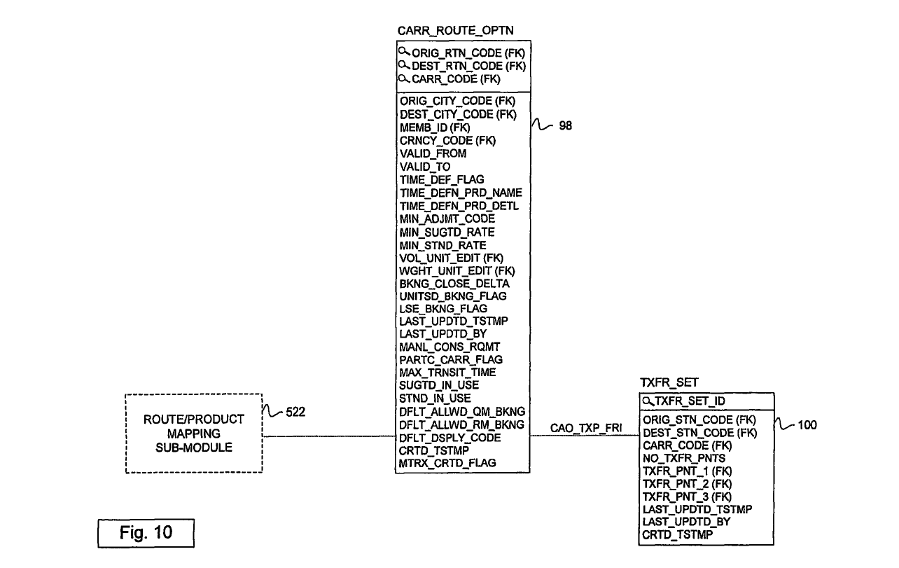

An example of an MCRO table 98 is illustrated in FIG. 10. The MCRO table 98 defines the carrier route options which the carrier wishes to market. To this end the origin station and destination station are defined together with a carrier code, respectively designated ORIG_STN_CODE, DEST_STN_CODE and CARR_CODE. Typically an origin city and destination city are included in MCRO table 98 and are designated ORIG_CITY_CODE and DEST_CITY_CODE. However, designating the origin and destination city is not necessary. Various other fields are available within the MCRO table which relate to DMS parameters which control all management aspects of the DMS and will not be described in detail. However, the carriers are able to define a suggested rate for the carriage of cargo as well as a minimum rate, (MIN_SUGTD_RATE) and (MIN_STND_RATE) for the route. Additionally, there is a unitized and a loose booking flag for indicating the type of cargo the carrier wishes to carry on this route. These flags are represented by the fields UNITSD_BKNG_FLAG and LSE_BKNG_FLAG respectively. A maximum journey time for the route (MAX_TRNSIT_TIME) is also specified. The MCRO table 98 illustrated in FIG. 10 is just for one carrier and one route. Every carrier will define each of their marketed routes by such a table, and it will be evident that the tables need not be structured in the manner illustrated in FIG. 10, but may be formatted in any suitable logical structure.

Also illustrated in FIG. 10 is a transfer sets table 100, which is related to the MCRO table 98. The transfer set table 100 is a child of the MCRO table 98. Within the transfer set table is included the origin station code and destination station code of the related carrier routes, together with the carrier code. In the example illustrated in FIG. 10, there are four fields which specify the number of transfer points in a transfer sequence and the sequence of up to 3 transfer points itself for the marketing route. These fields are respectively designated NO_TXF_PNTS, TXFR_PNT_{—}1, TXFR_PNT_{—}2, and TXFR_PNT_{—}3. For each of the fields for which a station may be designated as a transfer point, the appropriate station code is entered into the field. If not all the possible transfer points are used, for example only two stations are to be designated as transfer points, then the field for the third transfer point may be left blank indicating that there is no third transfer point available. Multiple sequences of transfer points (transfer sets) may be specified for a single carrier marketed route.

The transfer set table provides a high level of flexibility for the carrier in terms of the routes they wish to market. It is a relatively simple matter to modify which stations are to be transfer points and whether or not transfers are to be available at all. In this way, the marketed options can be easily updated and modified. Another advantage is that the carrier does not have to define every single available route, but merely the combinations of transfer point stations available. Thus, the carrier or DMS operator has minimal maintenance or set up to perform on the data.

In an optional embodiment, route/product mapping sub-module, 522, may be related to MCRO table 98, and is shown in broken outline in FIG. 10.

As described in the foregoing, the flight segment table 93 is derived from the seasonal 91 and/or operational tables 92 provided to the DMS 70 by the carriers. The flight segment table 93 is created for each possible flight segment provided by the carriers using the DMS 70 system. Thus, only a small number of tables, i.e. the flight segment table, the MCRO and some miscellaneous tables need be opened and interrogated in order to search for suitable routes in response to a search query. Relevant data from the different carriers has been de-normalized into at least an operational seasonal schedule 92, and then used to populate the relevant fields of the flight segment table 93. Thus, the many different systems and data utilized by different carriers are transparent to the user of the DMS 70 system, who merely sees the flight segment table 93.

In addition to the flight segment table 93 containing relevant information for any searches, there is MCRO table 98, and the transfer points table 100. A search query will still interrogate the MCRO 98 table to determine whether a requested route option is marketed by a carrier or carriers, that route in turn being limited by the transfer points defined in the transfer set table 100. Additionally, route/product mapping sub-module 522 is interrogated to determine which products are valid for that route. However, once the marketed route has been established as an existing route for a carrier, and the transfer stations have been identified then the flights segment table 93 is utilized to find the flight segment or combination of flight segments which will fulfill a route query.

The other principal tables that are set up and accessed are the: member org table which details each carrier organization parameters; carrier service rating table which is specified by the forwarder for each carrier on the route; buyer seller involvement table which sets out whether the carrier does business with the forwarder in a quote and/or reverse markets manner; preferred carrier table which is a list of preferred carriers specified by the forwarder; aircraft/ULD compatibility table 84 for ULD searches and which set out which ULDs can fit on a given aircraft; ULD table 88 which is a list of DMS system implemented and operator ULD types; and various system parameters.

In an optional embodiment of the DMS 70, the transfer set table 100 may define transfers between carriers, for example carriers which are part of an interline arrangement. Alternatively, carriers may arrange unilateral agreements with each other and provide for transfer between respective flights.

The foregoing described data architecture is particularly advantageous in terms of flexibility and updating of data. If a carrier makes a change to a flight, all they need to do is to update the appropriate entry in their operational table 92. The DMS 70 determines by means of a poll, trigger or other such message that a change in a field has occurred, opens and interrogates the relevant carrier operational schedule table 92, and makes a corresponding update to the field in the flight leg table 92b and flight segment table 93.

Other changes may be made to an operational flight either directly through a user interface unit, via an unrolled change to a seasonal flight or via a batch update to the operational flight tables. The flight leg and flight segment tables are then automatically updated.

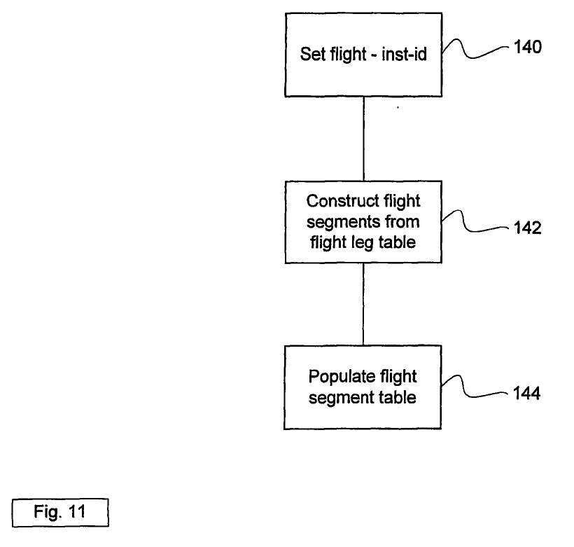

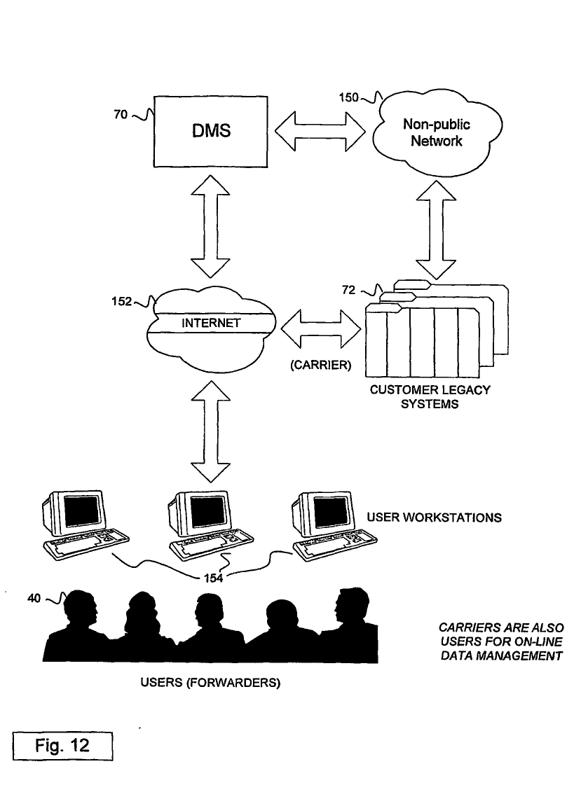

The data entity relationships illustrated in FIG. 7 show how a seasonal schedule 91 may be utilized to produce an operational schedule 92. The operational schedule is in great part the seasonal schedule entries having exact date and time applied to them, together with actual cargo capacity availability indicated. It is from the operational schedule 92 that the flight segment table 93 is generated. An example of the generation of the flight segment table 93 from the operational schedule 92 can now be described with reference to the flow diagram illustrated in FIG. 11.

At step 140 a flight instance identity is set, to determine which of the flight segments are to be generated. At step 142, the flight segments are constructed from the flight leg instance table 92b associated with the flight instance table 92a. Each possible combination of flight legs are evaluated, each one becoming a flight segment and populating flight segment table 93, associated with the appropriate flight instance identity, at step 144. The process of creating flight segments for each flight instance continues, until all possible flight leg segments have been created, providing a full flight segment table 93.

In a preferred embodiment the DMS is configured to be operable with both open and non-public computer networks. A particularly suitable configuration is illustrated in FIG. 12.

The DMS system 70, is coupled to customer's legacy systems 72 by a non-public network 150. Suitable non-public network links may be direct leased lines from telecommunications companies or links to non-public networks to which the carriers are connected, for example. The DMS system 70 is also coupled to a public network, such as the Internet 152. The legacy systems 72 may also be coupled to the Internet 152. Thus, clients may transmit data to the DMS system 70 via the non-public network 150 or the Internet 152. Such a configuration facilitates the scalability of the system, in particular the addition of new customers, since they need not provide non-public network links to the DMS system, but may choose to communicate via the Internet 152. Users of the DMS system, forwarders 40, access the DMS system 70 over the Internet 152 by means of workstations 154. The DMS system 70 can couple to forwarder systems and carrier systems via public or non-public links.

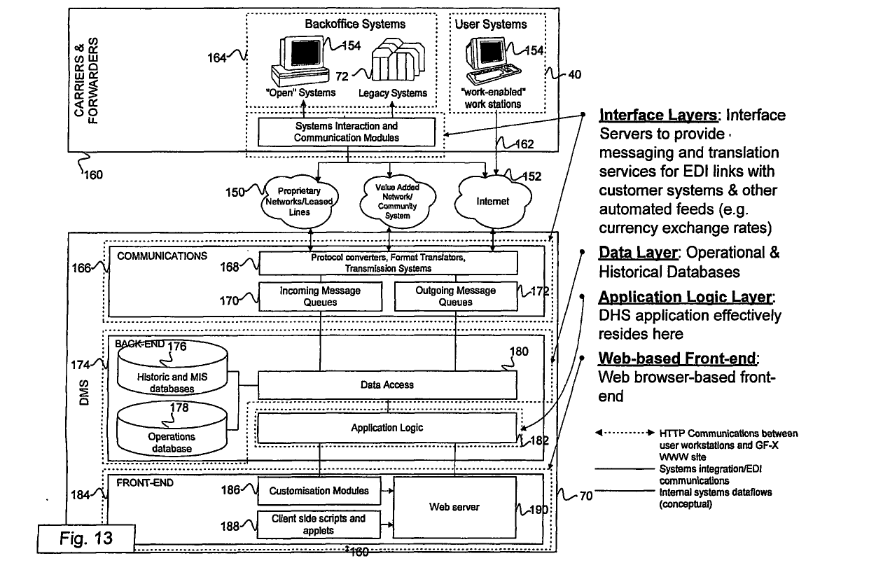

In the configuration illustrated in FIG. 13, the DMS system 70 is implemented as a Web Information System (WIS) at a website. Thus, it is accessible throughout the world by means of the global Internet. That is to say, any location that has access to the Internet may also have access to the DMS system, provided suitable access rights are granted to them by the operators of the DMS system. By configuring the system as a WIS, it becomes accessible by standard web applications. For example, all that a forwarder need have in order to interface with the DMS system is standard browser software and a connection to the Internet. Thus, the DMS system is platform independent and forwarders do not need any special hardware in order to access the DMS system. A particular advantage of configuring the DMS system 70 as a website is that it is relatively easy to scale up the service without forwarders 40 or carriers needing to upgrade or scale up their existing hardware or software (by for example having to install new versions of software). Other features provided by the DMS system are high resilience and high availability. Furthermore, the system is configured to preserve the confidentiality of sensitive information, control access to sensitive transactions, and to provide the service when and where it is needed

A more detailed description of the DMS system and the carrier and forwarder systems will now be described with reference to FIG. 13. FIG. 13 describes the logical architecture of the overall system. The carriers and forwarders are shown as users of the system and are commonly labeled 160. The forwarders 40 use workstations 154 which are suitably “web-enabled”, for example running suitable browser software, and are coupled to the Internet 152. The communications link between the forwarder workstation 154 and the Internet 152 is either a dial-up or a permanently connected leased line. In a preferred embodiment of the invention, the protocol used for communication with the DMS is HTTP and HTTPS 162. The carriers have back office systems 164, comprising their legacy computer systems 72 and their open communication systems such as workstations 154 which are web-enabled and capable of coupling to Internet based applications. The back office systems 164 are coupled to systems integration and communication modules 166, which provide interfaces to outside networks and systems.

The DMS system 70 also comprises a systems integration and communications module 166 comprise interface servers which provide messaging and translation services for links with the customer 160 systems as well as other automated feeds, for example currency exchange rate information which may be obtainable from suitable information sites. The communications module 166 includes an interface module 168 comprising protocol converters, format translators and transmission systems. Interface module 168 provides suitable messaging and transmission services for the information within the DMS system 70 to be output over the proprietary networks 150 and over networks 152. The DMS interface module 168 also provides interfacing to web-based services such as currency exchange rate information, as well as other suitable information that may be utilizable by the system. Communications module 168 is internally coupled to incoming message queues 170 and outgoing message queues 172 to and from the back end 174 of the DMS system 70. The message queue modules manage the transfer of messages to and from the DMS back end 174. Back end 174 comprises two main databases, a Management Information database 176 and an operational database 178. The Management Information database stores historical and statistical information regarding transactions conducted on the DMS system. The operational database 178 comprises the relational database 74 containing the raw data from the carriers and the refined database 76 comprising the flight instance table. Respective databases 176 and 178 are accessed by data access control module 180. Data access control module 180 handles incoming messages on the carriers which require access to the databases, as well as handling outgoing messages to the carriers or forwarders comprising data from the databases.

The DMS system application logic 182 controls the data access control module 180, as well as the front end module 184 of the DMS system. The DMS application logic 182 comprises the functional modules for performing pre-calculation routines, 104, on the data received from the carriers in order to set up the flight instance table 76. Furthermore, the DMS application 182 also comprises the modules for receiving the raw data from the carriers and setting it up in the relational database 74 in accordance with tables as illustrated in FIG. 5. The search engine 106 also resides in the DMS application 182.

The front end 184 of the DMS system 70 comprises the customer or user interface aspects of the system. Typically, the front end comprises customization modules 186 and client side scripts and applets modules 188. The customization modules 186 are driven by the DMS application 182 and are set up to configure user interfaces, access rights and privileges as well as the format of any results in accordance with a particular user. For example, certain users may only be able to see flights offered by particular carriers or only certain types of cargo capacity. The customization modules 186 and client side scripts and applets modules 188 are coupled to a web server 190. The DMS application 182 is also coupled to web server 190. Web server 190 performs the usual tasks and functions of a web server and provides web access to the DMS system 70 to a user, e.g. forwarder 40.

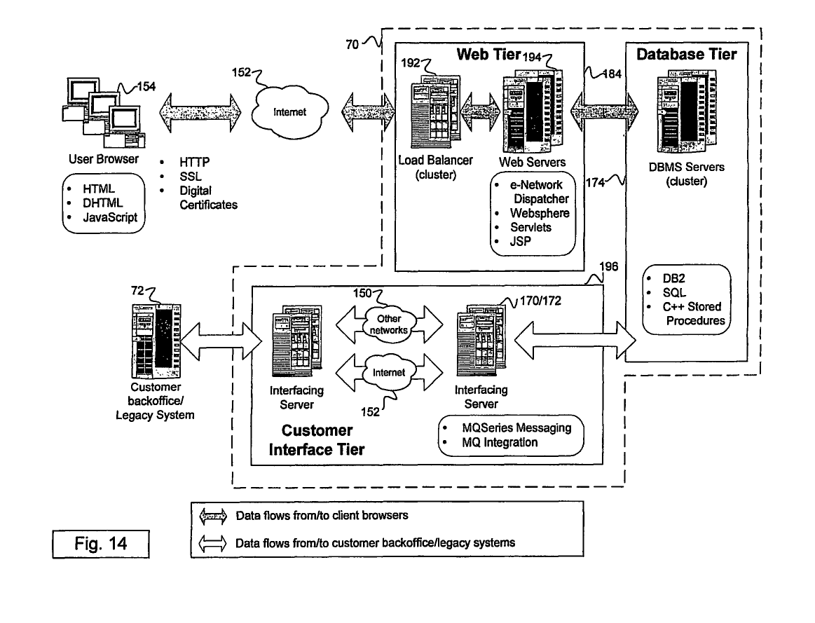

The physical architecture of the systems will now be described with reference to FIG. 14. Forwarders 40 make use of the system by virtue of workstations 154 running suitable browser software, typically interpreting HTML, DHTML and JavaScript code, for example. The workstations 154 are coupled over a telecommunications network supporting TCP/IP communications. Forwarders and the DMS may also exchange digital certificate information over the telecommunications system through the Internet 152 to mutually authenticate each other The DMS system 70 front end 184 comprises a web tier. The web tier includes a load balancer 192 for balancing the incoming and outgoing messages to and from the Internet. Load balancer 192 is coupled to a web/application server or servers 194 comprising suitable software modules for interfacing with Internet users such as application servers executing JSP and JAVA modules. The web/application servers 194 in the front end 184 are coupled to the back end 174 comprising the database tier. The database tier 174 includes a number of database servers. Suitably, the database servers operate a program language such as SQL and C++ stored procedures for controlling and operating the database. The back end or database tier 174 is coupled to a customer communications module or customer interface tier 196. The customer interface tier 196 comprises the communications modules 168 and messaging queues 170 and 172 described with reference to FIG. 14. An interface server couples the backend 174 to other networks such as non-public and proprietary networks and/or the Internet. Suitably, the server handling the incoming and outgoing message queues 170/172 utilizes mechanisms such as MQ series, FTP and SMTP for handling the incoming and outgoing message queues.

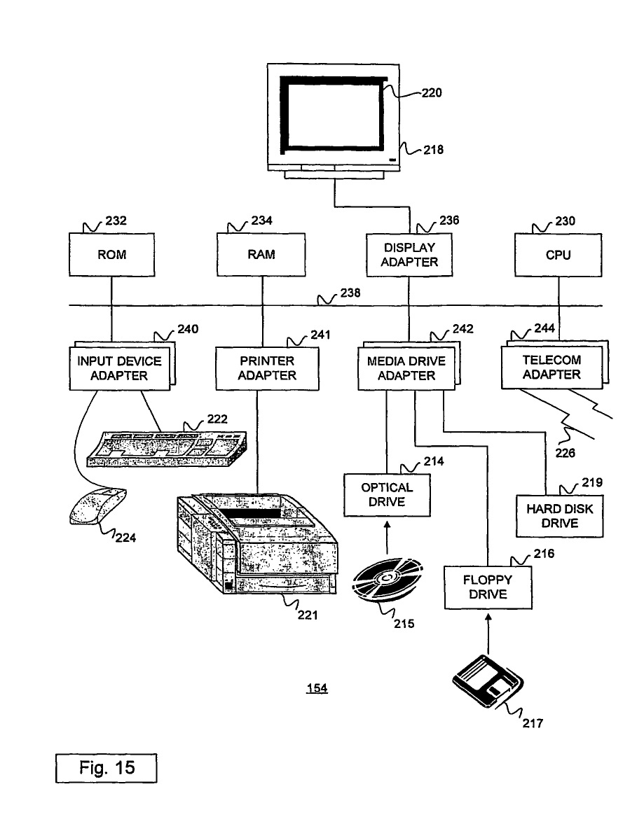

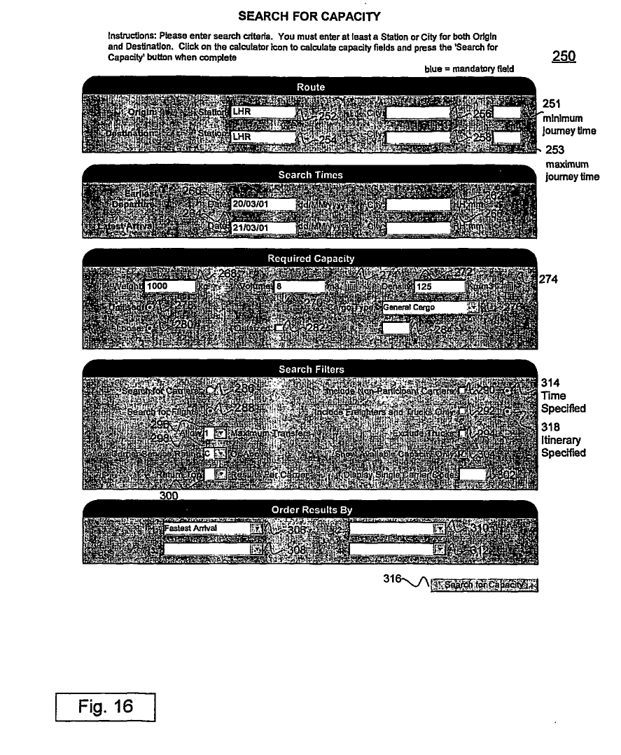

Referring now to FIG. 15, there is shown a schematic and simplified representation of an illustrative implementation of a workstation computer system 154. The workstation 154 comprises various data processing resources such as a processor (CPU) 230 coupled to a BUS structure 238. Also connected to the BUS structure 238 are further data processing resources such as Read-Only Memory 232 and Random Access Memory 234. A display adaptor 236 connects the display device 218 to the BUS structure 238. One or more user-input device adaptors 240 connect the user-input devices, including the keyboard 222 and mouse 224 to the BUS structure 238. An adaptor 241 for connection of the printer 221 may also be provided. One or more media drive adaptors 242 can be provided for connecting the media drive, for example the optical disk drive 214, the floppy disk drive 216 and hard disk drive 219 to the BUS structure 238. One or more telecommunications adaptors 244 can be provided, thereby providing processing resource interface means for connecting the workstation computer system to one or more networks or to other computer systems. The communications adaptors 244 could include a Local Area Network adaptor, a modem and/or ISDN terminal adaptor or serial or parallel port adaptor etc as required.

It will be appreciated from the following description of embodiments of the present invention that the work station 154 may take many forms. For example, the work station may be a non-PC type of computer which is Internet or network-compatible, for example a Network Computer or set top box for a TV capable of providing access to a computer network such as the Internet. Optionally, the work station 154 may be in the form of a wireless PDA or a multimedia terminal.

Work station 154 is configured to operate under the control of CPU 230 operating in accordance with a computer program stored in the workstation memory 232/234/219. The program implementable by the workstation 154 may be supplied on a telecommunications medium, for example over a telecommunications network and/or the Internet. For a work station 154 operating as a multi-media terminal over a radio telephone network, the telecommunications medium may be a radio frequency carrier wave carrying suitably encoded signals representing the computer program and data information. Optionally, the carrier wave may be an optical carrier wave for an optical fiber link or any other suitable carrier medium or a land line link telecommunications system. Suitably, message and data structures and formats from the workstation 154 to a remote computer, such as the DMS system 70 or received from such a remote computer may also be supplied on any of the telecommunications media referred to above. Additionally, the program may be supplied on a floppy disk 217 or CD-ROM 215. In particular, a Graphical User Interface for a remote system, such as the DMS system 70, may be supplied over a telecommunications medium in order to configure the work station display device 218 to display a suitable Graphical User Interface on a display screen 220.

A forwarder 40 wishing to utilize the DMS system 70 in order to search for suitable flights for carrying cargo from an origin to a destination station must first log on to the DMS website. When logging on to the DMS website, a welcome page is displayed and if the forwarder has previously registered with DMS then all they need to do is provide suitable passwords and user names comprising their member id of the DMS system and member organization in order to authenticate themselves as a registered user to the system. In order to search for flights having a required cargo capacity, the forwarder 40 will request a capacity search.

Responsive to a search request 70 to the web server, a server-side java servlet in the Application Logic module 182 calls a decision making perform search stored procedure, dmPerformSearch, from the data access 180 in response to receiving the completed search parameters page. The dmPerformSearch module returns a list of results to the servlet which packages them in HTML and passes them on to the web server for transmission to the forwarder 40.

The search parameter page transmitted from the web server 190 to the forwarder's 40 workstation 154 is displayed by a browser on the display screen 220.

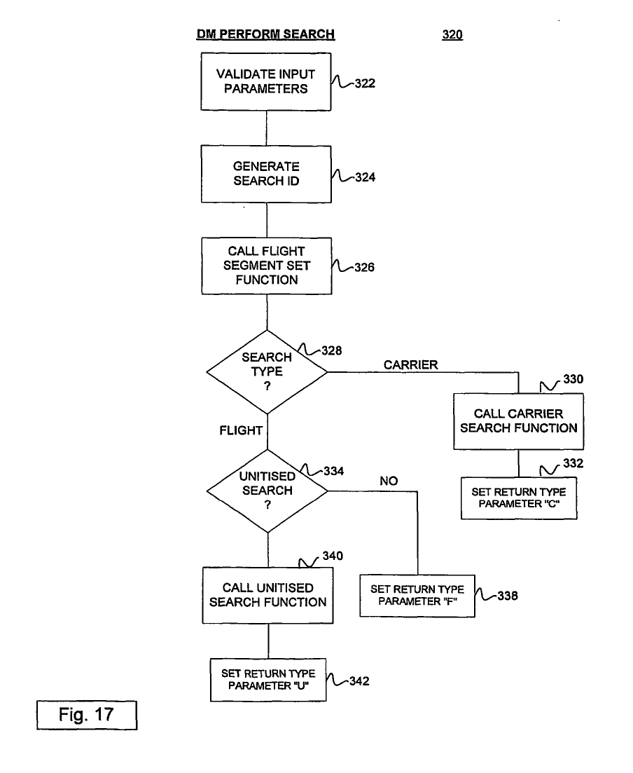

An example of a search user interface screen 250 is illustrated in FIG. 16. The forwarder 40 inputs the journey origin 252 and destination 254 airports into the appropriate screen fields 252 and 254. In the example illustrated in FIG. 16, the origin airport is London Heathrow and the destination airport is John F Kennedy airport in New York, having respective IATA designations LHR and JFK. Alternatively fields for origin and destination city, respectively 256 and 258, are also provided on the user interface 250 but need not be completed. Departure and arrival fields are also provided which are split into departure date 260 and time 262 and arrival date 264 and time 266, defining the window during which the forwarder 40 wishes to have the cargo transported from the origin to the destination. In a preferred embodiment, dates must be completed but times need not be. Fields 268 and 270 and 272 relate to the weight, volume and density of the goods for which cargo capacity is being searched. The calculator symbols 274 may be pressed to calculate the required volume if the weight and density are known or the density if the weight and volume are known. All three fields, weight, volume and density, need to be completed either by the user or automatically upon pressing the calculator icon in order for the nature of the cargo to be properly determined and the correct rate and value ascribed to it. Field 276 typically comprises a drop-down menu of different cargo types for which a search may be initiated. In the illustrated example, general cargo type is illustrated. Other types of cargo might comprise perishables, or auto parts, for example. Cargo type may be defined in any suitable manner by the DMS system operator.

The cargo type may be further defined in terms of whether it is loose cargo, i.e. boxes or packages or unitized cargo, that is to say pre-packed into predefined cargo units. A simple toggle button unitized 278 or loose 280 may be activated to indicate the cargo type. In some circumstances, the cargo may be so-called outsized as defined by the IATA Rules, in which case field 282 is checked to indicate an outsized cargo. In field 284, the unitized packaging type may be entered for a unitized search, i.e. toggle button 278 is activated.

In a preferred embodiment, if loose cargo type is selected, a forwarder may enter dimension data relating to individual pieces of cargo within the shipment. Data fields for the dimension data are provided in a search interface screen (not shown) corresponding to search interface screen 250. The dimension data include the number, length, width, height and weight of each piece of cargo. A calculator icon such as calculator symbol 274 is provided to generate the volume and density from the dimensions data, if provided.

If unitized is selected, the forwarder is able to enter weight, volume, density and ULD category. The search screen (not shown) includes the ability to enter up to 3 ULD categories for a unitized shipment. The system will only return ULDs which have been mapped by the carriers to the categories specified in the search. Carriers map supported ULDs to the ULD categories. The forwarder need not define ULD categories if they would like to return all available ULD types. Carriers typically use one of the three international standard ULD typologies (TACT class rating, IATA type code or ATA US domestic terminology) and/or their own specific-specific ULD types. The DMS allows carriers to map their ULD types to more generic ULD categories which differentiate ULDs across broad dimensions, such as container/pallet, lower/main deck. The forwarder is able to define generic ULD categories in the search screen, to ensure that only those specific carrier ULD types are returned which correspond to the defined category. For example, a search for Pallet (lower) will return in the search results only those segment sets and ULD types which the carrier has mapped to Pallet (lower). The carrier will provide rates and aircraft ULD compatibility for their specific supported ULD types. Their supported ULD types will be returned in the search results and be the basis for quote market and reverse market bookings.

The lower half of the user interface screen 250 comprises a series of search filters which determine the results to be returned to the forwarder 40. Two toggle buttons 286 and 288 may be activated to either initiate a search which will return a list of carriers fulfilling the criteria, or a list of flights fulfilling the search criteria, respectively. Further options are to include non-participants in the system by checking field 290, to exclude passenger aircraft and mixed flights by checking field 292 and further to exclude trucks i.e. road transport, by checking field 294. Further search filters are the maximum number of transfers to be permitted which may be selected by means of a drop down menu 296, determining an allowed carrier service rating for the results to be returned which is selectable via drop down menu 298 and the ability to determine how many results one wishes to have returned by virtue of drop down menu 300. Further limitations may be to display only a single carrier code by checking field 302 and to show just the available capacity only, i.e. those results which can cater for the cargo capacity required by checking box 304. Additionally, results that can not accommodate the searched capacity may be requested, for purposes of future reference or negotiation.

The forwarder 40 may determine the order in which the results are to be returned to them by prioritizing four different features. Four display fields are provided, each one having a drop down menu comprising the following five keys: preferred carrier, lowest cost, fastest arrival, latest departure, service rating. One or more fields 306-312 may be completed by using the drop down menus provided with each field, such that the results are ordered in accordance with the priority of the displayed keys.

User interface screen 250 also includes toggle buttons 314 and 318 for defining a search as a time specified search or itinerary specified search respectively. Additionally, minimum and maximum journey times may be specified by entering valves at in fields 251 and 253. The operation of the DMS in response to time or itinerary specified searches with defined minimum and maximum journey times will be described later.

A user submits their request to the DMS system by activating the “search for capacity” button 316.

User interface screen 250 may be configured to respond to a screen pointer controlled by the mouse 224 of the workstation 154 such that respective fields may be selected by user and data input into them by means of keyboard 222 or selection of options in a dropdown menu. Optionally, the user interface program may move a prompt throughout the user interface 250 to each field in turn whereby a user may input such data as they may desire. Such a prompt may be controllable by means of the up/down arrow and tab keys typically found on a keyboard such as keyboard 222.

By means of the search user interface screen, a forwarder may explicitly select the type of search they wish to perform via the DMS system. There are four searches:—loose flight segments, loose carriers, unitized flight segments and unitized carriers. The terms “loose” and “unitized” refer to the nature of the cargo packing. A flight segments search will return a set of results including full details of the flights segments for the requested route, whereas a carrier search will provide just carrier identification and optionally available capacity. Certain fields have to be completed for each type of search. These fields are the route between origin and destination, which could be a city or airport, the search times, the cargo type and cargo capacity. There is a system defined maximum time period between departure and arrival times in order to ensure that excessively long periods are not entered. If this system parameter is exceeded, the system will issue an error. Airports are generally associated with a city by an IATA table.

For each flight segment entry 93 there is a departure date and time (DEP_DTIME) and arrival date and time (ARR_DTIME). Each flight segment entry also has an origin and destination station for the flight segment. In the station handling times sub-module 534 an export handling time and import handling time is defined for each station. The export handling time defines the time required at the origin station for handling before the flight departs. Export handling time is subtracted from the departure time to define a drop-off time (in fact a latest drop-off time). Similarly, the import handling time defines the time required at the destination station for handling after the flight arrives. Import handling is added to the arrival time to define a pick-up time (in fact an earliest pick-up time) for the shipment. A drop-off time and pick-up time is thus established for each flight segment in the flight segment table.

In accordance with the preferred embodiment of the invention, a search may be envisaged to be time specified or itinerary specified (flight specific) by toggling buttons 314 or 318 respectively.

For an itinerary specified search (i.e. a search by departure and arrival date and time), the DMS searches the flight segment table and related tables for route segments with departure and arrival dates and times satisfying the request (where departure date and time is later than or equal to start (requested departure) date and time and arrival date and time is earlier or equal to end (requested arrival) date and time). In a preferred embodiment, only flights with a Y in field 510 are returned. The results may be displayed with the departure and arrival dates and times and/or with the associated drop-off and pick-up dates and times. If there is a Y in field 506 (i.e. the product is itinerary specified) the former are displayed and if there is a Y in field 508 (i.e. the product is time specific) the latter are displayed.

For a time specified search (i.e. a search by drop-off and pick-up date and time), the DMS searches the flight segment table and related tables for route segments with drop-off and pick-up dates and times satisfying the request (where drop-off date and time is later than or equal to start (requested drop-off) date and time and pick-up date and time is earlier than or equal to the end (requested pick-up) date and time). Again, the results may be displayed with the departure and arrival dates and times and/or with the drop-off and pick-up dates and times depending whether the product is an itinerary specific or time specific one.

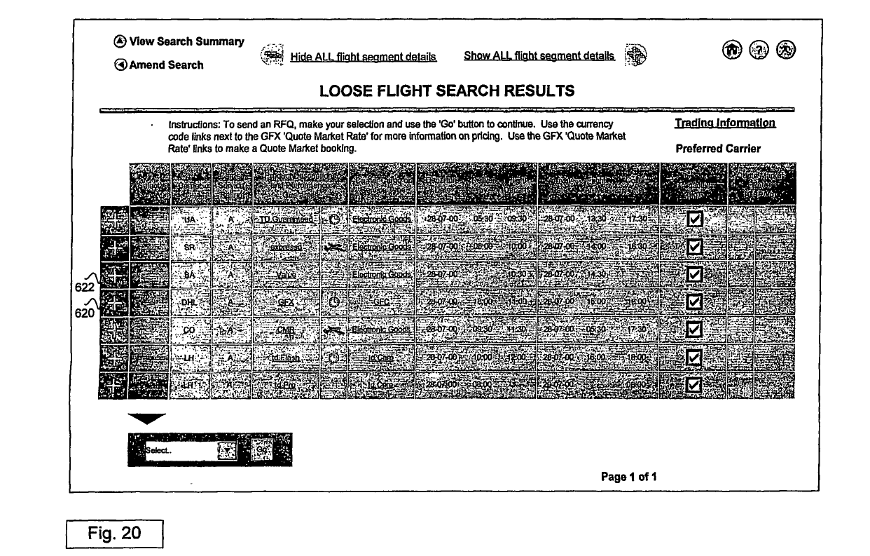

FIG. 20 illustrates a results screen in accordance with an embodiment of the invention. Entry 620 displays both deliver and arrive by (drop-off and pick-up) times for that route. In the illustrated results screen, flight departure and arrival times are also shown, which is an optional feature for “time specific” products. An example of an “itinerary specific” product is entry 622 for which only flight departure and arrival times are shown. It is also an optional feature for “itinerary specific” products to display deliver by and arrive by times if export and import handling times at respective origin and destination stations are available to the DMS system. Thus, it is possible to display both “time specific” and “itinerary specific” products on the same results screen thereby creating a unified marketplace for the two different product types.

FIG. 17 illustrates a flow diagram for an illustrative embodiment of the dmPerformSearch stored procedure. The dmPerformSearch stored procedure resides in the DMS data access logic 180 and initially validates the input parameters for a search request from a forwarder, step 322. Typically, the dmPerformSearch stored procedure validates the following input parameters which may be input by the search for capacity user interface screen 250 or as part of the log-on procedure and the search for capacity screen 250.

Typically, the following input parameters where applicable are validated:

a member ID parameter is passed in;

a result type search parameter is passed in;

a loose or unitized (278,280) search parameter is passed in;

results type (carrier or flights) 286,288;

ensure origin airport or origin city parameters (252,256) are passed in;

ensure the destination airport or destination city parameters (254,258) are passed in;

ensure that the origin city (256) if passed in is a valid city;

ensure that the origin airport 252 (if passed in) is a valid airport;

ensure that the destination city 258 (if passed in) is a valid city;

ensure that the destination airport 254 (if passed in) is a valid airport;

ensure that origin airport and origin city have not both been entered;

ensure that destination airport and destination city have not both been entered;

ensure that the origin is not the same as the destination for both airport and city;

ensure that origin station is not situated in the destination city;

ensure that destination station is not situated in origin city;

ensure that the maximum transfers parameter has been passed in;

ensure departure and arrival dates are passed in and that arrival date is after departure;

ensure that time between departure and arrival dates is not longer than a system defined maximum;

ensure that the cargo type 276 has been passed in and is a valid cargo type for the system;

ensure ULD category 284 (if entered) is valid;

ensure that the carrier code 302 (if entered) is valid;

ensure that weight, volume and density have been entered and that weight/volume=density; and

ensure that piece dimensions and weights, if entered, correspond to the weight and volume, within a system tolerance.

The dmPerformSearch function then proceeds to step 324 where it generates a unique search identity for the search requested. This search identity is used to identify a search result set formed when retrieving results sub-sets. A common function called Result Set ID utilizes the unique search ID and enters the unique ID into a record VU_SRCH_RSLT_SETU to record the time at which the search was performed. This record is then used in the DMS management system to determine when a search should be removed from the database. The unique search ID is returned to the client software once search processing is complete, for use in identifying the search result set.

The next step 326 calls a FlightSegmentSet function which is used to generate a list of flight segments that fulfill the search criteria entered in the search screen, e.g. 250, in terms of the journey origin and destination stations, the route, start and end dates and capacity availability. This list of flight segments is used for all search routines that are performed subsequently. The dmPerformSearch procedure then proceeds to step 328 in which it is determined whether the search is of the carrier type or the flight type as determined by toggle switches 286 and 288 respectively in the search for capacity screen 250, for example.

For a carrier type search, the dmPerformSearch stored procedure proceeds to step 330 where the carrier search function is called to perform the carrier search and the return “type” parameter “C” is set at step 332. For a flight type search, the function control flows to step 334 where it is determined whether a unitized type search has been requested. If a unitized search has not been requested then at step 336 a flight search function is called which will search for flights carrying loose cargo. Then the control flows to step 338 in which a return type parameter “F” is set. For a unitized search function control flows to step 340 where a unitized search function is called and thence to step 342 where a return type parameter “U” is set.

Once the dmPerformSearch stored procedure has been conducted and the relevant search type, i.e. carrier search 330, non-unitized search 338 or unitized search 340 has been undertaken, a search results set is established reflecting the results of the appropriate search. From the search results set, the pricing of individual records within that set is performed.

The procedure function “FlightSegmentSet” 326 is called in the dmPerformSearch procedure 320. The dmflightsegmentset 326 is executed for all search types and inserts into the result set table the list of flight segment sets that match the route specified in the search for capacity screen 250. Each flight segment set forms a row of data stored on the result set table, and the list is configured such that a requested number of rows can be returned to a JAVA servlet by a getresults function for communication to a user workstation 154. The dmflightsegmentset search is a complex search and the search is performed in several distinct queries from which the complete result set is constructed. Each query is performed in turn and the output from the search is inserted onto the result set table, along with relevant search ID. Each individual query corresponds to the number of transfers allowed in the route.

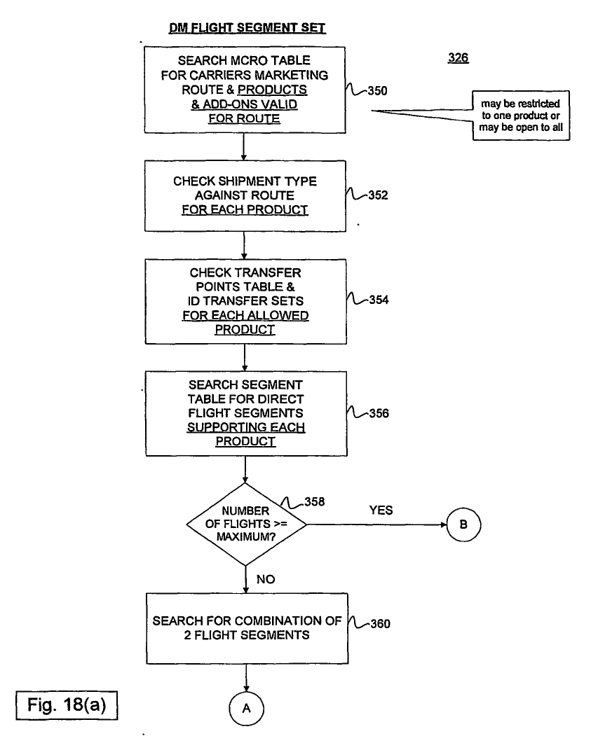

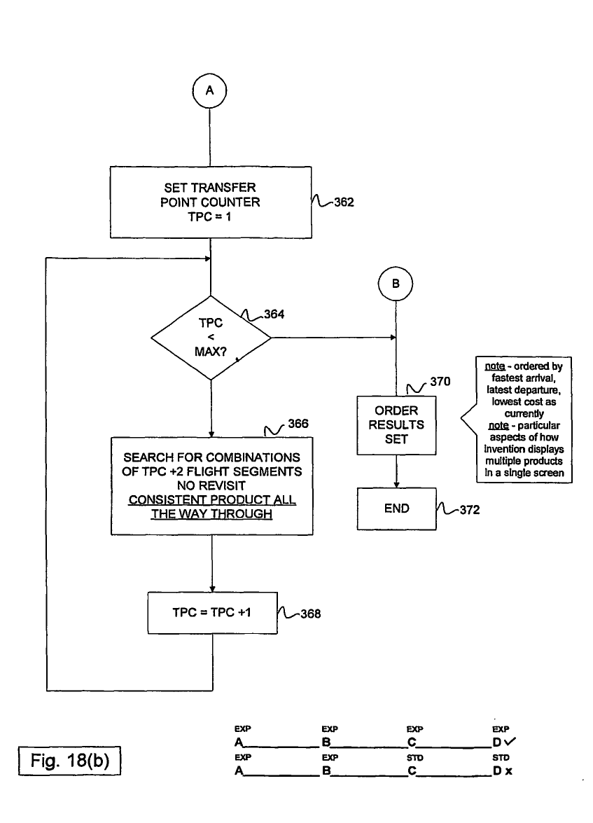

Operation of the DMS application logic 182 for the dmflightsegmentset 326 will now be described with reference to the flowchart illustrated in FIG. 18(a). The dmflightsegmentset stored procedure starts at step 350 by searching the MCRO table 98 for carriers which market the journey entered onto the search window 250. The valid products and add-ons for that route are also checked by referring to route/product mapping sub-module 522. In the example illustrated in FIG. 17, the MCRO table 98 will be searched for an origin airport LHR and a destination airport JFK. At step 352 the requested shipment type, i.e. unitized or loose, is also checked against the route marketed by the relevant carriers. A list of the carriers marketing the requested route, with the requested shipment types and valid products and add-ons, is then stored by the dmflightsegmentset procedure. Other checks that may be carried out in steps 350 and 352 are that the carriers have an adequate service rating, parameter 298 in screen 250. At step 354 the transfer point table 100 is checked to identify the transfer sets valid for each product for the marketed route for each carrier.

Flight segment table 93 is then searched at step 356 for direct flight segments having origin and destination stations corresponding to the origin and destination stations for the requested journey. Each of the direct flight segments is checked against the conditions entered into the search for the date period defined by search parameters 260, 262, 264 and 266 of screen 250 and includes the latest booking acceptance time conveyed by route and flight. Additionally, if the result is to be filtered by capacity then a search for the necessary capacity is also undertaken as well as a search for the appropriate equipment type as defined by search parameters 292 and whether or not to include trucks as defined by search parameter 294. The DMS application logic also checks that each of the flight segments has its departure and arrival times within a maximum time period as set by a system parameter. The direct flight segments are also checked to determine that they support the product or each product, together with any add-ons, valid for that route.

The direct flight segments identified in step 356 satisfying the query and carrier product definition are stored in a flight segment set list. The dmflightsegmentset stored procedure then proceeds to step 358 where it is determined whether a maximum number of flights have been identified. The maximum number of flights is typically a system parameter but optionally may be user defined. If a maximum number of flights has been identified then the dmflightsegmentset stored procedure process control flows to step 370 where the results in the flightlegset list are ordered and the dmflightsegmentset procedure ends at step 372. However, if the result of step 358 is no then the process control flows to step 360 at which the flight segment table is searched for a combination of two flight segments fulfilling the journey request. In a preferred embodiment of the invention, the two flight segments are for flights with the same managing carrier, but optionally they may be for flights having different carriers.

When searching for a combination of two flight segments, the connection of the two flight segments is handled by comparing the connection time i.e. difference between the arrival and departure of the two flight segments at the transfer station against the carrier minimum connection time as defined in the minimum connection time table 96. Two flight segments can only be connected if the time difference between their connection time and carrier minimum connection time is acceptable. That is to say, there has to be sufficient time in which to make the connection and transfer. The carrier minimum connection time varies depending upon aircraft, shipment type (loose or unitized) transit station etc as discussed with reference to FIG. 9 when discussing table 96. Additionally, the connection time is compared with the maximum connect time system parameter, to determine whether or not the time difference is acceptable. Optionally, the connection time is also compared with the appropriate field in the maximum connect time table 94. Again, the maximum connection time may vary depending upon aircraft type, shipment type (loose or unitized), and the transit station as well as other variables such as the nature of the cargo, as discussed with reference to FIG. 8. Additionally, each of the combined flight segments, collectively known as a trans-shipment, is checked against a maximum journey time for the marketed route stored in the MCRO table 98 and any which exceed the maximum journey time are discarded. A further condition for trans-shipment tested at step 360 are that the next flight's origin matches the previous flight destination. The flight segment set list is then updated with the trans-shipments identified in step 360. In accordance with an embodiment of the invention, each sub-module 534, 552 and 564 is checked to ensure that all stations in the combined segments support the same products. If they do not, then that segment combination is disallowed.

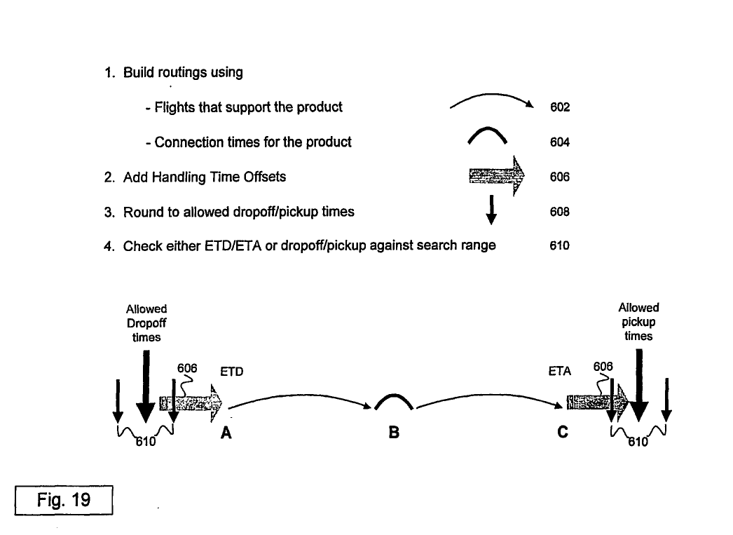

FIG. 19 schematically illustrates how combinations of flight segments are searched and checked to build routings in accordance with an embodiment of the invention. For flight segments AB and BC, it is first checked that they support the product, 602. Next, the connection time, 604, at station B is determined and the export/import handling times, 606, are combined with the estimated time of departure and estimated time of arrival to provide a range of drop-off and pick-up times 610.

Process control then flows to step 362 where a transfer point counter TPC is set to 1. This counter is used in order to check that the number of transfer points in a route do not exceed a user's specifications, a system parameter or a carrier defined limit for a product. At step 364, it is checked whether or not the transfer point counter TPC is less than a maximum value. If it is not less than a maximum value, then process control flows to step 370 where the flight segment list results are ordered, and thence to step 372 where the procedure ends. If the result at step 364 is yes then process control flows to step 366 where the segment table is searched for further combinations of flight segments. The number of flight segments which are searched is equal to TPC+2. The considerations when undertaking the search in the segment table in step 366 are the same as that undertaken in relation to step 360. However, there is a further restriction in that no transfer point can be re-visited during the trans-shipment. That is to say, a flight segment destination does not match a previous flight segment origin. This is to avoid convoluted and repetitive trans-shipment routes. Valid trans-shipments derived in step 366 are stored in flight segment list and process control flows to step 366 where counter TPC is incremented by 1. Then control flows back to step 364 where it is determined whether or not TPC is less than a maximum value.

Importantly, when searching the flight segment table for a combination of two or more flight segments, a check is made that each flight segment is capable of transporting cargo as set out in the request in terms of cargo compatibility for cargo type, dimensions and or ULD type, for example. For instance each segment must be capable of transporting cargo having the dimensions set out in the request or of the ULD type requested.

The result of the dmflightsegmentsetprocedure is to produce an ordered flight segment set list. The ordering is in accordance with the fastest arrival time, latest departure time, lowest cost and then in the order of results parameters 306, 308, 310, 312 and 314 input on the search screen 250. Having completed the dmflightsegmentset stored procedure function 326, process control flows to the dmPerformSearch stored procedure 320 where the search type is determined at step 328.

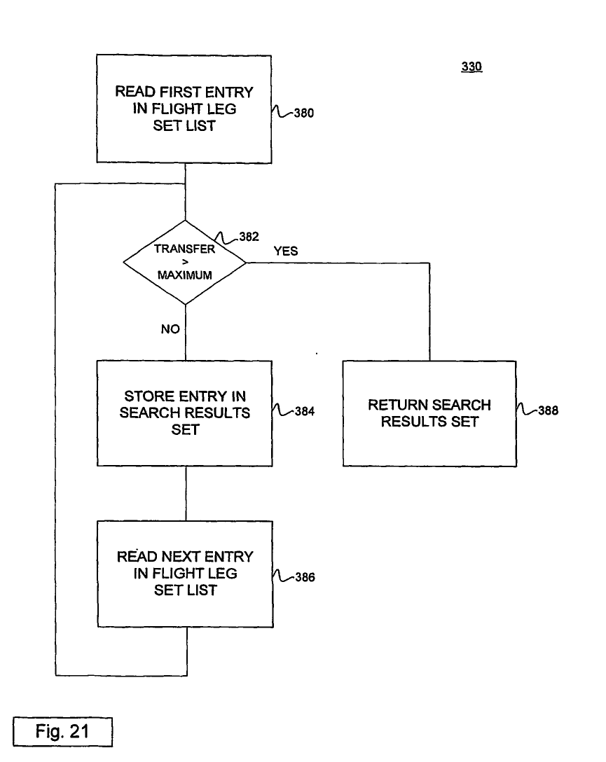

Returning now to FIG. 18(a), at step 328, search type to be performed by the perform search algorithm 320 is determined. For a search type “carrier” initiated by setting the toggle button 286 in search window 250, a carrier search function 330 is initiated. The process control flow for the carrier search function 330 will now be described with reference to the flowchart illustrated in FIG. 21. Initially, at step 380, the first entry in the flight segment set list is read. At step 382, it is determined whether the entry exceeds a maximum value as entered by the user in parameter 296 at search window 250. If the number of transfers is less than the maximum entered by the user, process control flows to step 384 where the entry is stored in a search results set. Next, step 386, the next entry in the flight segment set list is read and process control flow returns to step 302 to determine whether the number of transfers in the next entry exceeds the maximum allowed. If the number of transfers does not exceed the maximum, then the process control continues and flows to step 384 where the entry is stored and the search results and the next entry is read from the flight leg set list. However, if the number of transfers in the most recently read entry of the flight leg set list exceeds the maximum value, then process flow control moves to step 388 where the carrier search function is terminated and the final search result set is returned to the perform search procedure. For the carrier search, the final search result set comprises a list of carriers with flights and cargo capacity sufficient to fulfill the request.

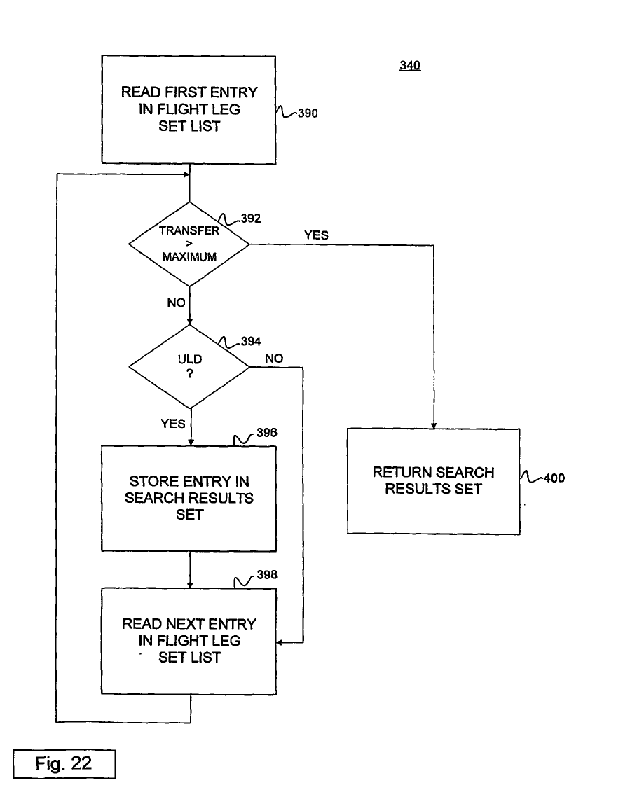

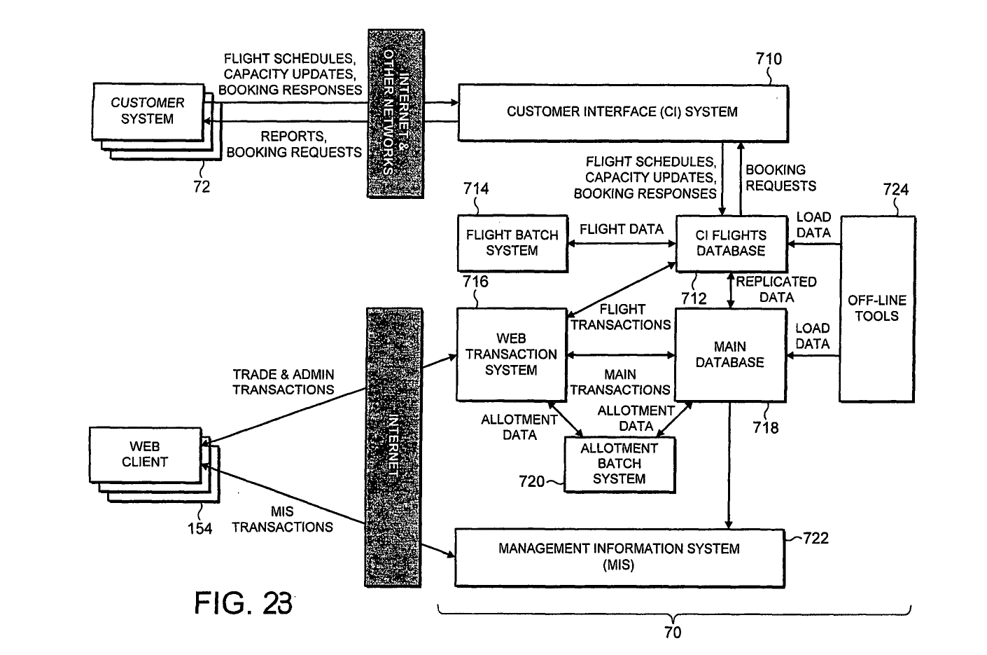

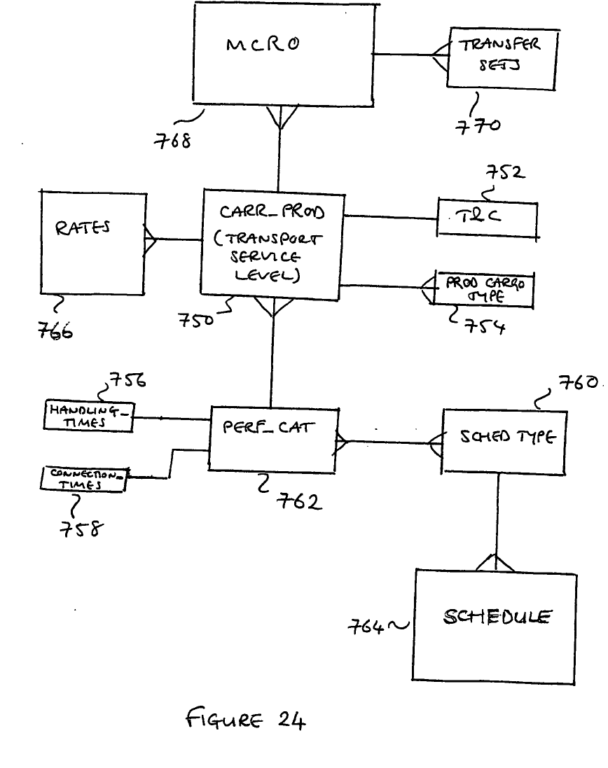

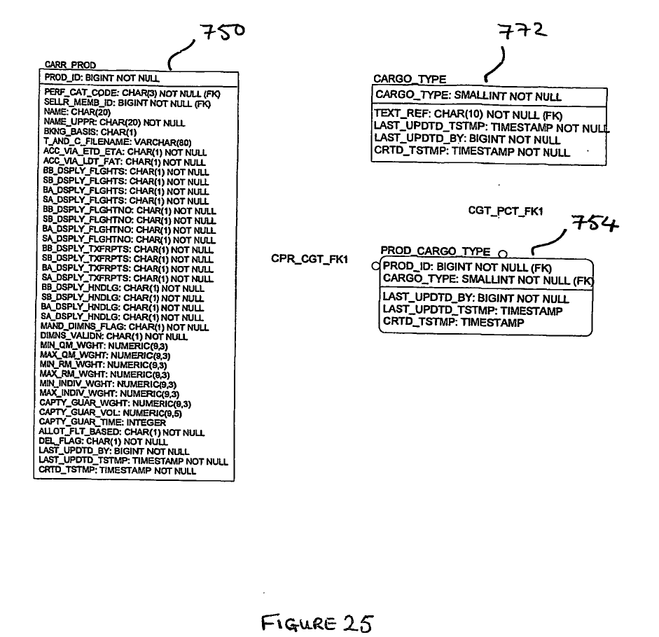

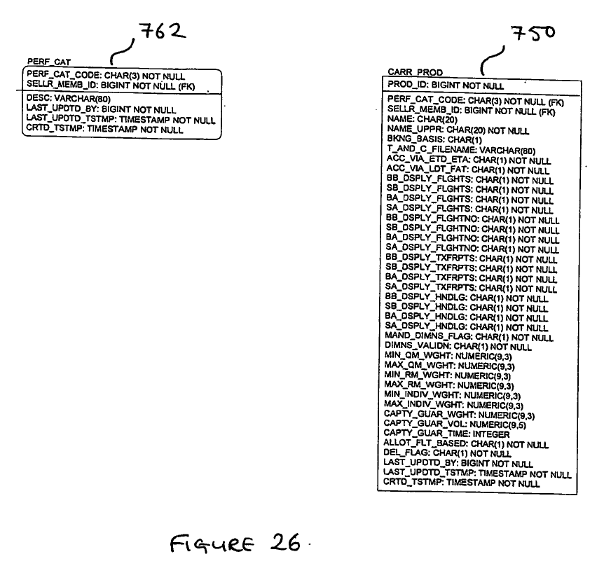

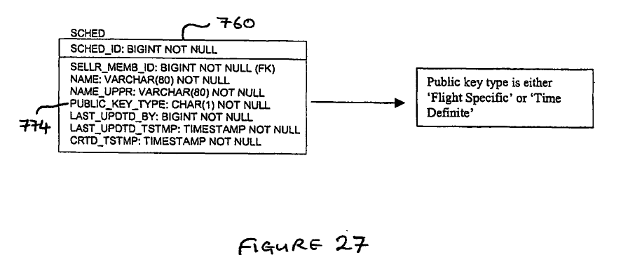

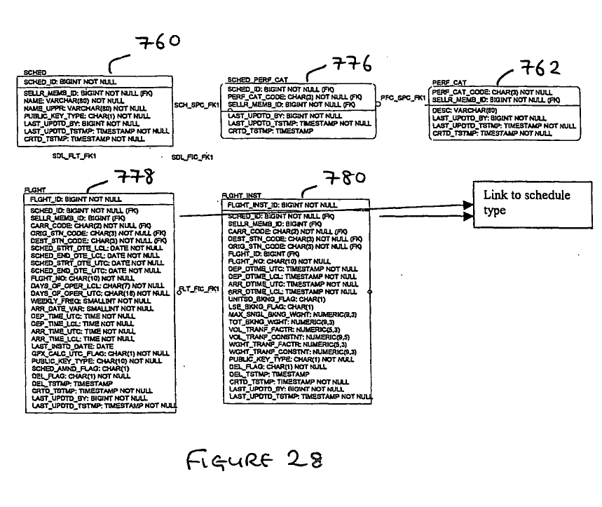

Referring now to FIG. 22, the control flow for the unitized search function 340 will now be described. For a unitized type search activated by setting the toggle button to 278 in the search window 250 an additional check in the DMS logic for whether each flight segment uses an aircraft type capable of handling ULDs generally or a specific ULD type. ULD categories may be entered in field 284 of the search window 250. For the example illustrated in FIG. 16, no entry has been made in field 284, which is consistent with the search being for loose capacity responsive to the loose toggle button 280 being activated. The first step 390 of the unitized search function 340 is to read the first entry in the flight segment set list. At step 392 it is determined whether or not the number of transfers for the entry exceeds a maximum. If not, the process control flows to step 394 where it is determined whether or not the entry contains a flight segment capable of supporting ULD unitized cargo generally, or if a ULD category has been entered that the flight segment supports that specific ULD type. If the result of step 394 is yes then process control flows to step 396 where the entry is stored in the search results set. Then, at step 398, the next entry in the flight segment set list is read and process control flows to step 392 where it is determined whether or not the number of transfers for that next entry exceeds the maximum value. At step 394, if the current read entry does not support the ULD cargo, or a specified ULD type, then process control flows to step 398 where the next entry in the flight segment set list is read. If the result at step 392 is yes, that is to say the number of transfers in the currently read entry from the flight segment set list exceeds a maximum value, then process control flows to step 400 where the search results set is returned to the dmPerformSearch stored procedure 320. Search results sets are only returned where each flight segment supports a common ULD type or types.

A search results set has now been created corresponding to the respective search type requested by the forwarder. Preferably, a price is associated with each flight segment set record. In the simplest case the price may be a function of the volume, weight or density of the cargo capacity request. Such a price per unit of capacity may be included at an entry in the MCRO 98 table. Optionally, the price may be an entry for each flight leg in the flight instance table 76 with the price for each flight leg in a combination of flights forming a segment and/or route being summed to give a total price for that route.

Optionally, rate cards are provided on the DMS system which are configured by many different parameters, including route and flight segments or flight legs, to calculate a rate for a journey.

The rate cards are created and maintained by carrier by route, journey, forwarder, cargo type, day of week, for example. The DMS system finds the correct rate card for each flight segment set and calculates a rate taking into consideration shipment type, weight amongst other things. The rating or revenue management information held against the MCRO referred to above includes a minimum for that route, below which the calculated rate is not allowed to fall. It is a minimum rating control. The system compares the rate on the rate card with the rate on the MCRO and takes the minimum of the two.

Other means for determining the price for the cargo capacity may also be utilized.

The search results, as created by the appropriate search, i.e. carrier, non-unitized or unitized search, are then displayed in the order selected by the user in the relevant search screens. The user then selects for which of the selected route options they wish to book cargo capacity. In a preferred embodiment of the invention, cargo capacity booking is done by selecting one of the flight segment sets in the results list, which initiates the generation of a booking screen which may be filled out by the user in order to book cargo capacity. Optionally, booking of cargo capacity may be by more conventional means such as a fax, telephone, or e-mail to the relevant carrier.

The logical architecture of a particularly suitable data management system (DMS 70) in accordance with an embodiment of the present invention will now be described with reference to FIG. 23. FIG. 23 shows the overall system. Customer (carrier) systems 72 communicate with customer interface (CI) system 710 across the Internet and/or other networks, as already described with reference to FIG. 13. CI system 710 interacts with CI Flights Database 712 which in turn interacts with Flight Batch System 714, Web Transaction System 716 and Main Database 718. Web Transaction System 716 and Main Database 718 also interact with one another.

Allotment Batch System 720 interacts with Web Transaction System 716 and Main Database 718. Main Database 718 interacts with Management Information System (MIS) 722. Off-line tools 724 can be used to load carrier and forwarder data gathered off-line into the CI Flights Database 712 and Main Database 718. Web Transaction System 716 and MIS 722 communicate with client (forwarder and/or carrier) work stations 154 across the Internet and/or other networks.

The Web Transaction System 716 comprises a web application server and database access software and enables forwarders using workstations 154 to submit search requests to the data management system. The MIS 722 uses data from the main database 718 to generate on-line reports, and the Allotment Batch System 720 is used to load allotment bookings and templates received via the Web Transaction System 716 into the main database 718.

Carrier systems 72 supply flight schedules to the CI system 710 either as seasonal schedules 91 with standing flight timetables or operational schedules with individual flight instances. The CI system 710 stores the flight schedules in operational schedule tables 92 and seasonal schedule tables 91 in the CI Flights Database 712. Capacity data for populating the flight segment table is also provided. Product data may be provided through the customer interface or via offline tools.

Marketed Carrier Routes Options (MCRO) data and Transfer Set data are also supplied by the carrier system 72 to the CI system 710, and these are stored in the Main Database 718 in MCRO table 98 and transfer set table 100 respectively. Copies of the MCRO table and transfer sets table are held in the CI Flights Database. ULD data is similarly received and stored in ULD tables 82. Operational schedule table 92, seasonal schedule table 91, MCRO table 98, transfer set table 100 and ULD table 82 and their relationships have been described with reference to FIGS. 7 and 10.

Flight Batch System 714 runs a batch process to unroll a carrier's seasonal schedule 91 to produce an operational schedule 92. As described with reference to FIG. 5, the operational schedule sets out the origin and destination stations, the time and date of departure, equipment type and the ability to on-load and off-load cargo at each station for each flight. When pre-calculation routine 104 creates flight segments for the flight segment table, valid combinations are made for segments which have an on-load capability at the origin station and an off-load capability at the destination station. In a preferred embodiment, flight legs are only combined by pre-calculation routine 104 to form segments in the flight segment table if the flight legs belong to the same flight i.e. have the same flight number.

In other embodiments different rules may be followed for combining flight legs to produce flight segments in the flight segment table. For instance a carrier may specify via an identifier which legs may be combined with which to form segments.

In a preferred embodiment MCRO table 98 and transfer set table 100 are used to define a marketed carrier route segments set by for example creating a marketed carrier route segments table containing all of the permissible route segments defined by the data in these tables. For example, if a carrier is marketing LHR-SIN directly and LHR-SIN via DXB, assuming load-on and load-off capability at DXB, then the marketed flight segments LHR-DXB, DXB-SIN and LHR-SIN will be created. However, if only LHR-SIN directly is being marketed then only the marketed flight segment LHR-SIN will be created. Pre-calculation routine 104 when populating the flight segment table reads data representing a flight leg or valid flight leg combination from the operational schedule and checks the origin and destination stations against those of each marketed flight segment. If the flight leg or flight leg combination corresponds to a marketed flight segment then the leg or flight leg combination will be entered into the flight segment table as a flight segment. If the flight leg or flight leg combination does not correspond to a marketed route segment then it is not entered into the flight segment table. Therefore in the example above a leg DXB-SIN would be entered into the flight segment table as a segment only if a corresponding marketed flight segment exists i.e. in the first part of the example but not the second part of the example.

The MCRO table 98 and transfer set table 100 are preferably still used in the dmPerformSearch procedure to first act as a check that the data in these table has not changed (been updated) and secondly check that if the search concatenates two or more segments that the concatenated search result corresponds to a marketed route and/or valid transfer.

Referring again to FIG. 23, the Flight Segment table formed in the CI Flights Database 712 is replicated to the Main Database 718 to support main transactions (customer searches) performed through the Web Transaction System 716. Main Database 718 holds the MCRO table, transfer sets table, ULD table and other tables used for customer transactions including the member org table, rating table, buyer seller involvement table, preferred carrier table and aircraft/ULD compatibility.

In an embodiment corresponding to the system shown in FIG. 23, the CI System 710 and CI Flights Database 712 are implemented as a CI server on a separate server to the main database 718, Web Transaction System 716 and Allotment Batch System 720. The CI System as well as receiving and handling Flight Schedules and populating the flight segment table, handles the exchange of other data between the carrier legacy systems (Customer/carrier systems) and the main database 718. This includes handling capacity updates, MCRO updates, transfer set updates, updates of other carrier data and the handling of booking requests generated through the DMS system and booking responses from the carrier system. Updates are cascaded to related tables using database triggers. In addition, the CI server ensures that this data is kept accurate and current.

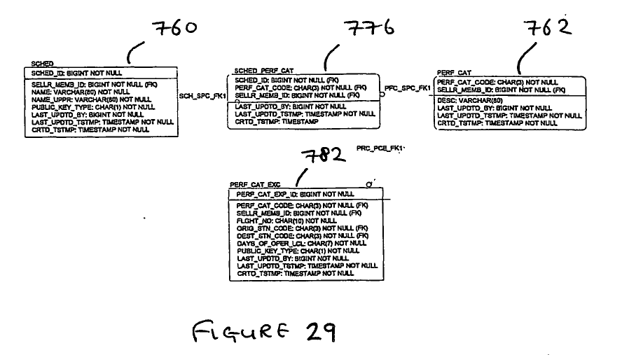

Features of particularly suitable embodiments in accordance with the present invention will now be described with reference to FIGS. 24 to 32. FIG. 24 schematically illustrates the relationship between data entities used in the creation of and search of a flight segment table and FIGS. 25 to 32 show tables used in a preferred embodiment.

Referring now to FIG. 24, CARR_PROD 750 defines a product (or transport service level) for a carrier (or transport provider). Each product has a set of terms and conditions, T&C 752, and is offered for one or more cargo types, PROD_CARGO_TYPE 754. T&C 752 and PROD_CARGO TYPE 754 are direct service attributes of the product and in one embodiment handling times (HANDLING-TIMES 756), connection times (CONNECTION_TIMES 758) and schedule type (SCHED_TYPE 760) are also direct service attributes of the product. However in the embodiment shown performance category, PERF_CAT 762, is a service attribute of the product and handling times, connection times and schedule type are attributes of the performance category. For the following description, it should be noted that where relationships with performance category are described, a corresponding relationship between an attribute (such as handling times 756, connection times 758 and schedule type 760) and product 750 exists for alternative embodiments where performance categories are not implemented. As can be seen from FIG. 24, one performance category 762 can be used for one or more carrier products 750.

Schedule 764, corresponding to operational schedule 92 (FIG. 7) optionally derived from seasonal schedule 91, may be one of several schedule types, for instance a trucking schedule or an aircraft schedule. Each performance category may apply for one or more schedule types. For instance, both trucking and aircraft schedules may be used for a “Standard” performance category whereas only an aircraft schedule may be used for an “Express” performance category. Schedules, such as the aircraft schedule in this example, may be used for more than one performance category.

Rate data 766 in the form of rate cards are associated with each product 750. One or more rates may apply for a particular carrier product 750.

It will be appreciated from FIG. 24 that different products can be established by using different terms and conditions 752 and rates 766 with a single performance category, for example.

Marketed Carrier Route Options data, MRCO 768, and transfer sets 770 correspond to MCRO 98 and transfer sets 100 described with reference to earlier Figures. As FIG. 24 shows, each product 750 may be marketed on a plurality of routes.

It will be appreciated that several of the entities described in FIG. 24 relate to tables described with reference to previous Figures. The following description with reference to FIGS. 25 to 32 sets out how these tables have been modified in a preferred embodiment of a data management system in accordance with the invention.

FIG. 25 shows CARR_PROD table 750 which defines a product for a carrier. Each carrier may define several products, with entries corresponding to table 750 made for each product. CARR_PROD table 750 broadly corresponds to product definition sub module 502 in FIG. 6. As can be seen from FIG. 25, CARR_PROD table 750 comprises a product identifier (PROD_ID); a performance category code (PERF_CAT_CODE) specifying the performance category for the product; a seller member identifier (SELLER_MEMB_ID); name details (NAME, NAME_UPPER); a field setting the booking basis for the product (BKNG_BASIS) setting an icon to be displayed with the search results; terms and conditions for the product implemented as a link to a separate file (T_AND_C_FILENAME); itinerary specific and time specific search flag fields for setting whether the product is offered for searches by departure and arrival time and date and/or drop-off and pick-up time and date (ACC_VIA_ETD_ETA and ACC_VIA_LDT_FAT respectively); display options for the buyer (B) and seller (S) before (B) and after (A) the booking for flights (FLGHTS), flight number (FLIGHTNO), transfer points (TXFRPTS) and handling times (HNDLG); fields for specifying whether loose piece dimensions must be supplied and to what level (MAND_DIMNS_FLAG and DIMNS_VALIDN); fields specifying minimum (MIN) and maximum (MAX) shipment weight (WGHT) for Quote Market (QM), Reverse Market (RM) and individual pieces (INDIV); capacity guarantee controls by weight (CAPTY_GUAR_WGHT) volume available at the guaranteed weight (CAPTY_GUAR_VOL) and time before departure that the guarantee applies (CAPTY_GUAR_TIME); and ALLCT_FLT_BASED, DEL_FLAG, LAST_UPDTD_BY, LAST_UPDTD_TSTMP and CRTD_TSTMP fields.

It can be seen that CARR_PROD table 750 defines some attributes for the product directly on the table and others via performance category. However, in one embodiment all of the attributes associated with performance categories are incorporated directly into the CARR_PROD table 750.

Also shown in FIG. 25 are PROD_CARGO_TYPE table 754 and CARGO_TYPE table 772. PROD_CARGO_TYPE table 754 broadly corresponds to the allowed add-ons 520 in FIG. 6 and along with CARGO_TYPE table 772 specifies an allowed cargo type for the product. Several cargo types may be specified for each product and examples of cargo types include perishable goods, electrical goods, dangerous goods, live animals, etc.

Referring now to FIG. 26, PERF_CAT table 762 is shown alongside the CARR_PROD table 750. PERF_CAT table 762 allows carriers to define performance categories which represent abstracted “speeds” from each carrier's network, for example “Express”, “Standard”, “72-hour”. As can be seen from the CARR_PROD table 750, carriers link products to performance categories in this table. This configuration rationalizes the data and, rather than carriers having to provide data for attributes (e.g. handling times 756 and connection times 758) for each product, they are only required to supply such data for each performance category; and there may be many more products than performance categories. Performance categories will be described in more detail after the following description of schedule types 760.

FIG. 27 shows a schedule type table, SCHED 760, comprising a schedule ID (SCHED_ID); SELLR_MEMB_ID; name details (NAME, NAME_UPPR); and a public key type (PUBLIC_KEY_TYPE 774). The schedule type has been devised to perform two distinct functions and these will now be described.

The first function enables the data management system to support the implementation of two different types of schedules—flight (route) specific schedules and time definite schedules. Flight specific schedules represent the true operating network of a carrier and comprise actual entries relating to real flights. Time definite schedules represent a marketed network for a range of products, for example an overnight network, a 24-hour network or a 48-hour network. These generally need not have any direct relationship with the underlying flights the carrier will use for physically shipping the freight, and indeed there may be several alternative physical flights that can be used to implement a single time definite flight. Since time-definite schedules do not necessarily map directly to physical flights, they are termed “virtual flights”. Flight legs for time definite flights are defined for each point-to-point journey the carrier wishes to market in their network, and because of this there are potentially many more ‘time definite’ flights than there are ‘flight specific’ flights. In particular the industry standard system of numbering flights breaks down for ‘time definite’ flights, as for a typical carrier it does not provide enough unique numbers to describe them all. Schedule type and in particular PUBLIC_KEY_TYPE 774 are used to address this problem. Whilst both types of schedules are loaded into the same data structures, the logical key is different according to whether the schedule is ‘flight specific’ or whether it is ‘time definite’. If the schedule is ‘flight specified’ for a given carrier, the logical key to a flight is flight number (plus date if a flight instance). If the schedule is time definite, the logical key additionally includes the origin and destination. PUBLIC_KEY_TYPE 774 is used to flag which key applies for each schedule, typically flight specific schedules using a ‘standard key’ and time definite schedules using an ‘extended key’.

This means that for ‘flight specific’ schedules, if the database holds a flight AA1234 LHR JFK departing on Jan. 1, 2001, and a user loads a flight AA1234 LHR BOS departing on Jan. 1, 2001, it will be treated as an amendment to the original flight—there can only be one AA1234 on Jan. 1, 2001. For ‘time specific’ schedules, if the database holds a flight AA1234 LHR JFK departing on Jan. 1, 2001 and a user loads a flight AA1234 LHR BOS departing on Jan. 1, 2001, the flight will treated as a new flight.

An additional issue for carriers introducing products is that they may wish to separate their schedules, so that some schedules whether ‘flight specific’ or ‘time definite’, are available for some products but not for others. For example,

a carrier may introduce a trucking schedule to be made available only for the slower discounted products.

a carrier may introduce 3 virtual schedules, ‘Express’, ‘24 hour’ and ‘standard’ which are available for 3 separate products (‘Exp’, ‘24 hr’, ‘standard’) with no overlap (eg. The ‘standard’ product cannot use flights from the ‘Express’ schedule)

This additional issue is addressed by the second function of schedule types. As can be seen from FIG. 28, each schedule type for each carrier is defined for one or more performance categories in the SCHED_PERF_CAT table 776 shown relating the SCHED table 760 to the PERF_CAT table 762. Each schedule type is thus defined for certain products. By creating schedule types and then creating a relationship between them and products (via performance categories) in this way, certain schedules can be applied to certain products.

Schedule types are therefore introduced for two reasons

to allow the entry of ‘time definite flights’ and ‘flight specific’ flights into the same database tables

to allow carriers to provide separate schedules for different performance categories (and hence for different products)

It should be noted that schedule type is used in the creation, deletion and amendment of flights, and in the population of the flight segment table. It is not however used in the DM search process—the DM search algorithm does not manage ‘flight specific’ flights any differently from ‘time definite’ flights. This means that the system can combine both types of flight in the search results, both in the sense that it can display both types of flight as separate rows and also within mixed rows (eg an intercontinental time definite schedule can connect with a local truck schedule).

It should also be noted that the two distinct functions of schedule type may be implemented separately. In one embodiment the first function is implemented as described above. In another embodiment for use in a system not supporting virtual flight schedules, the second function is implemented as above but without the PUBLIC_KEY_TYPE included as a field in the schedule type table 760.

Having defined a relationship between schedules and products using performance categories, a relationship between flights and products can be defined. This is performed by including SCHED_ID in the seasonal schedule table (FLGHT table 778) and the operational schedule table (FLGHT_INST table 780). As can be seen from FIG. 28, these tables correspond directly with seasonal-schedule table 91 and operational schedule table 92 of FIG. 7, but with SCHED_ID added.

The introduction of schedule type (as SCHED_ID) to the flight and flight instance tables is a high level control, allowing carriers to create a general relationship between performance categories (and hence products) and flights. However, carriers may wish to define this at a more granular level and to facilitate this a performance category exclusions table, PERF_CAT_EXC 782, is provided which enables carriers to override the performance categories supported by a particular flight. Performance category exclusions table 782 is shown in FIG. 29. As can be seen, the table includes an ID (PERF_CAT_EXP_ID); PERF_CAT_CODE; SELLR_MEMB_ID; flight number (FLGHT_NO); origin and destination station codes (ORG_STN_CODE and DEST_STN_CODE); days for which the exclusion applies; and PUBLIC_KEY_TYPE. This table may be used to exclude particularly busy flights from low end products, for example it may be that the last flight LHRDXB before the weekend is particularly constrained and should be excluded from low end products.

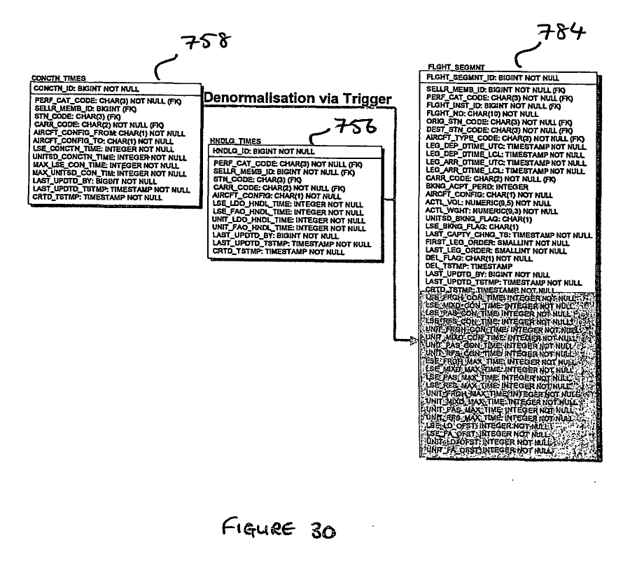

Referring now to FIG. 30, connection times table (CONCTN_TIMES 758) and handling times table (HNDLG_TIMES 756) are shown together with flight segment entry, FLGHT_SEGMNT 784. Flight segment entry 784 corresponds to flight segment entry 93 (FIG. 7) of the flight segment table. As can be seen SELLR_MEMB_ID and PERF_CAT_CODE are included in flight segment entry 784.

Handling times table 756 broadly corresponds to station handling sub-module 534 of FIG. 6 and comprises a handling ID (HNDLG_ID); PERF_CAT_CODE; SELLR_MEMB_ID; a station code (STN_CODE); a carrier code (CARR_CODE); an aircraft configuration code (AIRCFT_CONFIG); an import and export handling times for loose cargo (LSE_LDO_HNDL_TIME and LSE_FAO_HNDL_TIME); and import and export handling times for unitized cargo (UNIT_LDO_HNDL_TIME and UNIT_FAO_HNDL_TIME).

Connection times table 758, broadly corresponding to connection times tables 94 and 96 of FIG. 8, comprises PERF_CAT_CODE; SELLR_MEMB-ID; STN_CODE; CARR_CODE; an aircraft configuration for the in-coming flight (AIRCFT_CONFIG_FROM); an aircraft configuration for the out-going flight (AIRCRFT_CONFIG_TO); loose and unitized connection times (LSE_CONCTN_TIME); and UNITSD_CONCTN_TIME); and maximum connection times for loose and unitized cargo (MAX_LSE_CON_TIME and MAX_UNITSD_CON_TIME). During the pre-calculation routine 104, described with reference to FIG. 11, the flight segment entries of the flight segment table are populated with loose (LSE) and unitized (UNIT) connection times (CON_TIME) and maximum connection times (MAX_TIME) for freighter (FRGH), mixed passenger and freighter (MXD), passenger (PAS) and truck (RFS). Similarly, the flight segment entries are populated with import and export handling times for loose and unitized cargo (LSE_LD_OFST, LSE_FA_OFST, UNIT_LD_OFST and UNIT_FA_OFST). These fields on the flight segment entries are populated using the data in CONCTN_TIMES table 758 and HANDLG_TIMES table 756.

It can be seen that the connection times and handling times in the tables shown may be defined for each carrier for each station for each aircraft configuration or combination of aircraft configurations. However, carriers may simply choose to define one time for all stations and vehicle types. In other embodiments the CONTCTN_TIMES table 758 and HANDLG_TIMES table 756 contain fields enabling carriers to define the times by date, day of week and/or time of day.

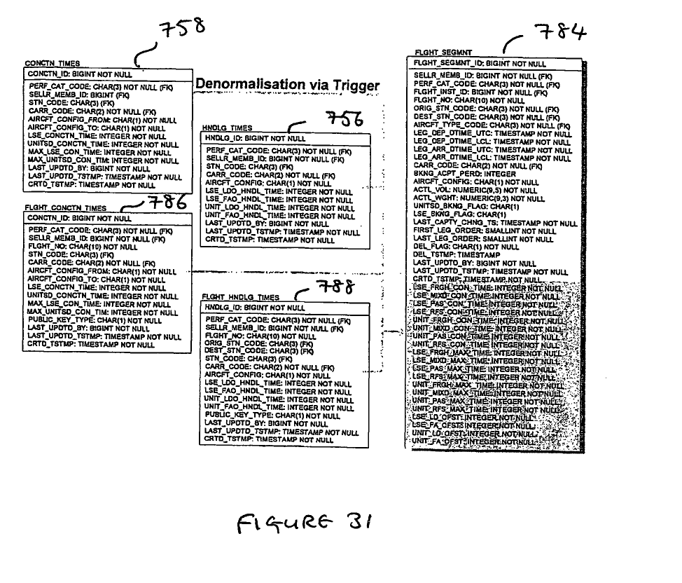

In the embodiment illustrated, to provide further flexibility carriers can override the station-based handling and connection times with handling and connection times by flight number and day of week. This is implemented using flight connection times table, FLGHT_CONCTN_TIMES 786, and flight handling times table, FLGHT_HANDLG-TIMES 788. FIG. 31 shows these tables together with CONCTN_TIMES table 758, HNDLG_TIMES table 756 and FLGHT_SEGMNT entry 784. As can be seen, FLGHT_CONCTN_TIMES table 786 comprises fields for a connection ID (CONCTN-ID); PERF_CAT_CODE; SEUR_MEMB_ID; Flight number (FLGHT_NO); STN_CODE; CARR_CODE; AIRCFT_CONFIG_FROM; CARR_CODE; AIRCFT_CONFIG_FROM; AIRCFT_CONFIG_TO; LSE_CONCTN_TIME; UNITSD_CONCTN_TIME; MAX_LSE_CON_TIM; MAX_UNITSD_CON_TIM; and PUBLIC_KEY_TYPE. Hence, fields corresponding to fields in the CONCTN_TIMES table 758 are defined for a particular flight, identified by FLGT NO, at a particular station.

Similarly, FLGT_HNDLG_TIMES table 788 comprises fields for a handling ID (HNDLG_ID); PERF_CAT_CODE; SELLR-MEMB_ID; Flight number (FLGHT_No); origin station and destination station codes (ORIG_STN_CODE and DEST_STN_CODE); station code (STN_CODE); CARR_CODE; AIRCFT_CONFIG: loose and unitized import and export handling times (LSE_LDO_HNDL_TIME, LSE_ FAO_HNDL_TIME; UNIT_LDO_HNDL_TIME and UNIT_FAO_HNDL_TIME); and PUBLIC_KEY_TYPE. Hence, fields corresponding to fields in the HNDLG_TIMES table 756 are defined for a particular flight, identified by FLGHT_NO, for a particular origin and destination station pair.

When the flight segment table is populated, using pre-calculation routine 104, the connection time data fields and handling time data fields (shown in the shaded part of flight segment entry 784 from LSE_FRGH_CON_TIME to UNIT_FA_OFST) are populated with values determined from CONCTN_TIMES table 758 and HNDLG_TIMES 756 unless overrides for particular flights are defined in FLGHT_HNDLG_TIMES table 786 and/or FLGHT_HNDLG_TIMES table 788. If such overrides are defined the corresponding flight segment entries are populated with values determined from the FLGHT_CONCTN_TIMES and/or FLGHT_HNDLG_TIMES tables respectively.

It will be appreciated from FIG. 31, by using PUBLIC_KEY_TYPE, that handling time and connection time overrides apply to flights from both time definite and flight specific schedules.

It should be noted that these overrides can be used to accurately represent office hours. For example, if a particular flight arrives at 2 am when the office is closed, the carrier can provide an import handling time of 6 hours so that the displayed pick-up time is 8 am. The carrier can thus tailor import and export handling times so that the displayed drop-off and pick-up times always occur during office hours.

Returning now back to FIG. 24 and FIGS. 5 and 10, MCRO table 768 and transfer sets table 770 correspond to MCRO table 98 and transfer points table 100. However product ID (PROD_ID) is added as a field in tables 768 allowing MCRO and transfer sets to be defined for each product and 770.

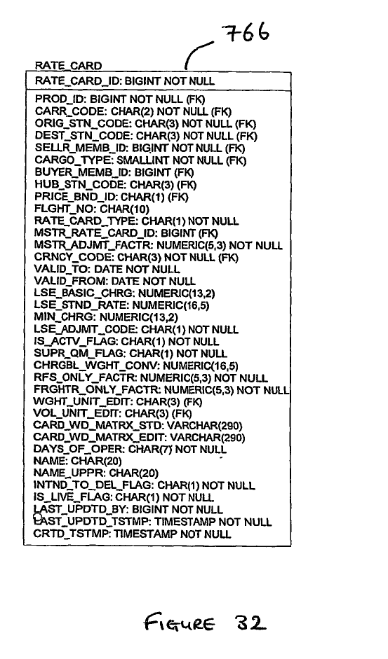

Similarly PROD_ID is added as a field in the RATES table 766 as shown in FIG. 32. This enables carriers to set different prices for different products. As can be seen from FIG. 32 rate card table 766 comprises PROD_ID; CARR_CODE; ORIG_STN_CODE; BEST_STN_CODE; SELLR_MEMB_ID; CARGO_TYPE; BUYER_MEMB_ID; (HUB_STN_CODE); price band ID (PRICE_BND_ID); FLGHT_NO; RATE_CARD_TYPE; master rate card ID (MSTR_RATE_CARD_ID); master adjustment factor (MSTR_ADJMT_FACTOR); currency code (CRNCY_CODE); valid to and from dates (VALID_TO and VALID_FROM); loose basic charge (LSE_BASIC_CHRG); loose standard rate (LSE_STND_RATE); minimum charge (MIN_CHRG); large adjustment code (LSE_ADJMT_CODE); IS_ACTV_FLAG; SUPR_QM_FLAG; chargeable weight conversion (CHRGBL_WGHT_CONV); factors for truck-only and freighter-only (RFS_ONLY_FACTR and FRGHTR_ONLY_FACTR); WGHT_LNIT_EDIT; VOL_UNIT_EDIT; CARD_WD_MATRX_STD; CARD_WD_MATRX-EDIT; days of operation (DAYS_OF_OPER); and name details (NAME; and NAME_UPPR).

It will be appreciated from the earlier description with reference to FIGS. 1 to 22, that the Flight segment table 76 is constructed for efficient calculation of routing options satisfying a given set of search parameters. An important benefit of the construction used for this table is that certain attributes (eg. handling and connection times) for a flight segment are pre-calculated and stored in a single table. Therefore a search through the table in real-time can be performed. Such a search is more efficient than a search which requires values for these attributes to be calculated “on-the-fly”.

In an embodiment using a flight segment entry such as that shown in FIG. 30, flight segments are pre-calculated for each performance category. That is to say, a flight segment entry corresponding to a particular flight segment is created for one performance category, for example “Express”, and another flight segment entry corresponding to the same flight segment is created for another performance category, for example “standard”, provided both performance categories are ascribed to the flight segment.

This means that multiple entries are created for a single flight segment for each performance category, with the appropriate handling and connection times for each performance category stored for each entry. It will be appreciated that in an embodiment not implementing performance categories, corresponding flight segment entries are created for each product.

Referring back to FIG. 24, the use of schedule type 760 to populate the flight segment table will now be described. This procedure is performed by the pre-calculation routine for each valid combination of flight legs. Each flight leg combination comes from a schedule having a defined schedule type. Using SCHED_PERF_CAT table 776, each schedule type maps on to a particular performance category. A check is made for any performance category overrides and a flight segment is created in the flight segment table for the performance category. Handling and connection times, taking into account any overrides, are also entered into the flight segment table for the flight segment. Capacity data for the flight segment (ACTL_VOL and ACTL_WGHT) is included in the flight segment table from a capacity data table, for instance. The process is repeated for each performance category defined by SCHED_PERF_CAT table 776 for the schedule type. In another embodiment, where performance categories are not implemented, the process is repeated for each product specified for the schedule type.

A search function corresponding to dmPerformSearch 320 described with reference to FIGS. 17 and 18 is used to search the flight segment table in response to a requested search. As already described, MCRO table 768 and transfer sets table 770 are defined for each product. In step 350 (FIG. 18) of the flight segment set function 326 the search is performed for each marketed product (plus add-ons valid for the route). In step 352, the check is made for each product; and the check at step 354 is performed for each allowed product. At step 356, the flight segment table is searched for direct flight segments supporting each product. With performance categories implemented, this search is performed for segments supporting the performance category for the product. When concatenating flight segments at step 366, a check is made that each segment supports the product (or performance category). It will be appreciated that if several products share the same performance category, a search result is created for each product although there is only a single entry in the flight segment table. In one embodiment the flight segment table is searched for each performance category and the results are then combined with data for each corresponding product to create the search results.

Data in RATE_CARDS 766 is used to generate a price for each product satisfying the requested search. In a preferred embodiment prices held on the rate cards can vary by station, hub-station, shipment, customer, group of customers, time period, day of week, time of day, cargo type, group of cargo types, flight, flight number, vehicle type and/or flight instance.

Referring back to FIG. 25, carriers can specify guaranteed weight (CAPTY_GUAR_WGHT) volume, available at a guaranteed weight (CAPTY_GUAR_VOL) and time before departure in hours (CAPTY_GUAR_TIME) for each product. The search function adjusts the capacity available according to the rules defined for each product by these entries. The formula below, using the following abbreviations is used to check if capacity is available:

GW=guaranteed weight

GV=volume available at guaranteed weight

T=time before departure

SW=searched weight

SV=searched volume

W=weight available on flight

V=volume available on flight

```
IF TIME TO DEPARTURE > T:
    IF SW <= W AND SV <= V THEN
        CAPACITY AVAILABLE = YES.
    ELSE IF SW <= GW AND SV <= MAX (V, GV)
        CAPACITY AVAILABLE = YES
    ELSE
        CAPACITY AVAILABLE = NO
    END IF
ELSE:
    IF SW <= W AND SV <= V THEN
        CAPACITY AVAILABLE = YES
    ELSE
        CAPACITY AVAILABLE = NO.
    END IF
END IF
```

In a preferred embodiment the search function checks certain size and weight controls as defined on CARR_PROD 750. These include checking that minimum and maximum shipment weights and individual price weights are applied. Further, the search function checks which products support the searched-for cargo type, returning only valid results. Referring back to carrier product table 750 in FIG. 25, it can be seen that by setting values for the fields BB_DSPLY_FLGHTS to SA_DISPLY_FLGHTS, carriers are able to specify in CARR_PROD table 750 whether or not flight numbers, routings, flight departure and arrival times and/or drop-off and collection times are displayed to carrier users and/or forwarder users for pre-bookings and/or post-bookings. This generates a total of 16 options as set out in the 16 fields from BB_DISPLY_FLGHTS to SA_DSPLY_FLGHTS inclusive.

In a preferred embodiment, users can perform flight specific searches or time-definite searches. The interface and difference between these searches has been described with reference to FIG. 16. In an embodiment implementing a flight segment table with flight segment entries such as FLGHT_SEGMNT 784 of FIG. 30, values corresponding to import and export handling times are included in each entry. This effects efficient real-time searches. Handling time and connection time data may be represented as absolute or relative values. In CARR_PROD table 750 (FIG. 26), products are identified as being valid for flight specific searches by setting ACC_VIA_ETD_ETA to TRUE. Products are identified as being valid for time-definite searches by setting ACC_VIA_LDT_FAT to TRUE. It would not be uncommon for carriers to set both of these fields to TRUE.

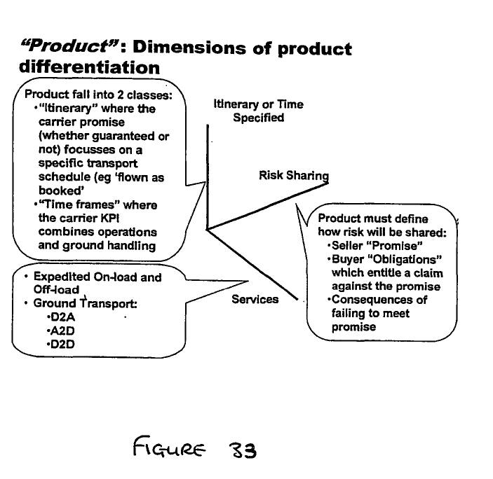

Further features and advantages of embodiments will become apparent from the following description given with reference to FIGS. 33 to 38.

Within the freight industry, sellers are increasingly seeking to differentiate their market offering by introducing ‘products’ into that marketplace. The introduction of a number of products allows them to:

1. Introduce higher value, premium services into the marketplace

2. Appeal to and compete over different segments of the market place based on service required and willingness to pay

3. Generate new areas of revenue, and hence introduce greater sophistication into their revenue management functions

4. Build differentiation and market brands which promote customer loyalty

Cargo products have a number of distinct dimensions, and the definition of a seller ‘product’ typically incorporates one or more of the dimensions outlined in FIG. 33.

Products fall into two distinct classes—Itinerary Specified Products and Time Specified Products. Itinerary specified products are products where there is either a guarantee or a KPI (Key Performance Indicator) that the booked freight will travel on a specified flight (or any other specified mode of transport such as a ship or rail or truck). It should be noted that ‘Itinerary’ incorporates both the routing and the actual vehicles scheduled for the journey. Time specified products are products where there is either a guarantee or a KPI that the booked freight will travel within a certain time frame, but there is no commitment made regarding which physical flight (or other mode of transport) it will travel on.

Performance of the Service

The performance of the service can be taken as the elapsed time between drop off of cargo at origin and pick up at destination. A seller can offer a number of different performance options through combining some or all of the following:

The routing options available to a product (higher performance products based on fewer transfers or direct routes only)

The use of different modes of transport (eg higher performance products using flights over trucks wherever possible)

The use of Fast, ‘expedited’ handling times at origin, destination and at any intermediate transfers, as opposed to the regular service levels provided

Delivery Variants

Typically sellers offer a point to point service to the freight buyer. The freight buyer is responsible for delivering the freight to the origin point, and collecting it from the destination point. Delivery variants include the seller providing additional services to collect cargo from the buyer's depot or the shipper's address, and deliver to the buyer depot or consignee address.

Special Handling

Sellers are increasingly offering special handling options, designed around the needs of particular cargo types. Examples of handling options include:

Temperature controlled (use of special containers and storage facilities to ensure fresh goods are kept at low temperature)

Shock controlled (use of special, shock controlled containers to prevent damage to sensitive components such as micro electronic equipment)

High security (use of highly secure containers and storage for valuable goods)

Risk Sharing

Guarantees are offered to assure the customer of various aspects of the service, most typically the performance aspect.

Examples of guarantees where the seller commits to provide the service (typically in the form of offering a rebate of all or part of the charges if it fails to meet the guarantees), are as follows:

Guarantee to a maximum elapsed time from delivery at origin to availability at destination (e.g. max 3 days)

Guarantee that the freight will travel on the stated transport as booked, according to the itinerary eg ‘Flown as Booked’ (i.e. No offloads or change or routing)

Guarantee of handling times (e.g. Will get on if delivered 4 hours before flight, will be available 3 hours after landing)

Examples of guarantees where the seller asks the buyer to commit to honoring their commitment (typically in the form of a weight based financial charge) in terms of the booking are as follows:

Buyer must provide cargo and containers matching description, within x hours of flight departing

Buyer must provide cargo not less than the weight booked

Embodiments in accordance with the present invention may provide the following functionality:

Definition of Products:

The ability for the seller to add new products to their offer by editing parameter data only

The ability to support all known products in the marketplace

The ability to define a service type with associated terms and conditions, and a mapping between the cargo type entered and the buyer and the service type subsequently offered by the seller

Optimization of Product—Physical relationship

Dynamic generation and optimization of different performance options from an underlying schedule according to seller defined performance and marketing rules

Display of Products:

Graphical indication of the complex properties of the products

Many products displayed from many sellers in response to a single search request, in an order prioritized by the buyer

A ‘level playing field’ for comparison of many different products in a single display

The ability to view (rather than make) bookings for many products in a single display

Hyperlinks from product description to seller provided terms and conditions, provided as a page of HTML

Ability of seller to control how much of the underlying data to show to the buyer (e.g. show the flights, or simply show the drop-off and pick-up times)

Measurement of Product—Physical relationship

The ability to monitor actual performance against that offered (by either the buyer or the seller)

Rating of Product

The ability to set up and display the rate associated with the particular product on the route selected

Buyer choice of search basis

The ability to specify whether search predicates corresponding to start and end times apply to the actual vehicle departure and arrival times or to the latest drop-off and earliest pick-up times.

For example, suppose a buyer searches for products departing after 9 am on a certain date. Suppose also a carrier has a flight departing at 10 am, with a freight latest drop-off time at 8 am.

The buyer may specify that the 9 am search predicate applies to the flight times (in which case the carrier's product will be returned) or they may specify that the 9 am search predicate applies to the latest drop-off times (in which case the carrier's product will not be returned).

This allows buyers to search for the products which exactly match their requirements.

Embodiments in accordance with the invention offer a front end which reduces changes to legacy systems across the carrier community, by allowing sellers to set-up generic definitions of their products, which will be used to generate and display product offerings on their behalf. This allows sellers to market products where it may not be possible using their own legacy systems.

A preferred embodiment builds a complex set of search results based on a complex search of underlying flights

A preferred embodiment interfaces with carriers legacy system on the basis of an underlying flight selection (i.e. the standard existing data) together with a product indicator

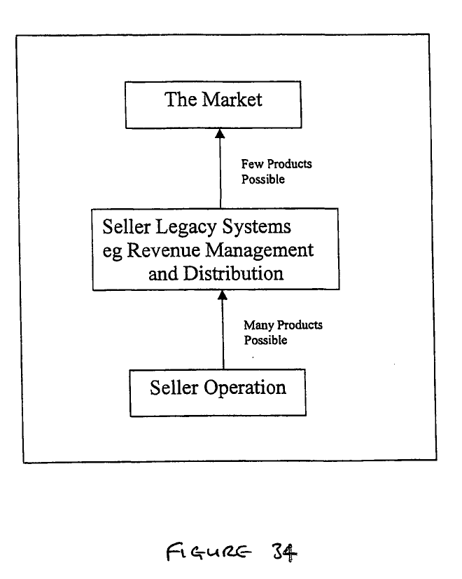

FIG. 34 shows the situation with existing systems, where the Seller's operation may support many different products, but their systems do not allow the distribution and management of those products.

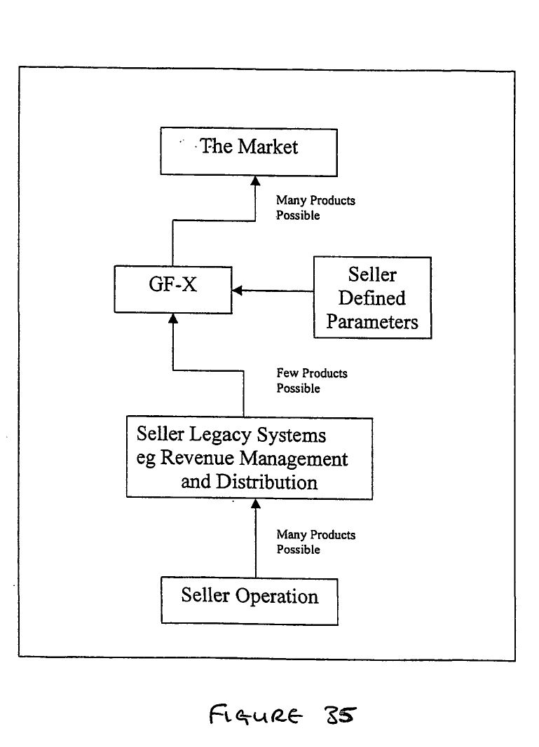

FIG. 35 shows how an embodiment in accordance with the present invention allows sellers to market and manage products, by allowing them to specify product definitions directly to the system, marked GF-X, for management and distribution to the marketplace.

The definitions of products supplied by sellers will include both Operational and Marketing (non-operational) factors.

Operational factors, all of which can be varied by product type and route:

Import handling times by product, equipment type,

Export handling times

Minimum/Maximum Transfer times

Allowed cargo types by equipment type, route, points on the journey

Allowed service type add-ons

Flights/Trucks/Routes supporting the product

Allowed earliest pick-up/latest drop-off times (see below)

Relationship between cargo type and service types

Marketing factors, all of which can be varied by product type and route:

Guarantees

Minimum journey times (eg must be at least 24 hours)

Maximum journey times (eg must be less than 48 hours)

Terms and Conditions

Icon representation of the product

Display Options (eg show indicative flights)

Allowed earliest pick-up/latest drop-off times (see below)

Allowed interlining options

Optimization of Product—Physical Relationship

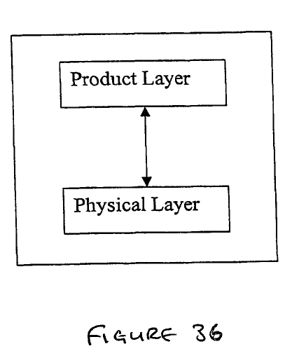

The introduction of Products can be thought of as introducing a new level at which the sellers and buyers interact. Without products, sellers and buyers simply deal with the physical space on aircraft/ships/trucks/trains—the buying and selling is of a physical quantity. With the decommoditization enabled by the introduction of products however a new layer of abstraction is introduced (see FIG. 36) where many different products may correspond to a single physical option.

A key feature of a preferred embodiment is the way in which it manages the relationship between the physical operations of the seller and the products offered by the seller. In this section we consider how the invention dynamically generates products from the physical data, and how it leverages the flexibility between the physical and product levels to maximize revenue.

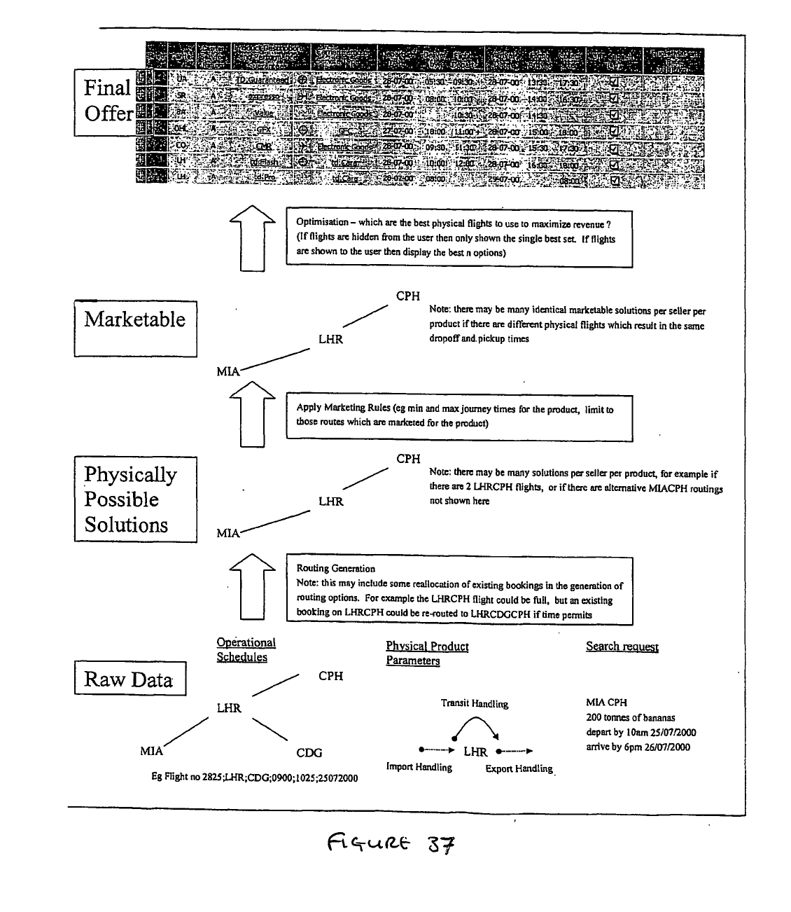

FIG. 37 illustrates how an embodiment dynamically generates Product offerings for an Air Freight market based on

Physical feasibility (eg is there enough time for connections to be made ?)

Marketing rules (eg for a discount product, the journey must be at least 48 hours to avoid it competing with a Premium product)

Revenue Optimization—in some cases there is some flexibility as to how a product offer is implemented in Physical terms. For example, there may be many different ways of routing a 48 hour package between London and Paris. A preferred embodiment uses Revenue Management science to select the revenue-maximizing option, including considering the re-routing of existing bookings to free up valuable capacity where necessary.

Marketing Rules

Latest Drop-off and Earliest Pick-up times

A feature of an embodiment is the calculation of latest drop-off and earliest pick-up times for each product. These have both an operational element (eg offices may be closed on Sundays) and a marketing element (eg for a certain product freight is accepted until time X and available by time Y, regardless of the routing).

The embodiment takes the following parameters as input to the calculation of latest drop-off and earliest pick-up times:

departure time

arrival time

Import handling time

Export handling time

A set (D) of Allowed drop-off times at origin

A set (P) of Allowed pick-up times at destination

The latest drop-off time is calculated as follows:

Latest Feasible Drop-off time=departure time−Export handling time

Latest Drop-off time=Latest (d∈D) s.t. d<Latest Feasible Drop-off time

The earliest pick-up time is calculated as follows:

Earliest Feasible Pick-up time=departure time+Import handling time

Earliest Pick-up time=Earliest (p∈P) s.t. p>Earliest Feasible Pick-up time

See FIG. 19 and the corresponding text.

Minimum and Maximum Journey Times

A preferred embodiment allows minimum and maximum journey times to be defined on a route/product basis. This allows sellers to segment their markets by required delivery speed by defining allowed journey times for each product. For example they may define an ‘Express’ product to have a maximum time of 24 hours on some set of routes, together with a ‘Value’ product to be between 24 and 48 hours on the same routes. This prevents ‘fast’ Value products being returned and ‘slow’ express products being returned. The known existing seller systems do not give this overall dynamic level of control.

Display of Products

Graphical Representation Of Products In Search Results

In an embodiment, sellers can control the display of:

A product name

A product icon

Product Terms and Conditions

A Service Package add-on

Service Package Terms and Conditions

The icons available to represent products may be chosen from a system defined selection. The icons may represent the following dimensions of products:

| Property | Notes | Allowed Values |
|---|---|---|
| Time | Will be transported within | Y/N |
| Specified | supplied time frame | |
| Itinerary | Will be transported on | named itinerary/first |
| Specified | specified itinerary | available itinerary/no |
| Import | Must be delivered by time X | Y/N |
| Handling | if seller is to meet any | |
| Specified | product commitments | |
| Export | Will be available for | Y/N |
| Handling | customs clearance by time X | |
| Specified | after arrival | |
| Buyer | Financial comeback if Buyer | Y/N |
| Guarantee | fails to meet promise | |
| Seller | Financial comeback if Seller | Y/N |
| Guarantee | fails to meet promise | |

As any of the first 4 properties can be independently guaranteed together all combinations generate 4.6.4.4=384 icons, however typically only about 10 are commonly used.

Multiple Products In a Single Set Of Search Results

A preferred embodiment allows the display of multiple product offerings in a single set of search results, creating a ‘level playing field’ where different products can be represented and compared in a fair and unbiased way.

The key challenge with this is to find a clear way of searching for, and then representing ‘time definite’ products and ‘Itinerary Specified’ products on the same page of search results.

‘Time Definite’ products are focused on latest drop-off and earliest pick-up times, and may or may not have flight details available for display.

‘Itinerary Specified’ products are focused on individual flights/ships/trains etc and may not have latest drop-off or earliest pick-up times available for display.

One possible solution to this is to divide the search into 2 components—a ‘Time Definite’ component and a ‘Itinerary Specified’ component. This is not a good solution however as it means the market is effectively split into 2, with a loss of liquidity and usability.

The better solution is to keep the market as one, but still allow the user to choose whether to do a schedule based search or a time based search.

If a schedule based search is performed, the underlying schedules of ‘Time Definite’ products are used to determine if they should appear in the search results, and how they should be ordered.

If a time based search is performed, for schedule based products, handling times are used to extrapolate from the schedules to calculate if they should appear in the search results, and how they should be ordered. In this case, if no handling times are available the products are not returned.

In the final results screen, all information available is displayed as in FIG. 20 (for the Air Cargo marketplace):

Ability To Monitor Performance

The ability to measure performance can be an important component of a system allowing the offering of different products.

Through a combination of Operational Data together with a categorization of the key performance indicators of each product, preferred embodiments constructed in accordance with the invention allow

Management Information reports to be run which analyze the performance of both buyers and sellers.

Real-time alerts to indicate divergence from an expected event path

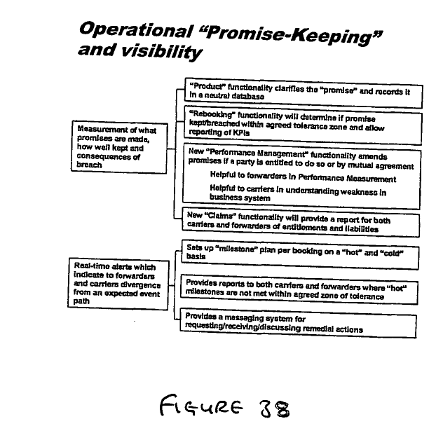

So, as illustrated in FIG. 38, in addition to forming a bridge between the Physical and Product levels shown in FIG. 36 for marketing, optimization and distribution purposes, embodiments may also allow a bridge between levels for performance monitoring purposes.

This functionality is unavailable in all known systems, because they do not have the combination of operational data, product categorization across sellers and management information reporting.

The operational data required includes:

Actual drop-off time

Actual departure time

Actual arrival time

Actual pick-up time

Actual manifest weight

Actual manifest volume

Actual manifest dimensions

Actual manifest shipment type

Actual manifest container type

Actual manifest cargo type

This is then matched against each booking record, which contains the times committed to by the seller and buyer.

Some example reports include:

Percentage of bookings (by Volume, Revenue etc) where buyer F failed to drop-off to seller C on time

Percentage of bookings (by Volume, Revenue etc) where seller C failed to deliver to buyer F on time

In view of the foregoing description it will be evident to a person skilled in the art that various modifications may be made within the scope of the invention.

Insofar as embodiments of the invention described above are implementable, at least in part, using a software-controlled programmable processing device such as a Digital Signal Processor, microprocessor or other processing device, it will be appreciated that a computer program for configuring the programmable device to implement the foregoing described methods is envisaged as an aspect of the present invention. The computer program may be embodied as source code and undergo compilation for implementation on a processing device, or may be embodied as object code.

Suitably, the computer program is stored on a carrier medium in machine or device readable form, for example in solid-state memory or magnetic memory such as disc or tape and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

The scope of the present disclosure includes any novel feature or combination of features disclosed therein either explicitly or implicitly or any generalization thereof irrespective of whether or not it relates to the claimed invention or mitigates any or all of the problems addressed by the present invention. The applicant hereby gives notice that new claims may be formulated to such features during the prosecution of this application or of any such further application derived there from. In particular, with reference to the appended claims, features from dependent claims may be combined with those of the independent claims and features from respective independent claims may be combined in any appropriate manner and not merely in the specific combinations enumerated in the claims.

For the avoidance of doubt, the term “comprising” used in the description and claims should not be construed to mean only “consisting only of”.

What is claimed is:

1. A method of configuring a computer system including a processing unit, an interface unit for communication with said processing unit and a memory unit, for providing an integrated representation of transport service levels for routes in a transport system comprising a multiplicity of connectable stations, the method comprising:
storing in said memory unit a short term schedule of individual instances of transport provider route legs, each route leg corresponding to a directly connectable station pair;
further storing in said memory unit service level data representative of one or more transport service levels ascribed to one or more route leg instances, said service level data comprising for the or each transport service level a service level identifier identifying the transport service level and at least one service attribute representing a characteristic of the transport service level;
deriving a route segment table comprising one or more route segments, each route segment corresponding to a route leg instance or a combination of route leg instances; and
storing said route segment table in said memory unit.

2. A method according to claim 1, further comprising including in said route segment table a service level identifier associating each route segment with said one or more ascribed transport service levels.

3. A method according to claim 1, wherein the service level data comprises performance category data representative of one or more performance categories, said performance category data comprising for the or each performance category a performance category identifier and a plurality of performance category attributes, wherein a performance category identifier is a service attribute of a plurality of transport service levels, the performance category attributes representing service attributes of said plurality of transport service levels, and wherein said one or more performance categories are ascribed to one or more route leg instances, thereby ascribing a plurality of service levels to one or more route leg instances.

4. A method according to claim 3, further comprising including in said route segment table a performance category identifier associating each route segment with said one or more ascribed performance categories.

5. A method according to claim 4, wherein the or each transport service level has as service attributes a performance category identifier and at least one other service attribute.

6. A method according to claim 5, further comprising including in said route segment table one or more entries corresponding to said service and/or performance category attributes of said one or more ascribed transport service levels and/or performance categories for each route segment.

7. A method according to claim 6, wherein said short term schedule comprises one of a plurality of schedule types; one of said service and/or performance category attributes denoting the schedule type or types associated with the service level and/or performance category thereby ascribing the service level and/or performance category to the route segments derived from legs of a schedule of an associated schedule type.

8. A method according to claim 7, wherein a schedule type is associated with a plurality of transport service levels and/or performance categories.

9. A method according to claim 8, further comprising storing in said memory unit data representative of route exceptions for a transport service level and/or a performance category, each route exception representing one or more route leg instances excluded from the transport service level and/or performance category, thereby overriding the ascribing of the service level and/or performance category for segments derived from said one or more route leg instances.

10. A method according to claim 9, wherein at least one service and/or performance category attribute for a transport service level and/or performance category is defined for one or more of: transport provider(s), station(s), vehicle type(s), combination of vehicle type(s), cargo type(s), date, day of week or time of day; said deriving comprising determining the service and/or performance category attribute for each route segment.

11. A method according to claim 10, said service level data comprising data representative of dependency exceptions for a service and/or performance category attribute for a transport service level and/or performance category, said dependency exceptions re-defining the attribute for the transport service level and/or performance category for one or more route leg instances.

12. A method according to claim 11, further comprising including in said route segment table data representative of a departure time and an arrival time for each route segment.

13. A method according to claim 12, further comprising including in said route segment table data representative of available cargo conveyance capacity for each route segment, transport service level and/or performance category.

14. A method according to claim 13, further comprising including in said route segment table at least one cargo compatibility entry representing a characteristic of cargo compatible with the route segment, transport service level and/or performance category.

15. A method according to claim 14, wherein said short term schedule comprises an identifier for each route leg instance and said deriving comprises constructing each route segment from one or more route leg instances having the same identifier.

16. A method according to claim 15, said short term schedule comprising data representative of an on-load permissibility at an origin station and an off-load permissibility at a destination station for each route leg instance and said deriving comprising:
reading an instance of a route leg or a combination of individual instances of route legs from the short term schedule;
checking that the route leg or route leg combination has on-load permissible at the origin station and off-load permissible at the destination station; and
including the route leg or route leg combination as a route segment in the route segment table dependent on the route leg or route leg combination having on-load permissible at the origin station and off-load permissible at the destination station.

17. A method according to claim 16, the method further comprising:
receiving a long term schedule of route legs from respective transport providers, each route leg corresponding to a directly connectable station pair; and
forming said short term schedule from said long term schedule.

18. A method according to claim 17, the method comprising receiving said short term schedule from respective transport providers.

19. A method according to claim 18, wherein said short term schedule comprises an extended-key schedule and/or a standard-key schedule.

20. A method according to claim 19, wherein individual route leg instances in the extended-key schedule are uniquely identified by a logical data key comprising data representative of the route identifier and origin and destination stations.

21. A method according to claim 20, wherein individual route leg instances in the standard-key schedule are uniquely identified by a logical data key comprising data representative of a route identifier.

22. A method according to claim 21, wherein the logical data key for the individual route leg instances in the extended-key schedule is a different structure from the logical data key for the individual route leg instances in the standard-key schedule.

23. A method according to claim 22, the method comprising:
further storing in said memory unit route table data comprising data representative of predefined permissible origin and destination station pairs ascribed to one or more transport service levels and/or performance categories.

24. A method according to claim 23, the method comprising:
further storing in said memory unit transfer set table data comprising a plurality of transfer set records each record representing one or more permissible transfer point stations between route segments for a route between an origin and destination station pair ascribed to a transport service level and/or performance category.

25. A method according to claim 24, said route table and/or transfer set table representing permissible route segments from permissible origin to permissible destination, from permissible origin to permissible transfer point, from permissible transfer point to permissible transfer point and/or from permissible transfer point to permissible destination and said deriving comprising:
reading an instance of a route leg or a combination of individual instances of route legs from the short term schedule;
comparing the route leg or route leg combination with the permissible route segments; and
including the route leg or route leg combination as a route segment in the route segment table dependent on the route leg or route leg combination corresponding to a permissible route segment.

26. A method according to claim 25, the method comprising:
further storing in said memory unit rate data representative of one or more prices linked with each transport service level.

27. A method according to claim 26, wherein the price is dependent on one or more of hub station, shipper, customer, group of customers, time period, day of week, time of day, cargo type, group of cargo types, route, route identifier, vehicle type and route instance.

28. A method according to claim 27, the method further comprising configuring the system to automatically update data stored in said route segment table responsive to an update of data linked thereto stored outside said route segment table.

29. A method according to claim 28, at least one service and/or performance category attribute corresponding to an operational service attribute.

30. A method according to claim 29, said operational service attribute comprising one or more of the following group of operational service attributes:
import handling time; export handling time; minimum transfer time; maximum transfer time; permitted cargo type; permitted service package add on; vehicle type; cargo conveyance capacity; cargo compatibility; size and weight controls; and set of office hours.

31. A method according to claim 30, at least one service and/or performance category attribute corresponding to a non-operational service attribute.

32. A method according to claim 31, said non-operational service attribute comprising one or more of the following group of non-operational service attributes:
service guarantee; time specific search flag; itinerary specific search flag; minimum journey time; maximum journey time; permitted transfer stations; terms and conditions of carriage; icon; service level category; display options; set of permitted latest drop-off times; set of earliest permitted pick-up times; rules to determine access to capacity and permitted interline options.

33. A method according to claim 32, wherein said one or more transport service level and/or performance category is alterable by a transport provider.

34. A method according to claim 33, wherein at least one of said service and/or performance category attributes, operational service attributes and non-operational service attributes are alterable by a transport provider.

35. A method according to claim 34, said deriving comprising including in the route segment table an export handling time for the origin station and an import handling time for the destination station for one or more route segments; wherein the departure date and time minus export handling time defines a drop-off date and time and the arrival date and time plus import handling time defines a pick-up date and time.

36. A method according to claim 35, said deriving comprising including in the route segment table an export handling time and a permitted set of latest drop-off times for the origin station and an import handling time and a permitted set of earliest pick-up times for the destination station for one or more segments, wherein the latest of the permitted set of drop-off times prior to departure time minus export handling time defines a latest drop-off time and the earliest of the permitted set of earliest pick-up times after arrival time plus import handling time defines an earliest pick-up time.

37. A method of configuring a computer system including a processing unit, an interface unit for communication with said processing unit and a memory unit, for providing an integrated representation of routes in a transport system comprising a multiplicity of connectable stations, the method comprising:
storing in said memory unit a short term extended-key schedule of individual instances of route legs each route leg corresponding to a connectable station pair, and
deriving from said short term extended-key schedule a route segment table comprising one or more extended-key route segments, each route segment corresponding to an individual instance of said route legs, or a combination of individual instances of said route legs.

38. A method according to claim 37, wherein each extended-key route segment is uniquely identified by a logical data key comprising data representing a route identifier and the origin and destination stations.

39. A method according to claim 38, the method further comprising:
storing in said memory unit a short term standard-key schedule of individual instances of transport provider route legs;
deriving from said short term standard-key schedule one or more standard-key route segments, each route segment corresponding to an individual instance of said route legs or a combination of individual instances of said route legs; and
storing said one or more standard-key segments in said route segment table.

40. A method according to claim 39, wherein each standard-key route segment is uniquely identified by a logical data key comprising data representing a route identifier.

41. A method according to claim 40, wherein the logical data key identifying the extended-key route segments is a different structure from the logical data key identifying the standard-key route segments.

42. A method for operating a computer system configured in accordance with claim 36, said method comprising:
generating one or more route options responsive to a route search request specifying a journey having an origin and destination station pair, each route option comprising a route segment having an origin and destination station pair specified in said route search request and selected from said route segment table, said route segment comprising one or more route leg instances ascribed to the same one or more transport service levels and/or performance categories throughout said route segment; and
storing said one or more route options in a segment set list in said memory unit.

43. A method according to claim 42, said step of generating one or more route options comprising generating a route option for at least one performance category and using said route option to generate one or more route options for one or more of the plurality of service levels having as a service attribute a corresponding performance category identifier.

44. A method according to claim 43, further comprising:
comparing said requested origin and destination station pair or said one or more route options with a route table comprising predefined permissible origin and destination station pairs for a transport service level and/or performance category stored in said memory unit, to determine whether said requested origin and destination station pair is permissible.

45. A method according to claim 44, wherein said step of generating further comprises concatenating two or more route segments to form a route option having an origin and destination station pair corresponding to said route search request, and comparing transport service levels and/or performance categories associated with said two or more route segments to generate route options comprising route segments having consistent transport service levels and/or performance categories.

46. A method according to claim 45, further comprising comparing said one or more route options with a transfer set table stored in said memory unit and comprising a plurality of transfer set records each associated with an origin and destination station pair for a transport service level and/or performance category, each transfer set record including one or more entries corresponding to said data representative of permissible transfer points, to determine route options having permissible route segment combinations.

47. A method according to claim 46, said generating step responsive to a route search request including a parameter representative of a maximum number of transfer points in a route between said origin and destination pair for a service level and/or a performance category to derive route options comprising no more transfer points than said maximum number.

48. A method according to claim 47, wherein said route segment table includes one or more service and/or performance category attributes ascribed to one or more route segments, the method further comprising receiving a route search request including a parameter representative of a service attribute, and deriving one or more route options in dependence on said service attribute.

49. A method according to claim 48, said step of generating one or more route options comprising generating a price for the associated transport service level.

50. A method according to claim 49, wherein the price is dependent on one or more of hub station, shipper, customer, group of customers, time period, day of week, time of day, cargo type, group of cargo types route, route identifier vehicle type and route instance, and said step of generating comprises determining the appropriate price for the one or more route options.

51. A method according to claim 50, said route search request specifying one or more of the following:
i) departure and arrival date and time for a journey between a station pair;
ii) drop-off and pick-up time for a journey between a station pair;
iii) a cargo conveyance capacity between a station pair;
iv) a price in respect of conveyance capacity;
v) transport provider;
vi) cargo type;
vii) vehicle type;
viii) route identifier;
ix) transport service level;
x) performance category; and
xi) piece dimensions.

52. A method according to claim 51, said transport system comprising a plurality of transport providers.

53. A method according to claim 52, further comprising initiating display of a user interface on a display apparatus, said user interface including a button actuateable by a user to initiate a search by departure and arrival date and time (an itinerary specified search) or a search by drop-off and pick-up date and time (a time specified search).

54. A method according to claim 53, responsive to a search by departure and arrive date and time, generating route options having departure and arrival times satisfying the request, and storing said route options in the segment set list.

55. A method according to claim 54, wherein one or more transport service levels are identified as being valid for searches by departure and arrival date and time, the method comprising generating said route options for such valid transport service levels.

56. A method according to claim 53, responsive to a search by drop-off and pick-up date and time, generating route options having a drop-off and pick-up date and time satisfying the request, and storing said route options in the segment set list.

57. A method according to claim 56, wherein one or more transport service levels are identified as being valid for searches by drop-off and pick-up date and time, the method comprising generating route options for such valid service levels.

58. A method according to claim 57, wherein one or more transport service levels are identified as departure/arrival display transport service levels, the method comprising generating route options with displayable departure and arrival dates and times for said departure/arrival display transport service levels.

59. A method according to claim 58, wherein one or more transport service levels are identified as drop-off/pick-up display transport service levels, the method comprising generating route options with displayable drop-off and pick-up dates and times for said drop-off/pick-up display transport service levels.

60. A method according to claim 59, the method comprising generating route options with one or more of said service and/or performance category attributes displayable.

61. A method according to claim 60, wherein the route segment table comprises extended-key route segments and standard-key segments, and said one or more route options incorporates one or other or both of said route segments.

62. A method for operating a computer system configured in accordance with claim 41, said method comprising:
generating one or more route options responsive to a route search request specifying a journey having an origin and destination station pair, each route option comprising a route segment having an origin and destination station pair specified in said route search request and selected from said route segment table; and
storing said one or more route options in a segment set list in said memory unit.

63. A method according to claim 62, wherein the route segment table comprises extended-key route segments and standard-key segments, and said one or more route options incorporates one or other or both of said route segments.

64. A computer system comprising a processing unit, an interface unit for communication with said processing unit and a memory unit, for providing an integrated representation of transport service levels for routes in a transport system comprising a multiplicity of connectable stations, configured to:
store in said memory unit a short term schedule of individual instances of transport provider route legs, each route leg corresponding to a directly connectable station pair;
further store in said memory unit service level data representative of one or more transport service levels ascribed to one or more route leg instances, said service level data comprising for the or each transport service level a service level identifier identifying the transport service level and at least one service attribute representing a characteristic of the transport service level;
derive a route segment table comprising one or more route segments, each route segment corresponding to a route leg instance or a combination of route leg instances; and
store said route segment table in said memory unit.

65. A system according to claim 64, further configured to include in said route segment table a service level identifier associating each route segment with said one or more ascribed transport service levels.

66. A system according to claim 64, wherein the service level data comprises performance category data representative of one or more performance categories, said performance category data comprising for the or each performance category a performance category identifier and a plurality of performance category attributes, wherein a performance category identifier is a service attribute of a plurality of transport service levels, the performance category attributes representing service attributes of said plurality of transport service levels, and wherein said one or more performance categories are ascribed to one or more route leg instances, thereby ascribing a plurality of service levels to one or more route leg instances.

67. A system according to claim 66, further configured to include in said route segment table a performance category identifier associating each route segment with said one or more ascribed performance categories.

68. A system according to claim 67, wherein the or each transport service level has as service attributes a performance category identifier and at least one other service attribute.

69. A system according to claim 68, further configured to include in said route segment table one or more entries corresponding to said service and/or performance category attributes of said one or more ascribed transport service levels and/or performance categories for each route segment.

70. A system according to claim 69, wherein said short term schedule comprises one of a plurality of schedule types; one of said service and/or performance category attributes denoting the schedule type or types associated with the service level and/or performance category thereby ascribing the service level and/or performance category to the route segments derived from legs of a schedule of an associated schedule type.

71. A system according to claim 70, wherein a schedule type is associated with a plurality of transport service levels and/or performance categories.

72. A system according to claim 71, further configured to store in said memory unit data representative of route exceptions for a transport service level and/or a performance category, each route exception representing one or more route leg instances excluded from the transport service level and/or performance category, thereby overriding the ascribing of the service level and/or performance category for segments derived from said one or more route leg instances.

73. A system according to claim 72, wherein at least one service and/or performance category attribute for a transport service level and/or performance category is defined for one or more of: transport provider(s), station(s), vehicle type(s), combination of vehicle type(s), cargo type(s), date, day of week or time of day; configured to determine the service and/or performance category attribute for each route segment.

74. A system according to claim 73, said service level data comprising data representative of dependency exceptions for a service and/or performance category attribute for a transport service level and/or performance category, said dependency exceptions re-defining the attribute for the transport service level and/or performance category for one or more route leg instances.

75. A system according to claim 74, further configured to include in said route segment table data representative of a departure time and an arrival time for each route segment.

76. A system according to claim 75, further configured to include in said route segment table data representative of available cargo conveyance capacity for each route segment, transport service level and/or performance category.

77. A system according to claim 76, further configured to include in said route segment table at least one cargo compatibility entry representing a characteristic of cargo compatible with the route segment.

78. A system according to claim 77, wherein said short term schedule comprises an identifier for each route leg instance, the system configured to construct each route segment from one or more route leg instances having the same identifier.

79. A system according to claim 78, wherein said short term schedule comprises data representative of an on-load permissibility at an origin station and an off-load permissibility at a destination station for each route leg instance, the system configured to:
read an instance of a route leg or a combination of individual instances of route legs from the short term schedule;
check that the route leg or route leg combination has on-load permissible at the origin station and off-load permissible at the destination station; and
include the route leg or route leg combination as a route segment in the route segment table dependent on the route leg or route leg combination having on-load permissible at the origin station and off-load permissible at the destination station.

80. A system according to claim 79, further configured to:
receive a long term schedule of route legs from respective transport providers, each route leg corresponding to a directly connectable station pair; and
form said short term schedule from said long term schedule.

81. A system according to claim 80, the system configured to receive said short term schedule from respective transport providers.

82. A system according to claim 81, wherein said short term schedule comprises a extended-key schedule and/or a standard-key schedule.

83. A system according to claim 82, wherein individual route leg instances in the extended-key schedule are uniquely identified by a logical data key comprising data representative of the route identifier and origin and destination stations.

84. A system according to claim 83, wherein individual route leg instances in the standard-key schedule are uniquely identified by a logical data key comprising data representative of a route identifier.

85. A system according to claim 84, wherein the logical data key for the individual route leg instances in the extended-key schedule is a different structure from the logical data key for the individual route leg instances in the standard-key schedule.

86. A system according to claim 85, the system configured to:
further store in said memory unit route table data comprising data representative of predefined permissible origin and destination station pairs ascribed to one or more transport service levels and/or performance categories.

87. A system according to claim 86, the system configured to:
further store in said memory unit transfer set table data comprising a plurality of transfer set records each record representing one or more permissible transfer point stations between route segments for a route between an origin and destination station pair ascribed to a transport service level and/or performance category.

88. A system according to claim 87, said route table and/or transfer set table representing permissible route segments from permissible origin to permissible destination, from permissible origin to permissible transfer point, from permissible transfer point to permissible transfer point and/or from permissible transfer point to permissible destination and said system configured to:
read an instance of a route leg or a combination of individual instances of route legs from the short term schedule;
compare the route leg or route leg combination with the permissible route segments; and
include the route leg or route leg combination as a route segment in the route segment table dependent on the route leg or route leg combination corresponding to a permissible route segment.

89. A system according to claim 88, the system configured to further store in said memory unit rate data representative of one or more prices linked with each transport service level.

90. A system according to claim 89, wherein the price is dependent on one or more of hub station, shipper, customer, group of customers, time period, day of week, time of day, cargo type, group of cargo types, route, route identifier, vehicle type and route instance.

91. A system according to claim 90, the system further configured to automatically update data stored in said route segment table responsive to an update of data linked thereto stored outside said route segment table.

92. A system according to claim 91, at least one service and/or performance category attribute corresponding to an operational service attribute.

93. A system according to claim 92, said operational service attribute comprising one or more of the following group of operational service attributes:
import handling time; export handling time; minimum transfer time; maximum transfer time; permitted cargo type; permitted service package add on; vehicle type; cargo conveyance capacity; cargo compatibility; size and weight controls; and set of office hours.

94. A system according to claim 93, at least one service and/or performance category attribute corresponding to a non-operational service attribute.

95. A system according to claim 94, said non-operational service attribute comprising one or more of the following group of non-operational service attributes:
service guarantee; time specific search flag; itinerary specific search flag; minimum journey time; maximum journey time; permitted transfer stations; terms and conditions of carriage; icon; service level category; display options; set of permitted latest drop-off times; set of earliest permitted pick-up times; rules to determine access to capacity and permitted interline options.

96. A system according to claim 95, wherein said one or more transport service level and/or performance category is alterable by a transport provider.

97. A system according to claim 96, wherein at least one of said service and/or performance category attributes, operational service attributes and non-operational service attributes are alterable by a transport provider.

98. A system according to claim 97, configured to include in the route segment table an export handling time for the origin station and an import handling time for the destination station for one or more route segments; wherein the departure date and time minus export handling time defines a drop-off date and time and the arrival date and time plus import handling time defines a pick-up date and time.

99. A system according to claim 98, configured to include in the route segment table an export handling time and a permitted set of latest drop-off times for the origin station and an import handling time and a permitted set of earliest pick-up times for the destination station for one or more segments, wherein the latest of the permitted set of drop-off times prior to departure time minus export handling time defines a latest drop-off time and the earliest of the permitted set of earliest pick-up times after arrival time plus import handling time defines an earliest pick-up time.

100. A computer system comprising a processing unit, an interface unit for communication with said processing unit and a memory unit, for providing an integrated representation of routes in a transport system comprising a multiplicity of connectable stations, the system configured to
store in said memory unit a short term extended-key schedule of individual instances of route legs each route leg corresponding to a connectable station pair, and
derive from said short term extended-key schedule a route segment table comprising one or more extended-key route segments, each route segment corresponding to an individual instance of said route legs, or a combination of individual instances of said route legs.

101. A system according to claim 100, wherein each extended-key route segment is uniquely identified by a logical data key comprising data representing a route identifier and the origin and destination stations.

102. A system according to claim 101, the system further configured to
store in said memory unit a short term standard-key schedule of individual instances of transport provider route legs;
derive from said short term standard-key schedule one or more standard-key route segments, each route segment corresponding to an individual instance of said route legs or a combination of individual instances of said route legs; and
store said one or more standard-key segments in said route segment table.

103. A system according to claim 102, wherein each standard-key route segment is uniquely identified by a logical data key comprising data representing a route identifier.

104. A system according to claim 103, wherein the logical data key identifying the extended-key route segments is a different structure from the logical data key identifying the standard-key route segments.

105. A computer system for providing an integrated representation of transport service levels for routes in a transport system comprising a multiplicity of connectable stations, the computer system comprising a processing unit, an interface unit for communication with said processing unit and a memory unit, configured to:
generate one or more route options responsive to a route search request specifying a journey having an origin and destination station pair, each route option comprising a route segment having an origin and destination station pair specified in said route search request and selected from said route segment table, said route segment comprising one or more route leg instances ascribed to the same one or more transport service levels and/or performance categories throughout said route segment; and
store said one or more route options in a segment set list in said memory unit.

106. A system according to claim 105, configured to generate a route option for at least one performance category and use said route option to generate one or more route options for one or more of the plurality of service levels having as a service attribute a corresponding performance category identifier.

107. A system according to claim 106, further configured to:
compare said requested origin and destination station pair or said one or more route options with a route table comprising predefined permissible origin and destination station pairs for a transport service level and/or performance category stored in said memory unit, to determine whether said requested origin and destination station pair is permissible.

108. A system according to claim 107, configured to concatenate two or more route segments to form a route option having an origin and destination station pair corresponding to said route search request, and compare transport service levels and/or performance categories associated with said two or more route segments to generate route options comprising route segments having consistent transport service levels and/or performance categories.

109. A system according to claim 108, further configured to compare said one or more route options with a transfer set table stored in said memory unit and comprising a plurality of transfer set records each associated with an origin and destination station pair for a transport service level and/or performance category, each transfer set record including one or more entries corresponding to said data representative of permissible transfer points, to determine route options having permissible route segment combinations.

110. A system according to claim 109, configured to include a parameter representative of a maximum number of transfer points in a route between said origin and destination pair for a service level and/or a performance category to derive route options comprising no more transfer points than said maximum number.

111. A system according to claim 110, wherein said route segment table includes one or more service and/or performance category attributes ascribed to one or more route segments, the system further configured to receive a route search request including a parameter representative of a service attribute, and deriving one or more route options in dependence on said service attribute.

112. A system according to claim 111, configured to generate a price for the associated transport service level.

113. A system according to claim 112, wherein the price is dependent on one or more of hub station, shipper, customer, group of customers, time period, day of week, time of day, cargo type, group of cargo types route, route identifier vehicle type and route instance, and said step of generating comprises determining the appropriate price for the one or more route options.

114. A system according to claim 113, said route search request specifying one or more of the following:
i) departure and arrival date and time for a journey between a station pair;
ii) drop-off and pick-up time for a journey between a station pair;
iii) a cargo conveyance capacity between a station pair;
iv) a price in respect of conveyance capacity;
v) transport provider;
vi) cargo type;
vii) vehicle type;
viii) route identifier;
ix) transport service level;
x) performance category; and
xi) piece dimensions.

115. A system according to claim 114, said transport system comprising a plurality of transport providers.

116. A system according to claim 115, further configured to initiate display of a user interface on a display apparatus, said user interface including a button actuateable by a user to initiate a search by departure and arrival date and time (an itinerary specified search) or a search by drop-off and pick-up date and time (a time specified search).

117. A system according to claim 116, responsive to a search by departure and arrive date and time, configured to generate route options having departure and arrival times satisfying the request, and store said route options in the segment set list.

118. A system according to claim 117, wherein one or more transport service levels are identified as being valid for searches by departure and arrival date and time, the system configured to generate said route options for such valid transport service levels.

119. A system according to claim 116, responsive to a search by drop-off and pick-up date and time, generating route options having a drop-off and pick-up date and time satisfying the request, and storing said route options in the segment set list.

120. A system according to claim 119, wherein one or more transport service levels are identified as being valid for searches by drop-off and pick-up date and time, the system configured to generate route options for such valid service levels.

121. A system according to claim 120, wherein one or more transport service levels are identified as departure/arrival display transport service levels, the system configured to generate route options with displayable departure and arrival dates and times for said departure/arrival display transport service levels.

122. A system according to claim 121, wherein one or more transport service levels are identified as drop-off/pick-up display transport service levels, the system configured to generate route options with displayable drop-off and pick-up dates and times for said drop-off/pick-up display transport service levels.

123. A system according to claim 122, the system configured to generate route options with one or more of said service and/or performance category attributes displayable.

124. A system according to claim 117, wherein the route segment table comprises extended-key route segments and standard-key segments, and said one or more route options incorporates one or other or both of said route segments.

125. A computer system comprising a processing unit, an interface unit for communication with said processing unit and a memory unit, for providing an integrated representation of routes in a transport system comprising a multiplicity of connectable stations, the system configured to:
generate one or more route options responsive to a route search request specifying a journey having an origin and destination station pair, each route option comprising a route segment having an origin and destination station pair specified in said route search request and selected from said route segment table; and
store said one or more route options in a segment set list in said memory unit.

126. A system according to claim 125, wherein the route segment table comprises extended-key route segments and standard-key segments, and said one or more route options incorporates one or other or both of said route segments.

127. A client computer system configured for remote communication with a computer system, said client computer system comprising:
a processing unit;
an interface unit for communication with said processing unit;
a memory unit; and
a display means for displaying information to a user of said client computer system;
said processing unit comprising a user interface mechanism configured to receive a search request input via said interface unit from said user, and to communicate said search request to said computer system for processing thereby.

128. A client computer system according to claim 127, said user interface mechanism configured for providing a graphical representation of said segment set list, said user interface mechanism operable to display on said display means a plurality of route options including origin and destination station, departure and arrival date and time and/or drop-off and pick-up date and time, at least one service and/or performance category attribute, available conveyance capacity and price for conveyance arranged in a logical grouping, said user interface mechanism responsive to a user input to select a displayed route option and record a user booking of at least a portion of a conveyance capacity of said selected route option.

129. A computer system network comprising a plurality of client computer systems according to claim 128 and a computer system.
